(19) United States
(12) Patent Application Publication
(10) Pub. No.: US 2019/0084308 A1
(43) Pub. Date: Mar. 21, 2019

(54) CARTRIDGE

(71) Applicant: Seiko Epson Corporation, Tokyo (JP)

(72) Inventors: Noriyuki FUKASAWA, Shiojiri-shi (JP); Taku Ishizawa, Matsumoto-shi (JP); Tadahiro Mizutani, Shiojiri-shi (JP); Shun Oya, Kiso-gun (JP)

(73) Assignee: Seiko Epson Corporation, Tokyo (JP)

(21) Appl. No.: 16/133,228

(22) Filed: Sep. 17, 2018

(30) Foreign Application Priority Data
Sep. 20, 2017 (JP) 2017-180091

(51) Int. Cl. B41J 2/175; B41J 2/21

(52) U.S. Cl. CPC B41J 2/1753; B41J 2/1752; B41J 2/2103; B41J 2/17553; B41J 2/17546

(57) ABSTRACT

An object is to provide a technique that maintains good contact between apparatus-side terminals and contact portions in a second cartridge configured to contain multiple different types of inks. In the cartridge, a center contact portion provided on center in an X direction among a plurality of contact portions is arranged to intersect with a first center plane. Part of the plurality of contact portions is placed in a range where a cartridge-side engagement portion is located, in the X direction. An engagement center is provided between the first center plane and a second center plane.

### CROSS REFERENCE TO RELATED APPLICATIONS

The present application is based on, and claims priority from JP Application Serial Number 2017-180091, filed on Sep. 20, 2017, the disclosure of which is hereby incorporated by reference herein in its entirety.

### BACKGROUND

### 1. Technical Field

The present disclosure relates to technology of a cartridge.

### 2. Related Art

There is a known technique to supply inks to a printer using two different types of cartridges (as described in, for example, JP 2003-520711A, JP 2014-233928A, JP 2015-160314A, JP 2007-276495A, and WO 99/59823). A first cartridge that is one of the two different types of cartridges contains one type of ink (for example, black ink). A second cartridge that is the other of the two different types of cartridges contains, for example, multiple different types of inks (for example, yellow, cyan and magenta inks). Each of the two different types of cartridges is provided with contact portions configured to come into contact with printer-side terminals provided on the printer to be electrically coupled with the printer-side terminals. The configuration that the contact portions are electrically coupled with the printer-side terminals enables information regarding the cartridge to be transmitted between the printer and the cartridge. The information regarding the cartridge may be, for example, information indicating the type of the liquid contained therein, information indicating the amount of the liquid contained therein, information indicating the consumed amount of the liquid, and information indicating the manufacturing date of the cartridge.

Known supply mechanisms to supply the ink contained in the cartridge to the printer include a chimney-type supply mechanism (for example, JP 2003-520711A, JP 2014-233928A, JP 2015-160314A and WO 99/59823) and a needle-type supply mechanism (for example, JP 2007-276495A). In the chimney-type supply mechanism, ink is supplied from an ink supply portion of the cartridge to an ink delivery portion of the printer in the state that a surface of the ink supply portion keeping the ink is in contact with an upper surface of the ink delivery portion. In the needle-type supply mechanism, ink is supplied to an ink flow path provided in an ink supply needle of the printer in the state that the ink supply needle is inserted into an ink supply port of the cartridge.

In the needle-type supply mechanism, the ink supply port may be provided with a valve member configured to open and close a flow path in the ink supply port and with a seal member configured to prevent leakage of the ink from a clearance between the ink supply needle and the ink supply port. When the ink supply needle is inserted into the ink supply port, the cartridge may receive an external force from the ink supply needle via the valve member and the seal member. When the cartridge receives the external force, the cartridge is likely to move to some extent even in the state that the cartridge is mounted to the printer.

The cartridge used for a printer provided with a carriage of reciprocating motions receives a force of inertia accompanied with the reciprocating motions of the carriage. A large force of inertia (external force) is applied to the cartridge by acceleration or deceleration of the carriage when the moving direction of the carriage is changed over from one direction (for example, forward direction) to the other direction (for example, backward direction). This may cause the cartridge to be rotated or swung.

There is a possibility that the part of the cartridge where the contact portions are placed is deformed by an external force, depending on the location of the contact portions on the cartridge. This may displace the position of the contact portions and may fail to maintain the contact between the printer-side terminals and the contact portions.

Moving the cartridge is likely to change the position of the contact portions of the cartridge and fail to maintain the contact between the printer-side terminals and the contact portions. There is accordingly a need for a technique that appropriately maintains the contact between the printer-side terminals and the contact portions. Especially, the second cartridge containing multiple different types of inks generally tends to have the larger weight than the first cartridge containing one type of ink. The second cartridge accordingly receives a significant force of inertia caused by acceleration or deceleration of the carriage and is likely to significantly move accompanied with the reciprocating motions of the carriage. The second cartridge accordingly needs a different ingenuity from that for the first cartridge to appropriately maintain the contact between the printer-side terminals and the contact portions. Such a need is not characteristic of the cartridge configured to contain inks that are to be supplied to the printer but is commonly found in any cartridge configured to contain liquids that are to be supplied to a liquid ejection apparatus other than the printer.

### SUMMARY

In order to solve at least part of the problems described above, the present disclosure may be implemented by aspects and applications described below.

(1-1) According to one aspect of the present disclosure, there is provided a cartridge that is mounted to a carriage of a liquid ejection apparatus. The cartridge may be arrayed with another cartridge provided with one liquid supply port. Assuming that three orthogonal directions are respectively an X direction, a Y direction and a Z direction, the liquid ejection apparatus comprises the carriage configured to reciprocate in the X direction, a plurality of liquid supply needles may be provided in the carriage to be arrayed in the X direction. An apparatus-side terminal may be provided in the carriage. An apparatus-side engagement portion may be provided in the carriage. The cartridge may comprise a bottom surface and an upper surface that are opposed to each other in the Z direction, and a first side surface and a second side surface that are opposed to each other in the Y direction; three or a larger odd number of liquid supply ports that are arrayed in the X direction on the bottom surface at a position closer to the second side surface than the first side surface and that respectively have center axes along the Z direction; a plurality of contact portions that are arrayed in the X direction on the second side surface at a position closer to the bottom surface than the upper surface; and an engagement member provided on the second side surface at a position closer to the upper surface side than the contact portions. The plurality of contact portions may have a center contact portion provided on center in the X direction among the plurality of contact portions. The engagement member may include a cartridge-side engagement portion. In a mounting state in which the cartridge is mounted onto the carriage, each of the liquid supply ports may receive the liquid supply needle, each of the contact portions may come into contact with the apparatus-side terminal, and the cartridge-side engagement portion that is part of the engagement member may be locked by a lower surface of the apparatus-side engagement portion. Assuming that the center axis of a middle liquid supply port among the three or the larger odd number of liquid supply ports is a first center axis; that a plane that includes the first center axis and that is perpendicular to the X direction is a first center plane; that the center axis of the liquid supply port on a side close to center of the carriage in the X direction out of two liquid supply ports located adjacent to the middle liquid supply port is a second center axis; that a plane that includes the second center axis and that is perpendicular to the X direction is a second center plane; and that center of the cartridge-side engagement portion in the X direction is an engagement center, a center contact portion may be arranged to intersect with the first center plane, part of the plurality of contact portions is placed in a range where the cartridge-side engagement portion is located, in the X direction, and the engagement center is provided between the first center plane and the second center plane.

In the mounting state that the cartridge is mounted onto the carriage of the liquid ejection apparatus, this configuration suppresses the motion of the cartridge when the cartridge is affected by an external force or a force of inertia accompanied with reciprocating motions of the carriage. This reduces a variation in position of the contact portions relative to the apparatus-side terminal and accordingly maintains the good contact between the contact portions and the apparatus-side terminal.

(1-2) The cartridge of the above aspect may further comprise a third side surface and a fourth side surface that are opposed to each other in the X direction; and a concave portion provided in at least one corner portion among a corner portion where the first side surface intersects with the third side surface, a corner portion where the first side surface intersects with the fourth side surface, a corner portion where the second side surface intersects with the third side surface, and a corner portion where the second side surface intersects with the fourth side surface, to receive a guide projection that is provided on the carriage and that is configured to guide mounting of the cartridge. The concave portion may be extended from the bottom surface side toward the upper surface side.

In the cartridge of this aspect, the concave portion restricts the motion of the cartridge. This configuration more effectively suppresses a variation in position of the contact portions and thereby maintains the better contact between the contact portions and the apparatus-side terminal.

(1-3) The cartridge of the above aspect may further comprise a concavo-convex portion that is provided on at least one end of the first side surface out of one end in the X direction and the other end in the X direction and that is configured to be fit with a cartridge identification convex provided in the carriage. The concavo-convex portion may be extended from the bottom surface side toward the upper surface side on the first side surface.

In the cartridge of this aspect, the concavo-convex portion restricts the motion of the cartridge. This configuration suppresses a variation in position of the contact portions and thereby maintains the better contact between the contact portions and the apparatus-side terminal.

(2-1) According to another aspect of the present disclosure, there is provided a cartridge that is mounted to a carriage of a liquid ejection apparatus to be arrayed with another cartridge provided with one liquid supply port. Assuming that three orthogonal directions are respectively an X direction, a Y direction and a Z direction, the liquid ejection apparatus comprises the carriage configured to reciprocate in the X direction, a plurality of liquid supply needles provided in the carriage to be arrayed in the X direction, and an apparatus-side terminal provided in the carriage. The cartridge comprises a bottom surface and an upper surface that are opposed to each other in the Z direction; a first side surface and a second side surface that are opposed to each other in the Y direction; three or a larger odd number of liquid supply ports that are arrayed in the X direction on the bottom surface at a position closer to the second side surface than the first side surface and that respectively have center axes along the Z direction; and a plurality of contact portions that are arrayed in the X direction on the second side surface at a position closer to the bottom surface than the upper surface. In a mounting state in which the cartridge is mounted onto the carriage, each of the liquid supply ports receives the liquid supply needle, and each of the contact portions comes into contact with the apparatus-side terminal. The second side surface includes a first surface portion, a second surface portion, and a protruded surface portion that is protruded in the Y direction toward the carriage from the first surface portion and the second surface portion. The first surface portion is located on a −X direction side that is one direction side in the X direction, and the second surface portion is located on a +X direction side that is the other direction side in the X direction. With regard to the X direction, the protruded surface portion is provided between the first surface portion and the second surface portion. The protruded surface portion is arranged to intersect with a predetermined YZ plane that includes the center axis of a middle liquid supply port among the odd number of liquid supply ports and that is orthogonal to the X direction. A placement portion on which the three or a larger odd number of contact portions are placed is provided on the protruded surface portion. In the mounting state, a first side portion on the −X direction side of the protruded surface portion and a second side portion on the +X direction side of the protruded surface portion are placed between two regulating portions provided on the carriage. When the cartridge is viewed in a direction from the second side surface side toward the first side surface side in the Y direction, the center axis of the middle liquid supply port is placed in a range where the protruded surface portion is located, in the X direction. The center axis of a liquid supply port on the −X direction side of the middle liquid supply port is placed in a range where the first surface portion is located, in the X direction. The center axis of a liquid supply port on the +X direction side of the middle liquid supply port is placed in a range where the second surface portion is located, in the X direction.

In the cartridge of the above aspect, the second side surface includes the first surface portion, the second surface portion and the protruded surface portion. This increases the rigidity of the second surface portion. In the cartridge of this aspect, the placement portion is provided on the protruded surface portion having the higher rigidity, and the contact portions are provided on this placement portion. This accordingly suppresses a variation in position of the contact portions and thereby maintains the better contact between the contact portions and the apparatus-side terminal.

In the cartridge of the above aspect, the first side portion and the second side portion of the protruded surface portion are located between the two regulating portions. This configuration enables the regulating portions to suppress the motion of the protruded surface portion on which the contact portions are placed. This suppresses a variation in position of the contact portions and thereby maintains the better contact between the contact portions and the apparatus-side terminal.

The cartridge of the above aspect enables the regulating portions to be provided by utilizing a space that is opposed to the first surface portion and the second surface portion in the Y direction. This increases the dimensions in the Y direction of the regulating portions and thereby increases the rigidities of the regulating portions. Accordingly, the motion of the protruded surface portion is restricted by the regulating portions having the high rigidities. This more effectively suppresses a variation in position of the contact portions.

In the cartridge of the above aspect, the protruded surface portion is provided between the first surface portion and the second surface portion in the X direction. The center axis of the middle liquid supply port is placed in the range where the protruded surface portion is located, in the X direction. This configuration restricts the motion of the protruded surface portion in the X direction in a balanced manner from the respective sides in the X direction of the protruded surface portion by the two regulating portions. Accordingly, this configuration suppresses a variation in position of the contact portions and thereby maintains the good contact between the contact portions and the apparatus-side terminal.

In the cartridge of the above aspect, the protruded surface portion is provided between the first surface portion and the second surface portion in the X direction. The center axis of the middle liquid supply port is placed in the range where the protruded surface portion is located, in the X direction. This configuration allows the dimensions in the X direction of the first surface portion and the second surface portion to be increased to some extent. As a result, the dimensions in the X direction of the regulating portions can be increased to some extent corresponding to the first surface portion and the second surface portion. This provides the high rigidities of the regulating portion. The motion of the protruded surface portion is thus restricted by the regulating portions having the high rigidities. This more effectively suppresses a variation in position of the contact portions.

The cartridge of the above aspect enables the user to use the protruded surface portion as a mark when mounting the cartridge to the carriage. This configuration reduces the possibility that the cartridge in such an attitude that the first side surface and the second side surface are inverted is mounted to the carriage.

In the cartridge of the above aspect, the placement portion on which the plurality of contact portions are placed is provided on the protruded surface portion. This configuration increases the possibility that the placement portion collides with the ground or another surface prior to the remaining part when the user or the manufacturer mistakenly drops down the cartridge. In many cases, the contact portions are provided on a circuit board. In many cases, a storage device (memory) is provided on the circuit board or in the periphery of the circuit board. The configuration of the above aspect thus increases the possibility that the circuit board or the storage device is purposely broken when the cartridge is dropped down. This enables the liquid ejection apparatus to readily detect a failure of the cartridge when the cartridge is mounted to the carriage.

(2-2) The cartridge of the above aspect may further comprise an engagement member that is provided on the second side surface at a position closer to the upper surface side than the plurality of contact portions. In the mounting state, a cartridge-side engagement portion that is part of the engagement member may be locked by a lower surface of an apparatus-side engagement portion provided on the carriage.

In the cartridge of this aspect, the presence of the engagement member reduces the motion of the cartridge. This accordingly reduces a variation in position of the contact portions relative to the apparatus-side terminal and thereby maintains the better contact between the contact portions and the apparatus-side terminal.

(2-3) In the cartridge of the above aspect mentioned on “2-2”, a first projection may be provided on the first side portion to be protruded in the −X direction, and a second projection may be provided on the second side portion to be protruded in the +X direction. The first projection and the second projection may be located on the upper surface side of the contact portions and on the bottom surface side of the engagement member in the Z direction. In the mounting state, the first projection may abut on one regulating portion out of the two regulating portions, and the second projection may abut on the other regulating portion out of the two regulating portions.

In the cartridge of this aspect, the first projection abuts on one regulating portion, and the second projection abuts on the other regulating portion. This further restricts the motion of the protruded surface portion. This configuration more effectively suppresses a variation in position of the contact portions and thereby maintains the better contact between the contact portions and the apparatus-side terminal.

In the cartridge of this aspect, the first projection and the second projection are located on the upper surface side of the contact portions and on the bottom surface side of the engagement member in the Z direction. This reduces the swinging motion of the cartridge.

(2-4) In the cartridge of the above aspect, the engagement member may be provided on the protruded surface portion. In the cartridge of this aspect, the engagement member is provided on the protruded surface portion having the higher rigidity. This reduces the possibility of deformation of the protruded surface portion and reduces the possibility of deformation of the engagement member and displacement of the locking position. Accordingly, this configuration maintains the better contact between the contact portions and the apparatus-side terminal.

(2-5) In the cartridge of the above aspect mentioned on “2-1”, a first projection may be provided on the first side portion to be protruded in the −X direction, and a second projection may be provided on the second side portion to be protruded in the +X direction. The first projection and the second projection may be located on the upper surface side of the contact portions and on the bottom surface side of the engagement member in the Z direction. In the mounting state, the first projection may abut on one regulating portion out of the two regulating portions, and the second projection may abut on the other regulating portion out of the two regulating portions.

In the cartridge of this aspect, the first projection abuts on one regulating portion, and the second projection abuts on the other regulating portion. This further restricts the motion of the protruded surface portion. This configuration more effectively suppresses a variation in position of the contact portions and thereby maintains the better contact between the contact portions and the apparatus-side terminal.

In the cartridge of this aspect, the first projection and the second projection are located on the upper surface side of the contact portions and on the bottom surface side of the engagement member in the Z direction. This reduces the swinging motion of the cartridge.

(2-6) In the cartridge of the above aspect, each of the first surface portion and the second surface portion may be provided with at least one of a concave portion and a convex portion arranged away from the protruded surface portion. This configuration increases the rigidities of the first surface portion and the second surface portion.

(2-7) In the cartridge of the above aspect, projections may be provided on the bottom surface at a position closer to the first side surface than the second side surface. Two projections may be arranged across a plane that includes the center axis of the middle liquid supply port and that is perpendicular to the X direction. This configuration causes the projections to restrict the rotating motion of the cartridge along a YZ plane that is parallel to the Y direction and the Z direction.

(2-8) In the cartridge of the above aspect, a center contact portion provided on center in the X direction among the plurality of contact portions may be arranged to intersect with a plane that includes the center axis of the middle liquid supply port and that is perpendicular to the X direction. This configuration reduces a variation in position of the plurality of contact portions.

(2-9) In the cartridge of the above aspect, the plurality of contact portions may be arranged to be symmetric in the X direction with respect to a plane that includes the center axis of the middle liquid supply port and that is perpendicular to the X direction. This configuration reduces a maximum variation amount of the contact portions.

(2-10) In the cartridge of the above aspect, the three or a larger odd number of liquid supply ports may be aligned parallel to the X direction. This configuration maintains the good connection of the liquid supply ports with the liquid supply needles and reduces leakage of the liquid and invasion of the air into the liquid supply needle.

(2-11) The cartridge of the above aspect may further comprise a concave portion provided on the bottom surface at a position closer to the first side surface than the second side surface to receive an apparatus-side projection provided on the carriage. In the cartridge of this aspect, insertion of the apparatus-side projection into the concave portion restricts the motion of the cartridge. Accordingly this configuration suppresses a variation in position of the contact portions and maintains the good contact between the contact portions and the apparatus-side terminal.

The present disclosure may be implemented by various aspects of the cartridge and various aspects other than the cartridge. For example, the present disclosure may be implemented by aspects of a manufacturing method of cartridge, a liquid ejection system including the cartridge and a head, and a cartridge set including a cartridge provided with one liquid supply port and a cartridge provided with an odd number of liquid supply ports.

### BRIEF DESCRIPTION OF THE DRAWINGS

Embodiments of the disclosure are described with reference to the accompanying drawings, wherein like numbers reference like like elements:

FIG. 1 is a perspective view illustrating the configuration of a liquid ejection system;

FIG. 2 is a first top view illustrating a carriage;

FIG. 3 is a second top view illustrating the carriage;

FIG. 4 is a first perspective view illustrating the carriage;

FIG. 5 is a second perspective view illustrating the carriage;

FIG. 6 is a first diagram illustrating the configuration of a contact mechanism;

FIG. 7 is a second diagram illustrating the configuration of the contact mechanism;

FIG. 8 is a diagram illustrating a head;

FIG. 9 is a sectional view taken on a line 9-9 shown in FIG. 2;

FIG. 10 is a sectional view taken on a line 10-10 shown in FIG. 2;

FIG. 11 is a first perspective view illustrating a first cartridge;

FIG. 12 is a second perspective view illustrating the first cartridge;

FIG. 13 is a first perspective view illustrating a second cartridge;

FIG. 14 is a second perspective view illustrating the second cartridge;

FIG. 15 is a top view illustrating the second cartridge;

FIG. 16 is a bottom view illustrating the second cartridge;

FIG. 17 is a rear view illustrating the second cartridge;

FIG. 18 is a front view illustrating the second cartridge;

FIG. 19 is a left side view illustrating the second cartridge;

FIG. 20 is a right side view illustrating the second cartridge;

FIG. 21 is a front view illustrating a circuit board;

FIG. 22 is a side view illustrating the circuit board;

FIG. 23 is a diagram illustrating the positional relationship of respective components of the second cartridge;

FIG. 24 is a first diagram illustrating external forces applied to the second cartridge;

FIG. 25 is a second diagram illustrating external forces applied to the second cartridge;

FIG. 26 is a diagram illustrating the configuration of restricting the motion of the second cartridge;

FIG. 27 is a diagram illustrating restriction of the motion of the second cartridge in an X direction;

FIG. 28 is a diagram illustrating a second cartridge according to a first reference example;

FIG. 29 is a diagram illustrating a second cartridge according to a second reference example;

FIG. 30 is a sectional view taken on a line 30-30 shown in FIG. 23;

FIG. 31 is a diagram illustrating a region surrounded by a rectangle in FIG. 30;

FIG. 32 is a sectional view taken on a line 32-32 shown in FIG. 23;

FIG. 33 is a diagram illustrating a second cartridge using an adapter;

FIG. 34 is a diagram illustrating another second cartridge using an adapter;

FIG. 35 is a conceptual view illustrating another second cartridge;

FIG. 36 is a conceptual view illustrating another second cartridge;

FIG. 37 is a conceptual view illustrating another second cartridge;

FIG. 38 is a conceptual view illustrating another second cartridge;

FIG. 39 is a conceptual view illustrating another second cartridge;

FIG. 40 is a conceptual view illustrating another second cartridge;

FIG. 41 is a conceptual view illustrating a two-part type second cartridge;

FIG. 42 is a diagram illustrating the two-part type second cartridge;

FIG. 43 is a conceptual view illustrating another two-part type second cartridge;

FIG. 44 is a diagram illustrating the two-part type second cartridge;

FIG. 45 is a diagram illustrating another second cartridge;

FIG. 46 is a diagram illustrating another second cartridge;

FIG. 47 is a diagram illustrating another second cartridge;

FIG. 48 is a diagram illustrating another embodiment of terminal configuration of the circuit board;

FIG. 49 is a diagram illustrating another embodiment of terminal configuration of the circuit board;

FIG. 50 is a diagram illustrating another embodiment of terminal configuration of the circuit board; and

FIG. 51 is a diagram illustrating another embodiment of terminal configuration of the circuit board.

### DESCRIPTION OF EXEMPLARY EMBODIMENTS

A. First Embodiment

A-1. General Configuration of Liquid Ejection Apparatus

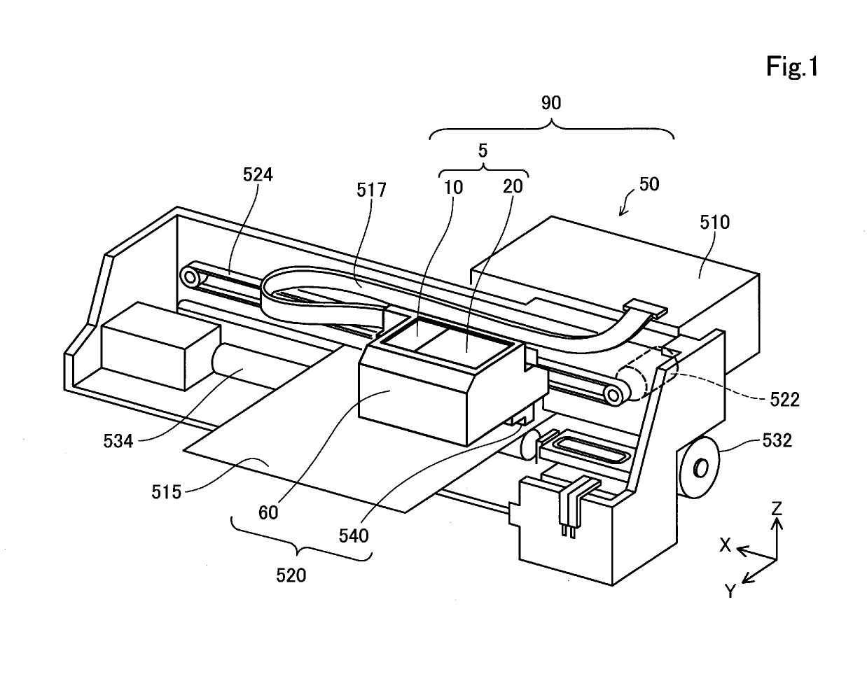

FIG. 1 is a perspective view illustrating the configuration of a liquid ejection system 90. FIG. 1 illustrates X, Y and Z axes that are orthogonal to one another. The X, Y and Z axes in FIG. 1 correspond to X, Y Z axes in the other drawings. The X, Y and Z axes are provided in subsequent drawings as needed basis. A direction along the X axis is expressed as an X direction, a direction along the Y axis is expressed as a Y direction, and a direction along the Z axis is expressed as a Z direction. One direction of the X direction is expressed as +X direction, and the other direction of the X direction is expressed as −X direction. One direction of the Y direction is expressed as +Y direction, and the other direction of the Y direction is expressed as −Y direction. One direction of the Z direction is expressed as +Z direction, and the other direction of the Z direction is expressed as −Z direction. In the state that the liquid ejection system 90 is placed on an XY plane (horizontal plane) that is parallel to the X direction and the Y direction, the Z direction is vertical direction: the +Z direction is opposite direction of gravity (upward direction), and −Z direction is direction of gravity (downward direction). In the liquid ejection system 90, the Y direction is front-rear direction, and the X direction is width direction (left-right direction).

The liquid ejection system 90 includes a cartridge set 5 that is comprised of two different types of cartridges 10 and 20 and a liquid ejection apparatus 50. In the liquid ejection system 90, the two different types of cartridge 10 and 20 are detachably mounted by the user to a cartridge holder 60 of the liquid ejection apparatus 50. The liquid ejection apparatus 50 is an inkjet printer applicable for printing on sheet of paper up to about the size A3. The liquid ejection apparatus 50 includes a head 540 configured to eject three or more different types of liquids. According to the embodiment, the head 540 is configured to eject four different types of inks having different colors (black ink, yellow ink, magenta ink and cyan ink). In the description below, the cartridge 10 is also called “first cartridge 10”, and the cartridge 20 is also called “second cartridge 20”.

The first cartridge 10 and the second cartridge 20 are mounted to the cartridge holder 60 to be arrayed in the X direction. The first cartridge 10 is configured to contain one type of liquid therein. According to the embodiment, the first cartridge 10 is configured to contain black ink therein. The second cartridge 20 is configured to contain three different types of inks, i.e., yellow ink, magenta ink and cyan ink. Accordingly, the second cartridge 20 is configured to contain multiple different types of liquids out of the remaining types of liquids that exclude one type of liquid contained in the first cartridge 10 from the three or more different types of (according to the embodiment, four different types of) liquids that are ejectable from the head 540. The number and the types of cartridges mounted to the cartridge holder 60 are, however, not limited to those of the embodiment. For example, two first cartridges 10 and one second cartridge 20 may be mounted to the cartridge holder 60. In this modification, the configuration of the cartridge holder 60 may be changed according to the number of cartridges. The types of liquids contained in the first cartridge 10 and the second cartridge 20 are not limited to those of the embodiment. For example, inks of other colors (for example, light magenta and light cyan) may be contained in the second cartridge 20. The second cartridge 20 may be configured to contain two different types of liquids therein or may be configured to contain four or more different types of liquids therein.

In addition to the cartridge holder 60, the liquid ejection apparatus 50 includes a controller 510 and a carriage 520 provided with the cartridge holder 60. The carriage 520 includes the head 540 described above. The liquid ejection apparatus 50 causes inks to be flowed from the first cartridge 10 and the second cartridge 20 mounted to the cartridge holder 60, to the head 540 via liquid supply needles described later. The inks flowed to the heads 540 are ejected (supplied) from the head 540 toward a printing medium 515 such as a sheet of paper or a label. Accordingly, data such as characters, graphics and images are printed on the printing medium 515 by using the head 540.

The controller 510 controls the respective components of the liquid ejection apparatus 50. The carriage 520 is configured to be movable relative to the printing medium 515. The head 540 includes an ink ejection mechanism configured to eject inks supplied from the cartridges 10 and 20 mounted to the cartridge holder 60, toward the printing medium 515. The controller 510 and the carriage 520 are electrically coupled to each other by means of a flexible cable 517. The ink ejection mechanism of the head 540 is operated in response to control signals from the controller 510.

According to the embodiment, the carriage 520 includes the head 540 and the cartridge holder 60. This type of the liquid ejection apparatus 50 with the cartridge 20 mounted to the cartridge holder 60 on the carriage 520 provided to move the head 540 may be called “on-carriage type”. According to another embodiment, a stationary cartridge holder 60 may be provided at a different location from a carriage 520, and inks from a cartridge 20 mounted to the cartridge holder 60 may be supplied to a head 540 of the carriage 520 through flexible tubes. This type of printer may be called “off-carriage type”.

The liquid ejection apparatus 50 includes a main scan feed mechanism and a sub scan feed mechanism configured to move the carriage 520 and the printing medium 515 relative to each other and implement printing on the printing medium 515. The main scan feed mechanism of the liquid ejection apparatus 50 includes a carriage motor 522 and a drive belt 524. The main scan feed mechanism reciprocates the carriage 520 along the X direction by transmission of the power of the carriage motor 522 via the drive belt 524 to the carriage 520. The sub scan feed mechanism of the liquid ejection apparatus 50 includes a feed motor 532 and a platen 534. The sub scan feed mechanism feeds the printing medium 515 in the +Y direction by transmission of the power of the feed motor 532 to the platen 534. The direction in which the carriage 520 is reciprocated is also called main scanning direction, and the direction in which the printing medium 515 is fed is also called sub scanning direction. According to the embodiment, the main scanning direction is the X direction, and the sub scanning direction is the Y direction. The carriage motor 522 of the main scan feed mechanism and the feed motor 532 of the sub scan feed mechanism are operated in response to control signals from the controller 510.

A-2. Configuration of Carriage 520

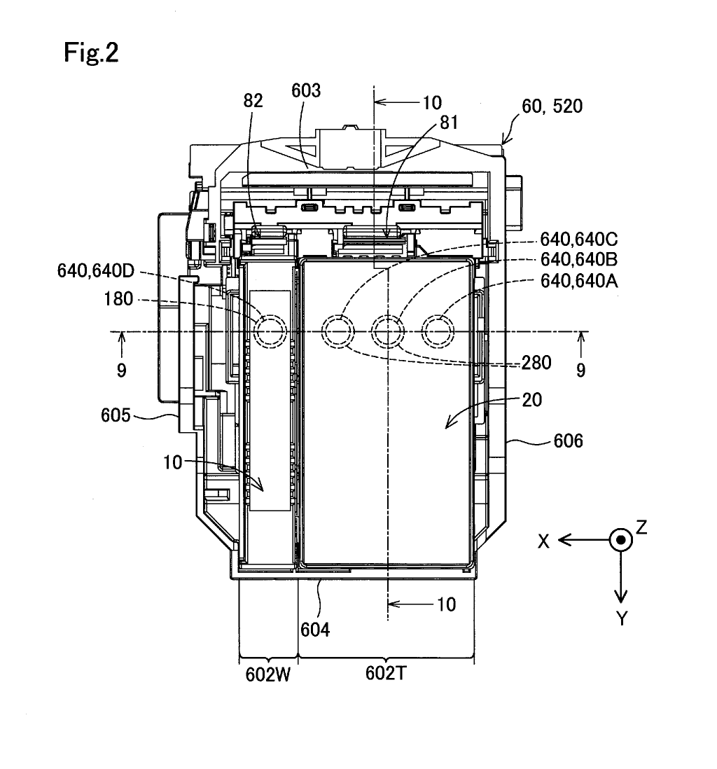

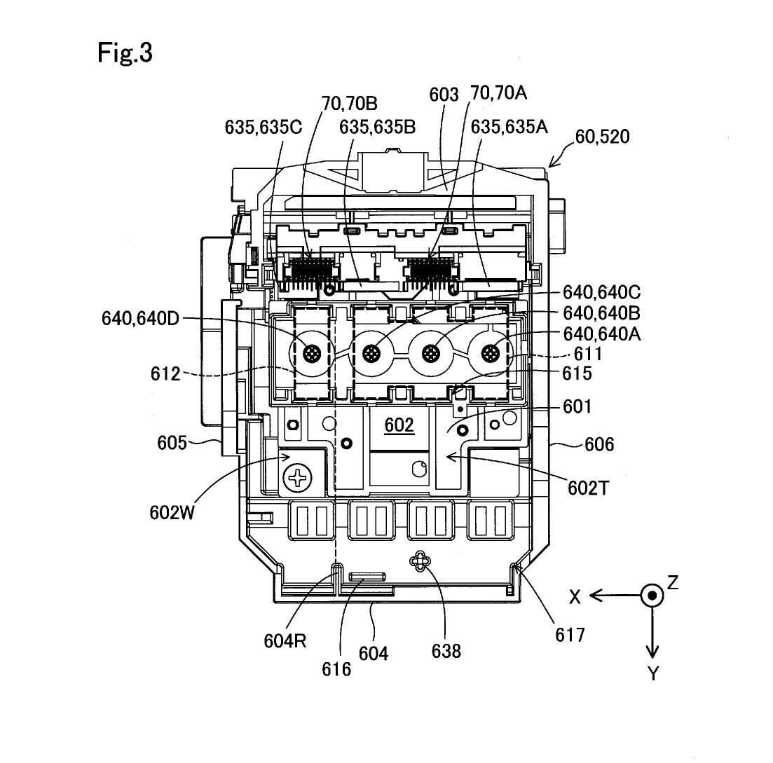

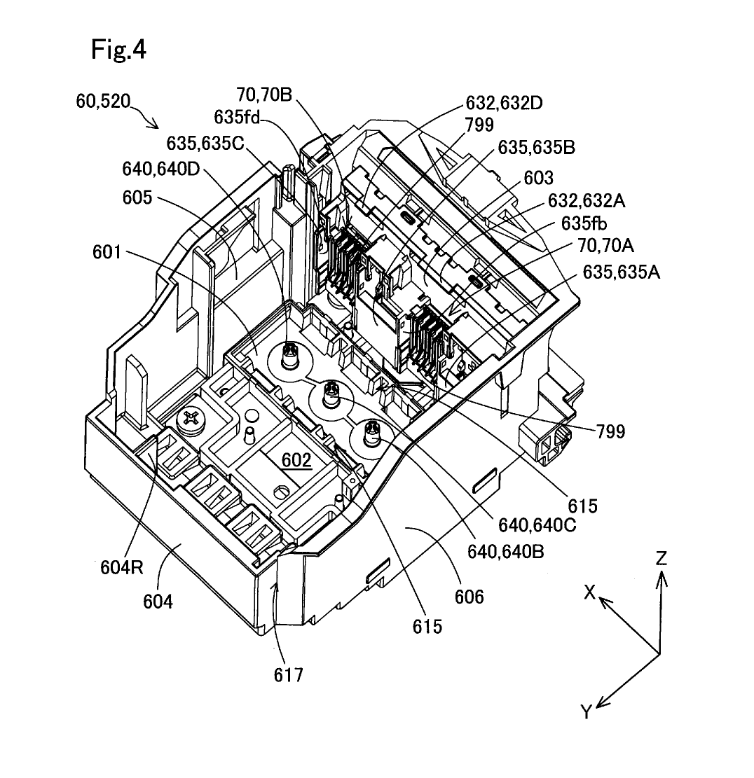

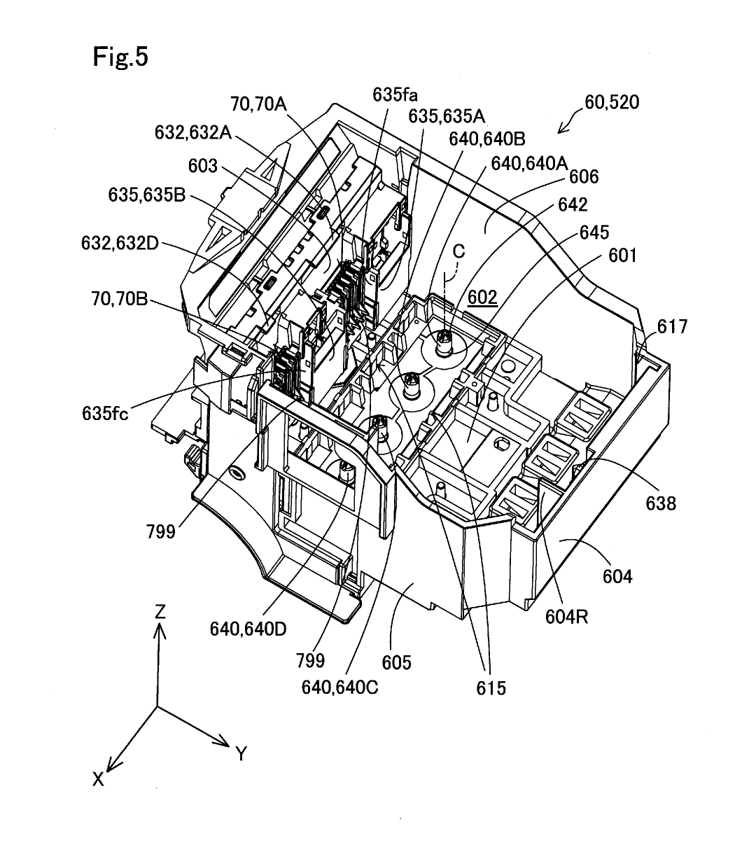

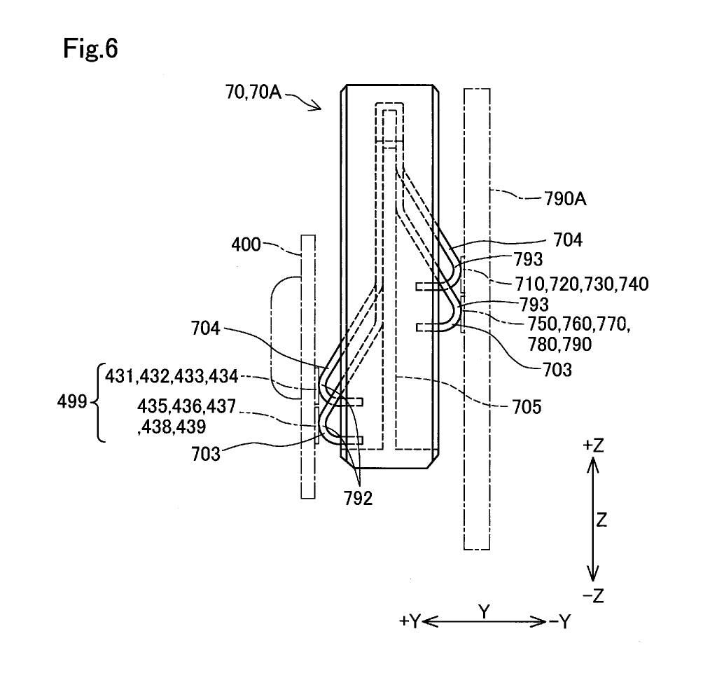

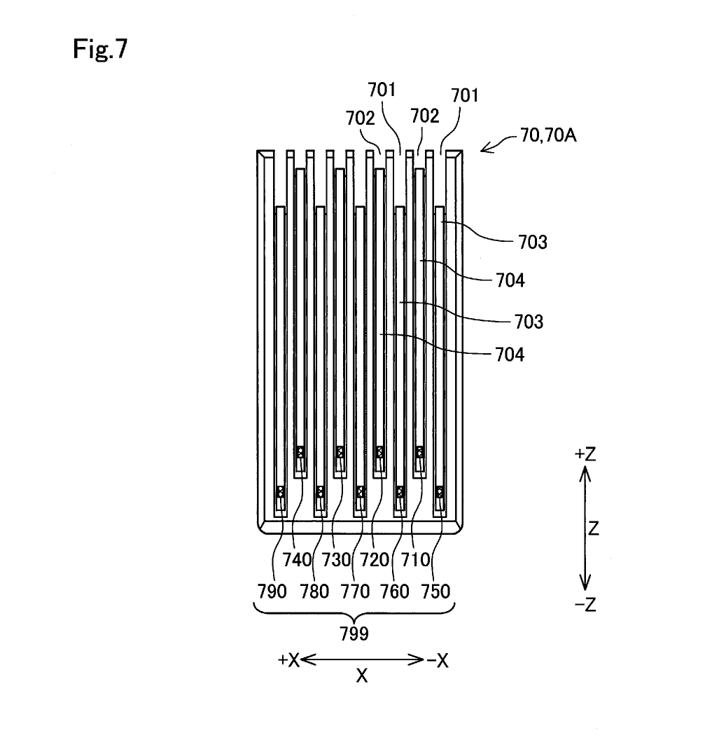

FIG. 2 is a first top view illustrating the carriage 520. FIG. 3 is a second top view illustrating the carriage 520. FIG. 4 is a first perspective view illustrating the carriage 520. FIG. 5 is a second perspective view illustrating the carriage 520. FIG. 6 is a first diagram illustrating the configuration of a contact mechanism 70A. FIG. 7 is a second diagram illustrating the configuration of the contact mechanism 70A. FIG. 2 also illustrates the state of the first cartridge 10 and the second cartridge 20 correctly mounted at a designed mounting position to the cartridge holder 60. This “state of being correctly mounted at the designed mounting position” denotes the state that the cartridges 10 and 20 are placed such that respective terminals of a cartridge-side terminal group described later respectively come into contact with corresponding terminals of an apparatus-side terminal group included in the contact mechanism 70 of the liquid ejection apparatus 50.

The cartridge holder 60 (shown in FIG. 4 and FIG. 5) has five wall portions 601, 603, 604, 605 and 606. A recessed portion formed by these five wall portions 601, 603, 604, 605 and 606 serves as a cartridge mounting portion 602 (also called “cartridge chamber 602”) to receive the cartridges 10 and 20 mounted thereto. The cartridge mounting portion 602 (shown in FIG. 2 and FIG. 3) includes a first mounting portion 602W that is located on a +X direction side to receive the first cartridge 10 mounted thereto and a second mounting portion 602T that is located on a −X direction side to receive the second cartridge 20 mounted thereto. The cartridge mounting portion 602 has an opening on an upper side (+Z direction side), such that the cartridges 10 and 20 are mounted to and dismounted from the cartridge holder 60 through this opening. The wall portion 601 is also called “apparatus-side bottom wall portion 601”. The wall portion 603 is also called “first apparatus-side side wall portion 603”. The wall portion 604 is also called “second apparatus-side side wall portion 604”. The wall portion 605 is also called “third apparatus-side side wall portion 605”. The wall portion 606 is also called “fourth apparatus-side side wall portion 606”.

The apparatus-side bottom wall portion 601 (shown in FIG. 4) forms a bottom surface of the cartridge mounting portion 602 in the recessed shape. The first to the fourth apparatus-side side wall portions 603, 604, 605 and 606 are extended in the +Z direction from the apparatus-side first wall portion 601 to form side surfaces of the cartridge mounting portion 602 in the recessed shape. The first apparatus-side side wall portion 603 and the second apparatus-side side wall portion 604 are opposed to each other in the Y direction. The first apparatus-side side wall portion 603 is located on a −Y direction side, and the second apparatus-side side wall portion 604 is located on a +Y direction side. The third apparatus-side side wall portion 605 and the fourth apparatus-side side wall portion 606 are opposed to each other in the X direction. The third apparatus-side side wall portion 605 is located on a +X direction side, and the fourth apparatus-side side wall portion 606 is located on a −X direction side.

The cartridge holder 60 (shown in FIG. 3 to FIG. 5) further includes a plurality of liquid supply needles 640 and a plurality of contact mechanisms 70 having apparatus-side terminals. According to the embodiment, four liquid supply needles 640 are provided as the plurality of liquid supply needles. When the four liquid supply needles 640 are to be distinguished from one another, reference signs “640A”, “640B”, “640C” and “640D” are used to express the respective liquid supply needles. According to the embodiment, two contact mechanism 70 are provided as the plurality of contact mechanisms. When the two contact mechanisms 70 are to be distinguished from each other, reference signs “70A” and “70B” are used to express the respective contact mechanisms.

The liquid supply needles 640 (shown in FIG. 5) are provided in the cartridge mounting portion 602 inside of the carriage 520 (cartridge holder 60). Each of the liquid supply needles 640 has an inner flow path which a liquid flows in. The liquid supply needles 640 are inserted into corresponding liquid supply ports 180 and 280 (shown in FIG. 2) of the cartridges 10 and 20. This insertion causes the liquids contained in the cartridges 10 and 20 to be introduced into the inner flow paths of the liquid supply needles 640. The liquid introduced into the liquid supply needles 640 are supplied to the head 540.

The liquid supply needle 640 (shown in FIG. 5) is a member extended in the +Z direction from the apparatus-side first wall portion 601 and includes a base end 645 and a leading end 642. A base end 645-side of the liquid supply needle 640 is formed in a columnar shape, and a leading end 642-side is formed in an approximately conical shape having the outer diameter tapered toward its +Z direction side. The base end 645 forms a −Z direction side end of the liquid supply needle 640. The leading end 642 forms a +Z direction side end of the liquid supply needle 640. An introducing hole is formed in the leading end 642 to introduce the liquid supplied from the cartridge 10 or 20 into the inner flow path. The liquid supply needle 640 has a center axis C along the Z direction.

The four liquid supply needles 640A to 640D (shown in FIG. 3) are arrayed in the X direction. The four liquid supply needles 640A to 640D are placed in a region of the apparatus-side bottom wall portion 601 surrounded by apparatus-side restriction wall portions 615 that are arranged in a frame-like shape and that are extended in the +Z direction from the apparatus-side bottom wall portion 601. The three liquid supply needles 640A to 640C are placed in an area 611 that is located on the −X direction side of the region surrounded by the apparatus-side restriction wall portions 615. The remaining one liquid supply needle 640D is placed in an area 612 that is located on the +X direction side of the region surrounded by the apparatus-side restriction wall portions 615. The apparatus-side restriction wall portions 615 serve to restrict the motions of the first cartridge 10 and the second cartridge 20 in the state that the first cartridge 10 and the second cartridge 20 are mounted to the cartridge holder 60 (in the mounting state). More specifically, the apparatus-side restriction wall portions 615 restrict the motions of the first cartridge 10 and the second cartridge 20 along the XY plane that is parallel to the X direction and the Y direction. The details of the restriction of the motions of the first cartridge 10 and the second cartridge 20 by the apparatus-side restriction wall portions 615 will be described later.

The three liquid supply needles 640A to 640C (shown in FIG. 3) are placed in the second mounting portion 602T. The three liquid supply needles 640A to 640C are respectively inserted into three corresponding liquid supply ports 280 provided in the second cartridge 20. Such insertion causes the different types of liquids contained in the second cartridge 20 to be respectively flowed in the three liquid supply needles 640A to 640C. According to the embodiment, yellow ink is flowed in the liquid supply needle 640A, magenta ink is flowed in the liquid supply needle 640B, and cyan ink is flowed in the liquid supply needle 640C. The liquid supply needle 640D is inserted into one liquid supply port 180 provided in the first cartridge 10. Such insertion causes the liquid contained in the first cartridge 10 (black ink according to the embodiment) to be flowed in the liquid supply needle 640D. The liquids flowed in the respective liquid supply needles 640A to 640D are supplied to the head 540 (shown in FIG. 2).

The contact mechanisms 70 (shown in FIG. 4) are provided on the first apparatus-side wall portion 603. The contact mechanism 70A has apparatus-side terminals (apparatus-side terminal group 799) that are in contact with contact portions of the second cartridge 20 described later in the mounting state of the second cartridge 20. The contact mechanism 70B has apparatus-side terminals (apparatus-side terminal group 799) that are in contact with contact portions of the first cartridge 10 described later in the mounting state of the first cartridge 10.

The two contact mechanisms 70A and 70B have identical configurations. The following accordingly describes the contact mechanism 70A provided in the second mounting portion 602T. The contact mechanism 70A (shown in FIG. 6 and FIG. 7) has contact-forming members 703 and 704 that are in contact with a cartridge-side terminal group of the second cartridge 20 (the first cartridge 10 in the case of the contact mechanism 70B). In the contact mechanism 70A (shown in FIG. 6), two different types of multiple slits 701 and 702 having different depths (shown in FIG. 7) are alternately formed corresponding to respective cartridge-side terminals 431 to 439 of a cartridge-side terminal group 499.

A holding member 705 (shown in FIG. 6) is placed in each of the slits 701 and 702. The contact-forming member 703 or 704 having electric conductivity and elasticity is embedded in the holding member 705 placed in each of the slits 701 and 702. Both end portions of the contact-forming member 703 or 704 are elastically deformed in a direction including a Y-direction component about a portion that is in contact with the holding member 705 as the supporting point.

One end portion 792 exposed in the cartridge mounting portion 602 out of both the end portions of the contact-forming member 703 or 704 is elastically brought into contact with a corresponding cartridge-side terminal among the respective cartridge-side terminals 431 to 439 provided in a circuit board 400 (circuit board 30 described later in the first cartridge 10) of the second cartridge 20 (first cartridge 10 in the case of the contact mechanism 70B). As shown in FIG. 6, the respective end portions 792 are pressed in the −Y direction by the cartridge-side terminal group 499, such as to be elastically deformed in the −Y direction, compared with a non-load state. The cartridge-side terminal group 499 is accordingly pressed in the +Y direction by the respective end portions 792. This maintains the good contact between the contact-forming members 703 and 704 and the cartridge-side terminal group 499.

Portions of the respective cartridge-side terminals 431 to 439 that are in contact with the contact-forming members 703 and 704 serve as contact portions. FIG. 7 illustrates portions 710 to 790 of the contact-forming members 703 and 704 that are in contact with the cartridge-side terminals 431 to 439. Accordingly, the portions 710 to 790 that are in contact with the cartridge-side terminals 431 to 439 serve as apparatus-side terminals to electrically couple the controller 510 (shown in FIG. 1) of the liquid ejection apparatus 50 to the cartridge-side terminals 431 to 439. In the description below, the portions 710 to 790 that are in contact with the cartridge-side terminals 431 to 439 are also called apparatus-side terminals 710 to 790. The apparatus-side terminals 710 to 790 are collectively called apparatus-side terminal group 799.

The other end portion 793 (shown in FIG. 6) of the contact-forming member 703 or 704 located outside of the cartridge mounting portion 602 is, on the other hand, elastically brought into contact with a corresponding terminal among terminals 71 to 79 provided in a relay board 790A of the liquid ejection apparatus 50.

The cartridge holder 60 further includes apparatus-side engagement portions 632 (shown in FIG. 4), regulating portions 635 (shown in FIG. 4 and FIG. 5) serving as regulators, a cartridge identification convex 616 (shown in FIG. 3) and an apparatus-side projection 638 (shown in FIG. 3 and FIG. 5).

The apparatus-side engagement portions 632 (shown in FIG. 4) are provided on the first apparatus-side side wall portion 603 and are placed on a +Z direction side of the contact mechanisms 70. Two apparatus-side engagement portions 632 are provided according to the embodiment. When the two apparatus-side engagement portions 632 are to be distinguished from each other, reference signs “632A” and “632D” are used to express the respective apparatus-side engagement portions. The apparatus-side engagement portions 632 are projection pieces that are protruded from the first apparatus-side side wall portion 601 toward the cartridge mounting portion 602 (toward the +Y direction). The apparatus-side engagement portion 632A provided in the second mounting portion 602T locks an engagement member of the second cartridge 20 described later in the mounting state of the second cartridge 20. The apparatus-side engagement portion 632D provided in the first mounting portion 602W locks an engagement member of the first cartridge 10 described later in the mounting state of the first cartridge 10.

The regulating portions 635 (shown in FIG. 4 and FIG. 5) are wall portions protruded from the first apparatus-side side wall portion 603 toward the cartridge mounting portion 602 (toward the +Y direction). The regulating portions 635 are placed below the apparatus-side engagement portions 632 and are located in a range in the Z direction where at least the contact mechanisms 70 are located. Three regulating portions 635 are provided according to the embodiment. When the three regulating portions 635 are to be distinguished from one another, reference signs “635A”, “635B” and “635C” are used to express the respective regulating portions.

The first regulating portion 635A is located on a −X direction side of the contact mechanism 70A. The second regulating portion 635B is located on a +X direction side of the contact mechanism 70A and is located on a −X direction side of the contact mechanism 70B. The third regulating portion 635C is located on a +X direction side of the contact mechanism 70B.

The first regulating portion 635A and the second regulating portion 635B are arranged across the contact mechanism 70A in the X direction. Accordingly, the contact mechanism 70A is placed in a space having side surfaces in the X direction defined by the first regulating portion 635A and the second regulating portion 635B. The second regulating portion 635B and the third regulating portion 635C are arranged across the contact mechanism 70B in the X direction. Accordingly, the contact portion 70B is placed in a space having side surfaces in the X direction defined by the second regulating portion 635B and the third regulating portion 635C.

The first regulating portion 635A (shown in FIG. 5) has a first restriction wall surface 635fa that is opposed to the apparatus-side terminal group 799 of the contact mechanism 70A in the X direction. The first restriction wall surface 635fa forms a +X direction-side side surface of the first regulating portion 635A. The first restriction wall surface 635fa is a surface arranged to face in the +X direction. Accordingly, the first restriction wall surface 635fa is a surface approximately parallel to the Y direction and the Z direction.

The second regulating portion 635B (shown in FIG. 4) has a second restriction wall surface 635fb that is opposed to the apparatus-side terminal group 799 of the contact mechanism 70A in the X direction. The second restriction wall surface 635th is a surface opposed to the first restriction wall surface 635fa across the apparatus-side terminal group 799 of the contact mechanism 70A in the X direction and is a surface arranged to face in the −X direction. Accordingly, the second restriction wall surface 635fb is a surface approximately parallel to the Y direction and the Z direction. The second restriction wall surface 635fb forms a −X direction-side side surface of the second regulating portion 635B. The second regulating portion 635B also has a third restriction wall surface 635fc (shown in FIG. 5) that is opposed to the apparatus-side terminal group 799 of the contact mechanism 70B in the X direction. The third restriction wall surface 635fc forms a +X direction-side side surface of the second regulating portion 635B. The third restriction wall surface 635fc is a surface arranged to face in the +X direction. Accordingly, the third restriction wall surface 635fc is a surface approximately parallel to the Y direction and the Z direction.

The third regulating portion 635C (shown in FIG. 4) has a fourth restriction wall surface 635fd that is opposed to the apparatus-side terminal group 799 of the contact mechanism 70B in the X direction. The third regulating portion 635C may be configured as part of the third apparatus-side side wall portion 605. The fourth restriction wall surface 635fd is a surface opposed to the third restriction wall surface 635fc across the apparatus-side terminal group 799 of the contact mechanism 70B in the X direction and is a surface arranged to face in the −X direction. Accordingly, the fourth restriction wall surface 635fd is a surface approximately parallel to the Y direction and the Z direction.

The cartridge identification convex 616 (shown in FIG. 3) is a member provided to prevent any cartridge other than the second cartridge 20 from being mounted to the second mounting portion 602T and is formed in a salient form extended in the +Z direction from the apparatus-side bottom wall portion 601. The second cartridge 20 has concave/convex portions that are fit in the cartridge identification convex 616. Cartridges other than the second cartridge 20, for example, the first cartridge 10 and any cartridge used for a different model of liquid ejection apparatus, do not have concave/convex portions that are fit in the cartridge identification convex 616. The presence of the cartridge identification convex 616 reduces the possibility that any cartridge different from the second cartridge 20 which is to be mounted to the second mounting portion 602T, is mounted to the second mounting portion 602T. The cartridge identification convex 616 is located on a +X direction side (third apparatus-side side wall portion 605-side) and on a +Y direction side (second apparatus-side side wall portion 604-side) of the second mounting portion 602T.

The apparatus-side projection 638 (shown in FIG. 3 and FIG. 5) is a rod-like member extended in the +Z direction from the apparatus-side first wall portion 601. The apparatus-side projection 638 is inserted into a recessed portion of the second cartridge 20 described later. The apparatus-side projection 638 is located on the +Y direction side (second apparatus-side side wall portion 604-side) of the second mounting portion 602T.

The cartridge holder 60 further includes a guide projection 617 (shown in FIG. 3 to FIG. 5). The guide projection 617 is a member that is provided in a corner portion where the second apparatus-side side wall portion 604 and the fourth apparatus-side side wall portion 606 intersect with each other and that is protruded toward the second mounting portion 602T of the cartridge mounting portion 602. The guide projection 617 is extended in the +Z direction from the apparatus-side first wall portion 601. The guide projection 617 serves to guide mounting of the second cartridge 20 to the second mounting portion 602T. The guide projection 617 is also a portion that abuts on the second cartridge 20 in the mounting state of the second cartridge 20.

The cartridge holder 60 (shown in FIG. 3 to FIG. 5) additionally includes a partition wall 604R. The partition wall 604R is a plate-like member that is protruded from the second apparatus-side side wall portion 604 inward (in the −Y direction) of the cartridge mounting portion 602. The partition wall 604R is extended from the apparatus-side bottom wall portion 601 to an upper end of the second apparatus-side side wall portion 604. The partition wall 604R is located on a boundary between the first mounting portion 602W and the second mounting portion 602T.

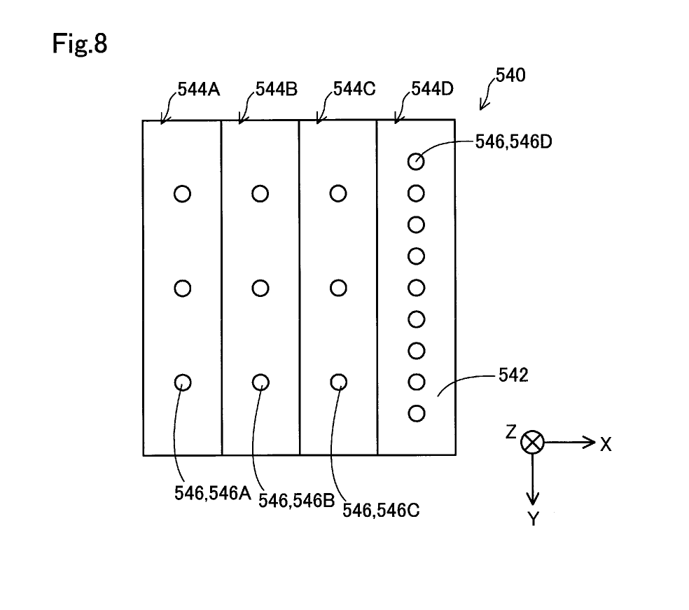

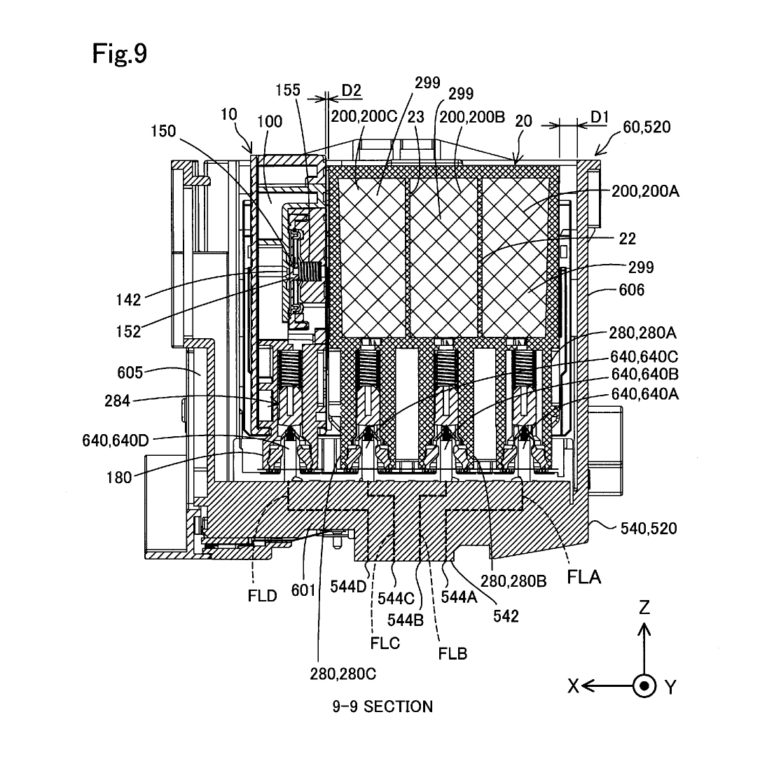

FIG. 8 is a diagram illustrating the head 540. FIG. 9 is a sectional view taken on a line 9-9 shown in FIG. 2. The head 540 (shown in FIG. 8) has a first-type ejecting port portion 544D and a plurality of (three according to the embodiment) second-type ejecting port portions 544A, 544B and 544C. The first-type ejecting port portion 544D (shown in FIG. 9) communicates with a first liquid chamber 100 of the first cartridge 10 (shown in FIG. 9) which one type of liquid (black ink according to the embodiment) is contained in. The first-type ejecting port portion 544D serves to eject the one type of liquid contained in the first cartridge 10. The second-type ejecting port portion 544A communicates with a second liquid chamber 200A of the second cartridge 20 (shown in FIG. 9). The second-type ejecting port portion 544B communicates with a second liquid chamber 200B of the second cartridge 20 (shown in FIG. 9). The second-type ejecting port portion 544C communicates with a second liquid chamber 200C of the second cartridge 20 (shown in FIG. 9). The second liquid chamber 200A contains yellow ink, the second liquid chamber 200B contains magenta ink, and the second liquid chamber 200C contains cyan ink. Accordingly, the second-type ejecting port portions 544A to 544C are provided individually for the multiple different types of liquids contained in the second cartridge 20 and respectively serve to the corresponding liquids out of the multiple different types of liquids.

As shown in FIG. 8, each of the first-type ejecting port portion 544D and the second-type ejecting port portions 544A, 544B and 544C has a plurality of ejection ports 546 formed in a lower surface 542 of the head 540. The liquids supplied through the liquid supply needles 640 (640A to 640D) and flow paths FLA to FLD (shown in FIG. 9) to the head 540 are ejected from the ejection ports 546 toward outside (for example, toward the printing medium 515). When the ejection ports 546 included in the respective ejecting port portions 544A to 544D are to be distinguished from one another, reference signs “546A”, “546B”, “546C” and “546D” are used to express the respective ejection ports.

One type of liquid (black ink according to the embodiment) supplied from the first cartridge 10 to the head 540 is ejected from the respective ejection ports 546D of the first-type ejecting port portion 544D (shown in FIG. 8). One type of liquid out of the three types of liquids contained in the second cartridge 20 is ejected from the respective ejection ports 546A, 546B or 546C of the second-type ejecting port portion 544A, 544B or 544C. More specifically, yellow ink is ejected from the respective ejection ports 546A of the second-type ejecting port portion 544A, magenta ink is ejected from the respective ejection ports 546B of the second-type ejecting port portion 544B, and cyan ink is ejected from the respective ejection ports 546C of the second-type ejecting port portion 544C. The three ejecting port portions 544A to 544C have identical numbers of the ejection ports 546A to 546C.

The number of the ejection ports 546D included in the first-type ejecting port portion 544D is larger than the numbers of the ejection ports 546A to 546C included in the respective second-type ejecting port portions 544A to 544C. According to the embodiment, the number of the ejection ports 546D is three times the number of the ejection ports 546A, the number of the ejection ports 546B and the number of the ejection ports 546C. Accordingly, the first-type ejecting port portion 544D has a higher maximum ejection amount of ejecting the liquid per unit time than the respective second-type ejecting port portions 544A to 544C. For example, the first-type ejecting port portion 544D has the maximum ejection amount of 6 g/minute, whereas the respective second-type ejecting port portions 544A to 544C have the maximum ejection amounts of 2 g/minute. According to the embodiment, the maximum ejection amount of the first-type ejecting port portion 544D and the maximum ejection amounts of the second-type ejecting port portions 544A to 544C are regulated by the number of the ejection ports 546D and the numbers of the ejection ports 546A to 546C. This is, however, not essential. For example, the maximum ejection amount may be changed by changing the type and the performance of a liquid ejection mechanism (for example, piezoelectric vibration element) that controls ejection of liquid. In another example, the maximum ejection amounts may be changed by changing the opening diameters of the respective ejection ports 546A to 546D.

A-3. Description of Outline of Internal Configurations of Cartridges and Mounting State of Cartridges

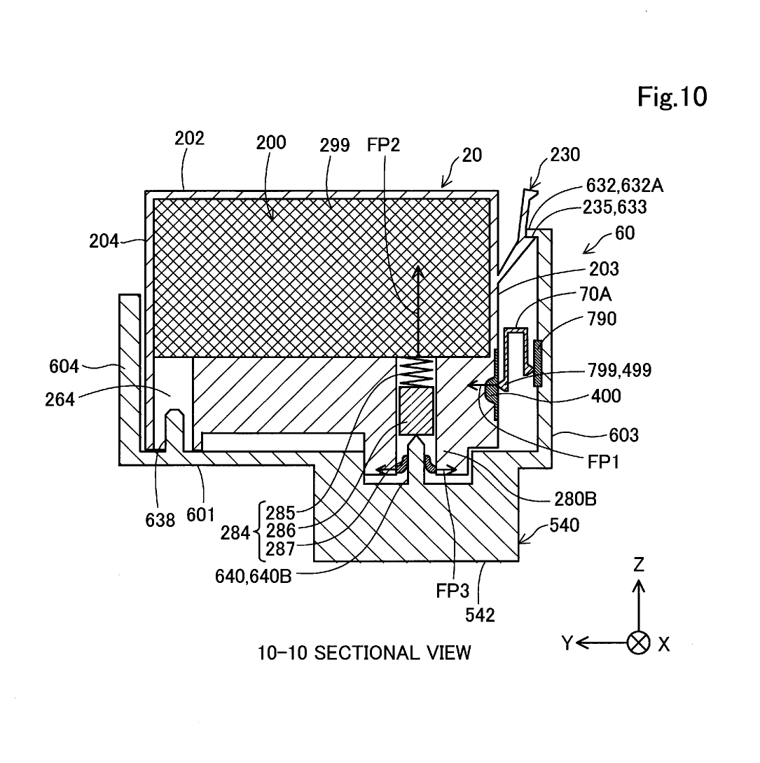

The following describes the outline of the internal configurations of the first cartridge 10 and the second cartridge 20 and the mounting state of the first cartridge 10 and the second cartridge 20 to the cartridge holder 60 with reference to FIG. 10 in addition to FIG. 9 described above. FIG. 10 is a sectional view taken on a line 10-10 shown in FIG. 2. FIG. 10 is a partially schematic drawing.

As shown in FIG. 9, in the mounting state of the first cartridge 10 and the second cartridge 20, a distance D1 between the second cartridge 20 and the cartridge holder 60 (more specifically, the fourth apparatus-side side wall portion 606) is larger than a distance D2 between the first cartridge 10 and the second cartridge 20 in the X direction.

In the mounting state of the first cartridge 10 to the cartridge holder 60 (shown in FIG. 9), the liquid supply needle 640D is inserted into the liquid supply port 180 of the first cartridge 10. Such insertion causes black ink to be supplied from the first liquid chamber 100 to the head 540 through the liquid supply needle 640D. The first liquid chamber 100 is not provided with a liquid absorber to retain (absorb) the liquid therein. In other words, the first cartridge 10 is a direct liquid-type cartridge. A valve mechanism 150 is placed in the first liquid chamber 100 to open and close a flow path that is arranged to connect the first liquid chamber 100 with the liquid supply port 180. For example, the valve mechanism 150 has a configuration similar to that of a valve disclosed in JP 2013-248786A. More specifically, the valve mechanism 150 includes a valve element 152 configured to close a communicating hole 142. The communicating hole 142 and the valve element 152 are provided in the middle of the flow path arranged to connect the first liquid chamber 100 with the liquid supply port 180. Ink flows from the first liquid chamber 100 toward the liquid supply port 180, so that the liquid supply port 180-side is called downstream side. The flow path arranged to connect the first liquid chamber 100 with the liquid supply port 180 is generally closed when the valve element 152 receives a biasing force of a biasing member 155 to close the communicating hole 142. When the negative pressure on the downstream side of the valve element 152 becomes equal to a predetermined level with consumption of the liquid on the downstream side of the valve element 152 in this state, the valve element 152 is displaced in a direction of separating from the communicating hole 142 against the biasing force of the biasing member 155. When the valve element 152 is separated from the communicating hole 142, the liquid is supplied from an upstream region of the valve element 152 to a downstream region through the communicating hole 142. When supplying a predetermined amount of the liquid to the downstream region of the valve element 152 provides a predetermined pressure (negative pressure), the valve element 152 is displaced to close the communicating hole 142 by the biasing force of the biasing member 155. The first liquid chamber 100 communicates with the ambient air, and the ambient air is introduced into the first liquid chamber 100 accompanied with consumption of the liquid.

In the mounting state of the second cartridge 20 to the cartridge holder 60, the corresponding liquid supply needles 640 are inserted into the liquid supply ports 280 of the second cartridge 20. Such insertion causes yellow ink, magenta ink and cyan ink to be supplied from the second liquid chambers 200 to the head 540 through the liquid supply needles 640. The second cartridge 20 includes a plurality of (three according to the embodiment) second liquid chambers 200 that are configured to respectively contain three different types of liquids. When the three second liquid chambers 200 are to be distinguished from one another, reference signs “200A”, “200B” and “200C” are used to express the respective second liquid chambers. The three second liquid chambers 200A to 200C are parted from one another by partition walls 22 and 23 to prevent the respective liquids from being mixed with one another. The second liquid chamber 200A contains yellow ink, the second liquid chamber 200B contains magenta ink, and the second liquid chamber 200C contains cyan ink. The three second liquid chambers 200A to 200C respectively includes liquid absorbers (liquid retaining members) 299 placed therein. The liquid absorber 299 is a member configured to retain (absorb) the liquid by a predetermined capillary force and may be, for example, a foaming member such as urethane foam or a fibrous member by bundling polypropylene fibers. Each liquid absorber 299 is placed over approximate the entire area inside of each of the liquid chambers 200A to 200C. Unlike the first liquid chamber 100, no valve mechanism 150 is provided in the respective second liquid chambers 200A to 200C. In the second cartridge 20, the negative pressure in each of the second liquid chambers 200A to 200C is kept by the capillary force of the liquid absorber 299. Accordingly, the second liquid chambers 200A to 200C do not need the valve mechanism 150. The respective second liquid chambers 200A to 200C communicate with the ambient air on the upstream region, and the ambient air is introduced into the respective second liquid chambers 200A to 200C accompanied with consumption of the respective liquids.

A valve mechanism 284 is placed inside of each of the liquid supply ports 180 and 280A to 280C. The valve mechanism 284 (shown in FIG. 10) is configured to open and close an internal flow path provided in each of the liquid supply ports 180 and 280. The valve mechanism 284 includes a seal portion (valve seat) 287, a valve element 286 and a biasing member 285 provided sequentially from a leading end side of the liquid supply port 180 or 280. The seal portion 287 is a member in an approximately ring shape. The seal portion 287 is made from, for example, an elastic material such as rubber or elastomer. The seal portion 287 is press fit inside of the liquid supply port 180 or 280. In the mounting state, the seal portion 287 airtightly comes into contact with an outer circumferential surface of the liquid supply needle 640, so as to suppress the liquid from being leaked outside from a clearance between the liquid supply port 180 or 280 and the liquid supply needle 640. The valve element 286 is a member in an approximately columnar shape. In the state prior to mounting of the cartridge 10 or 20 to the cartridge holder 60 (in the non-mounting state), the valve element 286 is biased by the biasing member 285 in a direction toward the seal portion 287, so as to close an aperture formed in the seal portion 287. Accordingly, in the non-mounting state, the valve mechanism 284 is in a closed position. The biasing member 285 is a compression coil spring. In the mounting state of the cartridge 10 or 20, the liquid supply needle 640 presses the valve element 286 in a direction of separating from the seal portion 287, so as to separate the valve element 286 from the seal portion 287. This causes the valve mechanism 284 to be set in an open position.

As shown in FIG. 10, in the mounting state of the second cartridge 20, an engagement member 230 of the second cartridge 20 is locked by a lower surface 633 of the apparatus-side engagement portion 632A. The surface 633 is a surface arranged to face in the −Z direction. The engagement member 230 is a member operated by the user to mount and dismount the second cartridge 20 to and from the second mounting portion 602T and is configured as a lever having elasticity. The engagement member 230 has a cartridge-side engagement portion 235 that is locked by the surface 633. The second cartridge 20 in the mounting state receives a biasing force (external force) FP1 in the +Y direction from the apparatus-side terminal group 799 of the contact mechanism 70A toward the cartridge-side terminal group 499 of the circuit board 400. The second cartridge 20 in the mounting state also receives an external force (reaction force) FP2 that is generated when the valve element 286 is pressed up in the +Z direction by the liquid supply needle 640 to compress the biasing member 285. The second cartridge 20 in the mounting state is elastically deformed when the seal portion 287 is pressed by a corresponding one of the liquid supply needle 640A to 640C. The second cartridge 20 in the mounting state receives an external force FP3 along the XY plane that is parallel to the X direction and the Y direction by a reaction force of this elastic deformation. The external force FP3 includes an external force in the X direction and an external force in the Y direction.

In the mounting state, the cartridge-side engagement portion 235 of the second cartridge 20 is locked by the surface 633 of the apparatus-side engagement portion 632A. Such engagement of the cartridge-side engagement portion 235 with the apparatus-side engagement portion 632A suppresses the second cartridge 20 from being moved in the +Z direction by the external force FP2. A configuration of suppressing the second cartridge 20 from being moved by the external force FP1 and the external force FP3 will be described later.

A-4. Detailed Configuration of First Cartridge 10

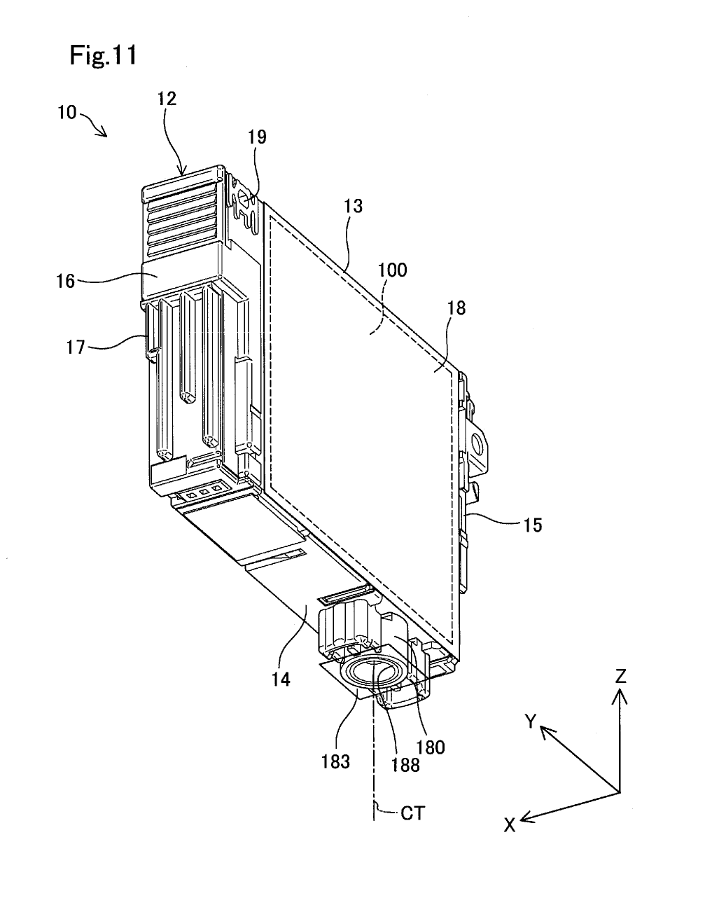

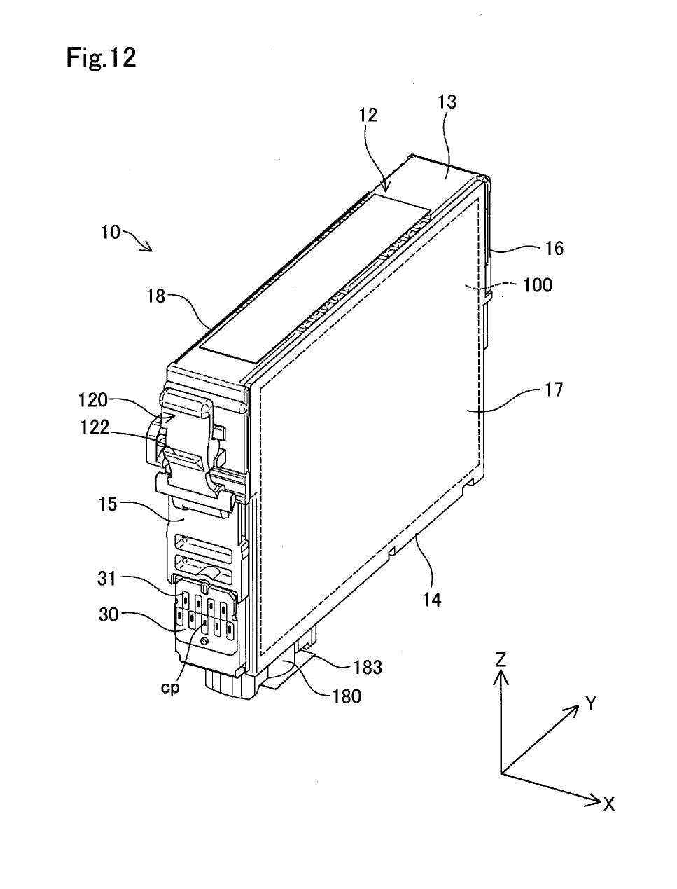

FIG. 11 is a first perspective view illustrating the first cartridge 10. FIG. 12 is a second perspective view illustrating the first cartridge 10. A mounting direction of the first cartridge 10 to the cartridge holder 60 is −Z direction, and a dismounting direction is +Z direction.

As shown in FIG. 11 and FIG. 12, the first cartridge 10 has an approximately rectangular parallelepiped appearance shape. An outer surface (outer shell) 12 of the first cartridge 10 includes six surfaces. The six surfaces include a bottom surface 14, an upper surface 13, a front surface (first side surface) 16, a rear surface (second side surface) 15, a left side surface (third side surface) 17 and a right side surface (fourth side surface) 18. The six surfaces 13 to 18 form the outer shell 12 of the first cartridge 10. Each of the surfaces 13 to 18 is formed in a planar shape. The planar shape herein includes not only the case where the entire surface is completely flat but the case where part of the surface has some concavity and convexity. In other words, each planar surface is allowed to partly have some concavity and convexity. Each of the surfaces 13 to 18 is formed in an approximately rectangular outer shape in a plan view.

The first cartridge 10 includes the first liquid chamber 100 configured to contain one type of liquid (black ink according to the embodiment) therein. The one type of liquid (black ink) contained in the first liquid charmer 100 is a pigment-containing ink. (pigment ink). The pigment ink denotes an ink prepared by dispersing the pigment in a dispersion medium such as water.

The bottom surface 14 is a concept including a wall that forms a bottom wall of the first cartridge 10 in the mounting state and is also called “bottom surface wall portion (bottom wall) 14”. The upper surface 13 is a concept including a wall that forms an upper wall of the first cartridge 10 in the mounting state and is also called “upper surface wall portion (upper wall) 13”. The front surface 16 is a concept including a wall that forms a front wall of the first cartridge 10 in the mounting state and is also called “front surface wall portion (front wall) 16”. The rear surface 15 is a concept including a wall that forms a rear wall of the first cartridge 10 in the mounting state and is also called “rear surface wall portion (rear wall) 15”. The left side surface 17 is a concept including a wall that forms a left side wall of the first cartridge 10 in the mounting state and is also called “left side surface wall portion (left side wall) 17”. The right side surface 18 is a concept including a wall that forms a right side wall of the first cartridge 10 in the mounting state and is also called “right side surface wall portion (right side wall) 18”. The “wall portion” or the “wall” herein may not be necessarily formed by a single wall but may be formed by a plurality of walls.

The upper surface 13 and the bottom surface 14 are opposed to each other in the Z direction. The upper surface 13 is located on the +Z direction side, and the bottom surface 14 is located on the −Z direction side. In the mounting state, the bottom surface 14 is arranged to face the apparatus-side bottom wall portion 601 of the cartridge holder 60 (shown in FIG. 4). The upper surface 13 and the bottom surface 14 are horizontal surfaces in the mounting state. The upper surface 13 and the bottom surface 14 are arranged to intersect with the rear surface 15, the front surface 16, the left side surface 17 and the right side surface 18 at approximately right angles. The upper surface 13 and the bottom surface 14 are surfaces parallel to the X direction and the Y direction. The upper surface 13 and the bottom surface 14 are surfaces perpendicular to the Z direction. Assuming that a surface parallel to the X direction and the Y direction (i.e., surface perpendicular to the Z direction) is expressed as an XY plane, the upper surface 13 and the bottom surface 14 are surfaces parallel to the XY plane.

The rear surface 15 and the front surface 16 are opposed to each other in the Y direction. The rear surface 15 is located on the −Y direction side, and the front surface 16 is located on the +Y direction side. In the mounting state, the rear surface 15 is arranged to face the first apparatus-side side wall portion 603 of the cartridge holder 60 (shown in FIG. 4). In the mounting state, the front surface 16 is arranged to face the second apparatus-side side wall portion 604 of the cartridge holder 60 (shown in FIG. 4). The rear surface 15 and the front surface 16 are vertical surfaces in the mounting state. The rear surface 15 and the front surface 16 are arranged to intersect with the upper surface 13, the bottom surface 14, the right side surface 18 and the left side surface 17 at approximately right angles. The rear surface 15 and the front surface 16 are surfaces parallel to the X direction and the Z direction. The rear surface 15 and the front surface 16 are surfaces perpendicular to the Y direction. Assuming that a surface parallel to the X direction and the Z direction (i.e., surface perpendicular to the Y direction) is expressed as an XZ plane, the rear surface 15 and the front surface 16 are surfaces parallel to the XZ plane.

The left side surface 17 and the right side surface 18 are opposed to each other in the X direction. The left side surface 17 is located on the +X direction side, and the right side surface 18 is located on the −X direction side. In the mounting state, the left side surface 17 is arranged to face the third apparatus-side side wall portion 605 of the cartridge holder 60 (shown in FIG. 4). In the mounting state, the right side surface 18 is arranged to face the second cartridge 20. The left side surface 17 and the right side surface 18 are vertical surfaces in the mounting state. The left side surface 17 and the right side surface 18 are arranged to intersect with the upper surface 13, the bottom surface 14, the rear surface 15 and the front surface 16 at approximately right angles. The left side surface 17 and the right side surface 18 are surfaces parallel to the Y direction and the Z direction. The left side surface 17 and the right side surface 18 are surfaces perpendicular to the X direction. Assuming that a surface parallel to the Y direction and the Z direction (i.e., surface perpendicular to the X direction) is expressed as a YZ plane, the left side surface 17 and the right side surface 18 are surfaces parallel to the YZ plane.

The first cartridge 10 has a length (dimension in the Y direction), a height (dimension in the Z direction) and a width (dimension in the X direction) in descending order. The magnitude relationship of the length, the width and the height of the first cartridge 10 is, however, not limited to this embodiment but may be changed arbitrarily. For example, the first cartridge 10 may have the height, the length and the width in descending orders or may have the height, the length and the width that are equal to one another.

As shown in FIG. 11, one liquid supply port 180 is arranged to be protruded on the bottom surface 14. The liquid supply port 180 is formed in an approximately cylindrical shape. The liquid supply port 180 has a center axis CT along the Z direction. As shown in FIG. 9, in the mounting state that the first cartridge 10 is mounted to the carriage 520, the liquid supply needle 640D (shown in FIG. 2) that is provided in the first mounting portion 602W of the cartridge holder 60 (shown in FIG. 2 and FIG. 3) is inserted into the liquid supply port 180. An opening 188 is formed in an end face of the liquid supply port 180 to flow the ink contained in the first liquid chamber 100 toward outside. In the first cartridge 10 prior to mounting to the first mounting portion 602W of the liquid ejection apparatus 50, the opening 188 is closed by a film 183. The film 183 is configured to be broken by the liquid supply needle 640D when the first cartridge 10 is mounted to the first mounting portion 602W.

As shown in FIG. 12, a circuit board 30 is provided at a location of the rear surface 15 that is closer to the bottom surface 14 than the upper surface 13.

The circuit board 30 has a configuration similar to that of a circuit board 400 of the second cartridge 20 described later. A plurality of (nine) cartridge-side terminals 31 that form a plurality of (nine) contact portions are formed on a surface of the circuit board 30. In the mounting state, each of the plurality of cartridge-side terminals 31 comes into contact with the apparatus-side terminal group 799 of the contact mechanism 70B (shown in FIG. 4). This causes the circuit board 30 to be electrically coupled to the controller 510 of the liquid ejection apparatus 50 (shown in FIG. 1). A rewritable storage device (memory) is provided on a rear face of the circuit board 30. Information regarding the first cartridge 10, for example, the amount of ink consumption and the color of ink of the first cartridge 10, is stored in the storage device.

An engagement member 120 is provided in the form of a lever on the rear surface 15 at a position on the upper surface 13-side of the circuit board 30. The engagement member 120 has a −Z direction end that is connected with the rear surface 15 and is elastically deformed in a direction including a Y-direction component about the −Z direction end. Such elastic deformation is used for mounting and dismounting of the first cartridge 10 to and from the cartridge holder 60 (shown in FIG. 1). The engagement member 120 includes a cartridge-side engagement portion 122 that is locked by the lower surface (i.e., surface arranged to face in the −Z direction) 633 (shown in FIG. 10) of the apparatus-side engagement portion 532D (shown in FIG. 4). The cartridge-side engagement portion 122 is a projection that is protruded in the −Y direction from a main body of the engagement member 120.

As shown in FIG. 11, an air introducing hole 19 is formed in the right side surface 18. The air introducing hole 19 is an opening provided to introduce the ambient air (the air) into the first liquid chamber 100.

A-5. Detailed Configuration of Second Cartridge 20

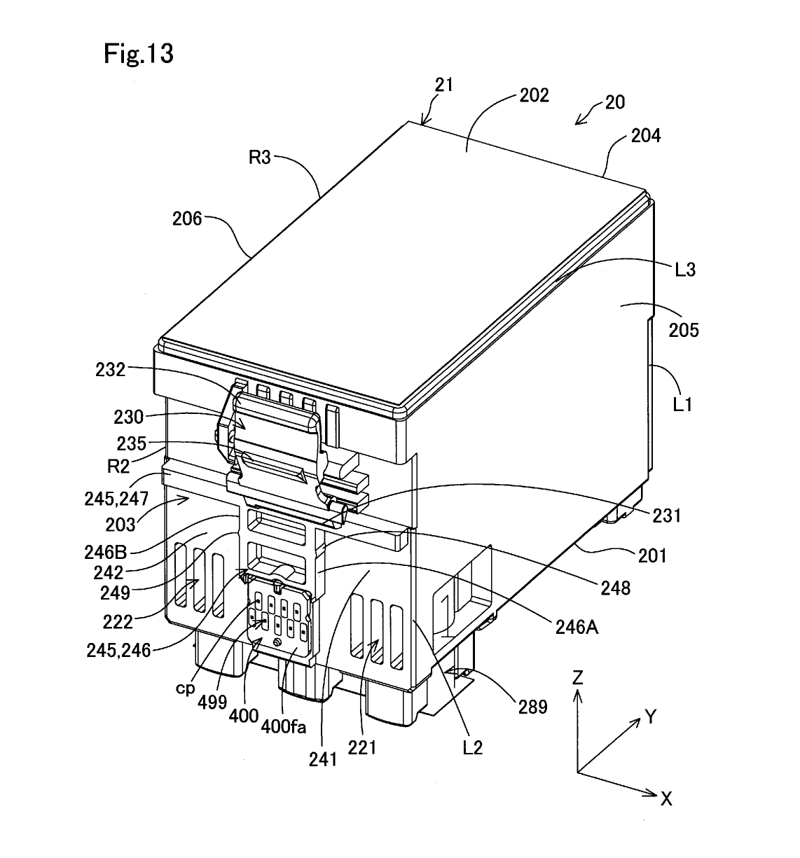

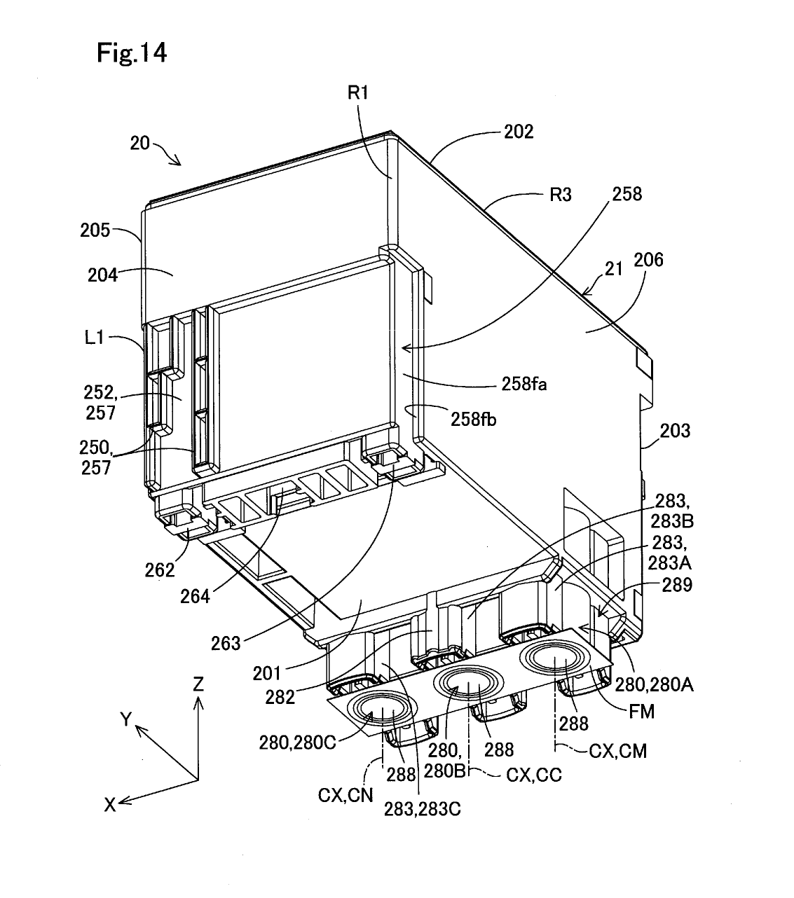

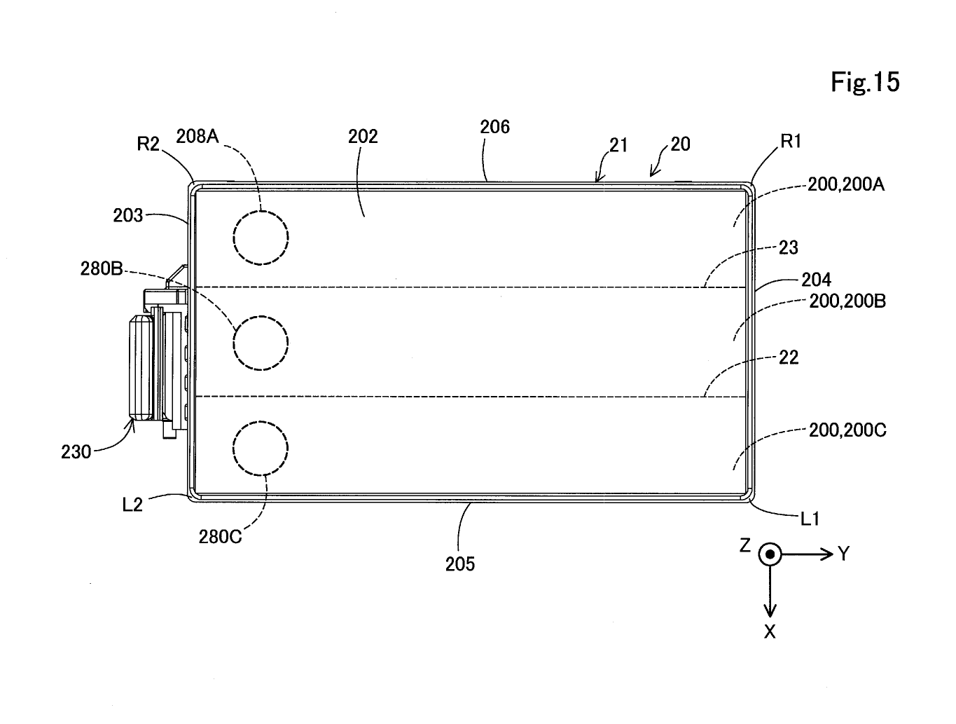

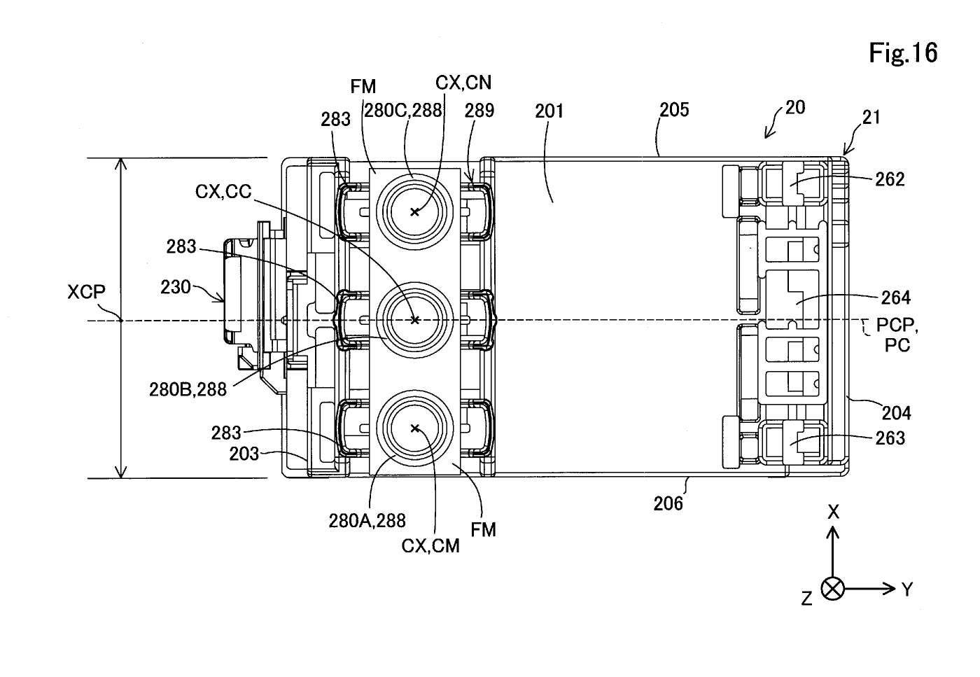

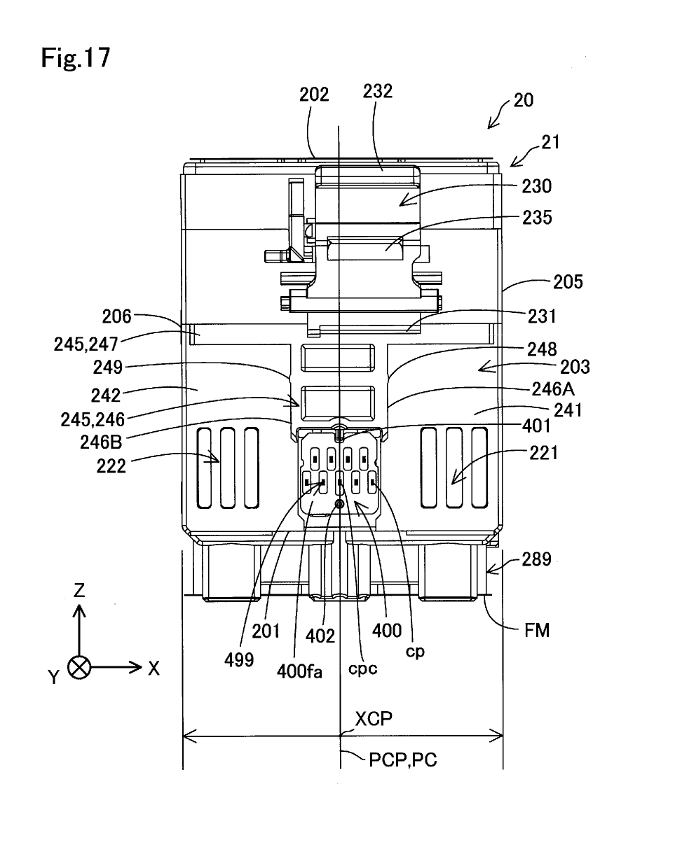

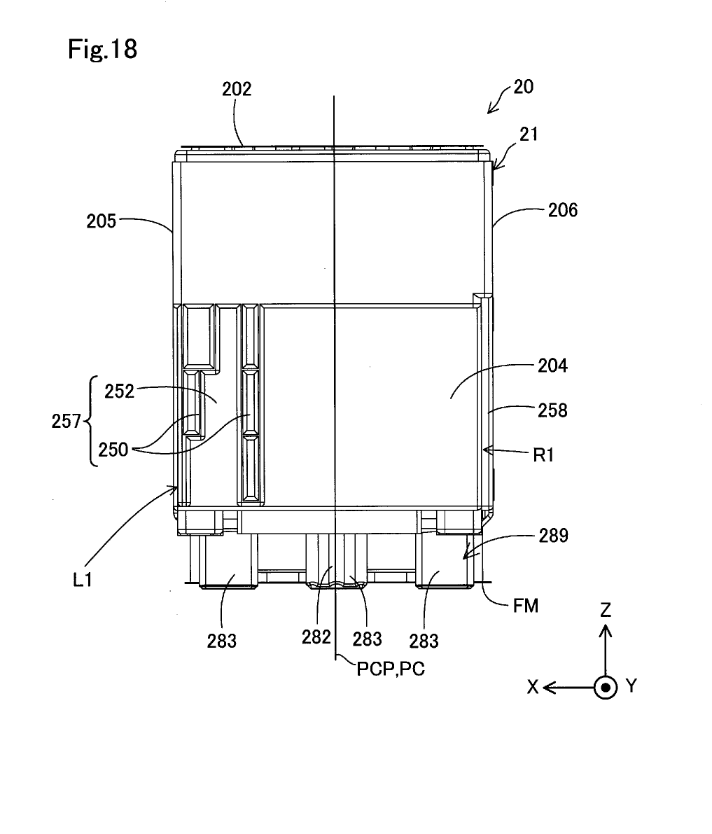

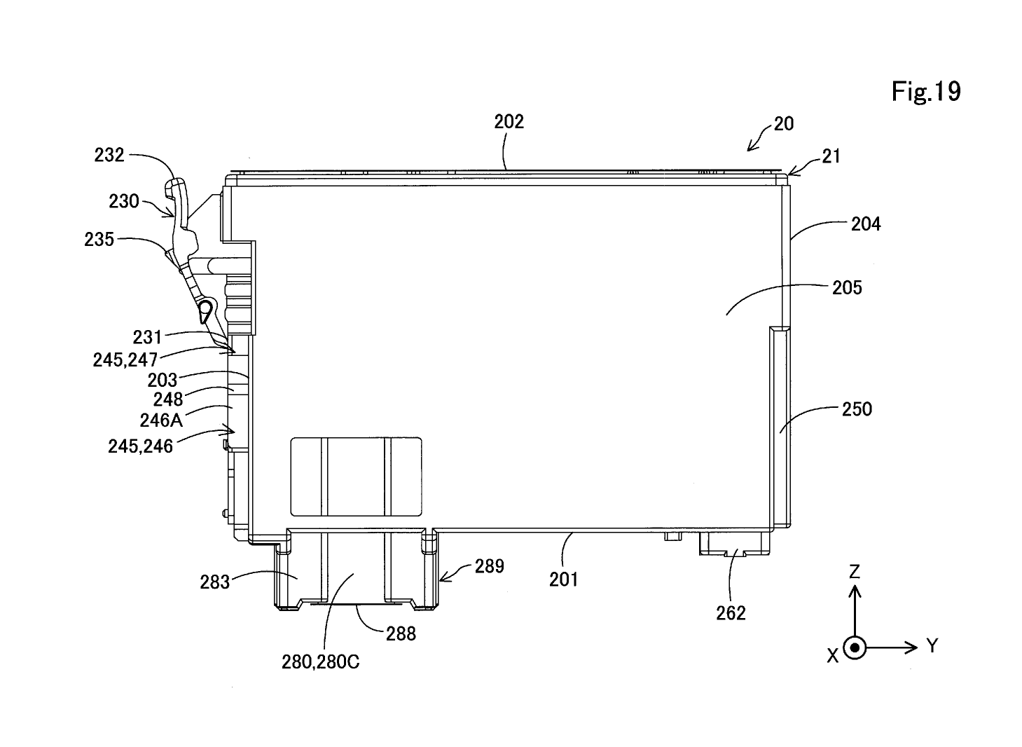

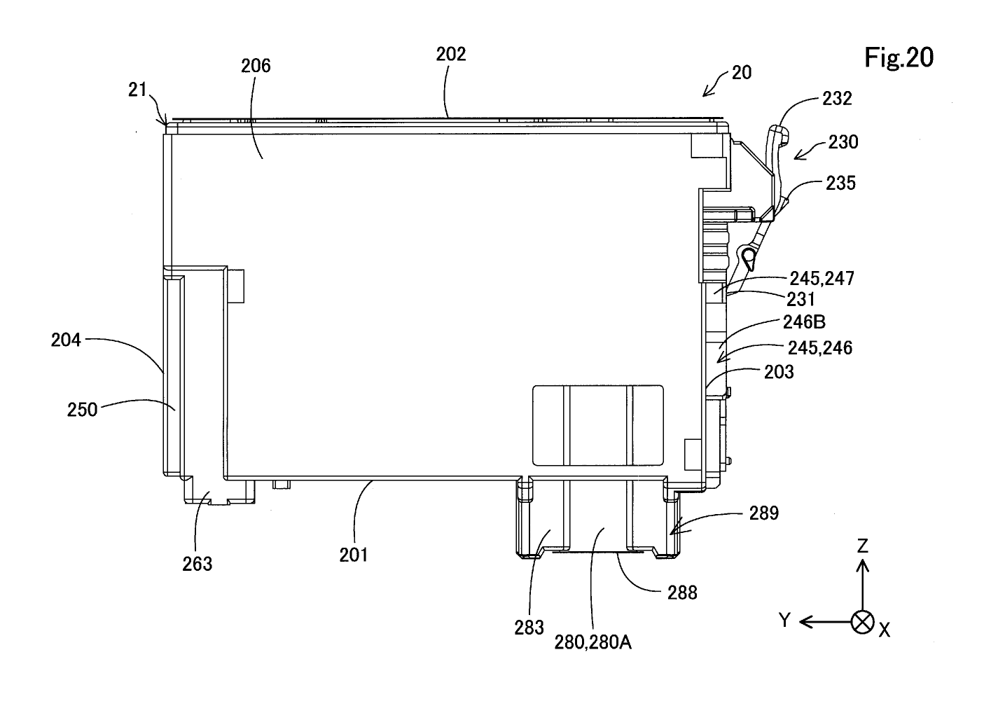

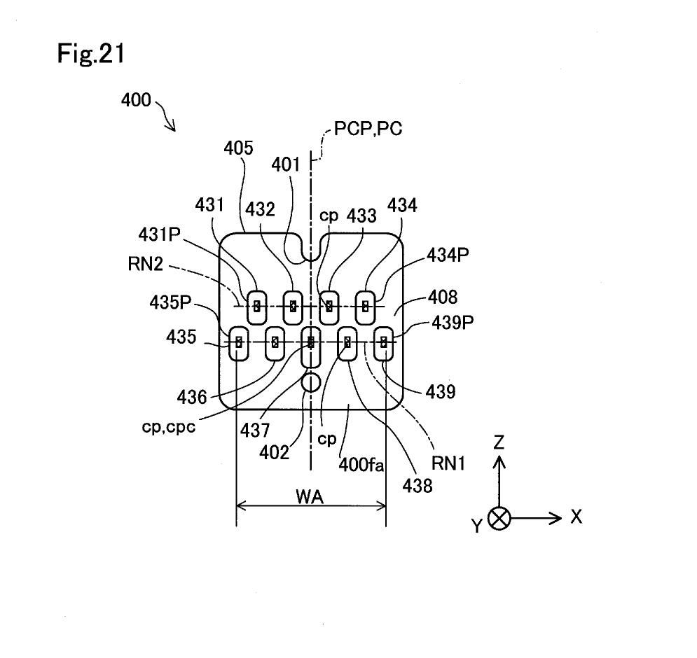

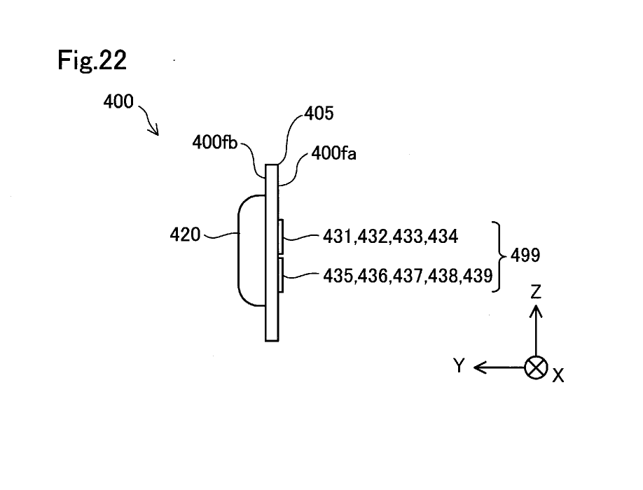

FIG. 13 is a first perspective view illustrating the second cartridge 20. FIG. 14 is a second perspective view illustrating the second cartridge 20. FIG. 15 is a top view illustrating the second cartridge 20. FIG. 16 is a bottom view illustrating the second cartridge 20. FIG. 17 is a rear view illustrating the second cartridge 20. FIG. 18 is a front view illustrating the second cartridge 20. FIG. 19 is a left side view illustrating the second cartridge 20. FIG. 20 is a right side view illustrating the second cartridge 20. FIG. 21 is a front view illustrating the circuit board 400. FIG. 22 is a side view illustrating the circuit board 400. As shown in FIG. 2, the second cartridge 20 is arrayed in the X direction with another cartridge (first cartridge) 10 having one liquid supply port and is mounted to the carriage 520. As in the case of the first cartridge 10, the mounting direction of the second cartridge 20 to the cartridge holder 60 is −Z direction, and the dismounting direction is +Z direction.

The second cartridge 20 (shown in FIG. 13) has a length (dimension in the Y direction), a height (dimension in the Z direction) and a width (dimension in the X direction) in descending order. The magnitude relationship of the length, the width and the height of the second cartridge 20 is, however, not limited to this embodiment but may be changed arbitrarily. For example, the second cartridge 20 may have the height, the length and the width in descending orders or may have the height, the length and the width that are equal to one another. The second cartridge 20 has the larger dimension in the X direction than the first cartridge 10.

As shown in FIG. 13 and FIG. 14, the second cartridge 20 has an approximately rectangular parallelepiped appearance shape. An outer shell 21 of the second cartridge 20 includes six surfaces. The six surfaces include a bottom surface 201, an upper surface 202, a first side surface (front surface) 204, a second side surface (rear surface) 203, a third side surface (left side surface) 205 and a fourth side surface (right side surface) 206. The six surfaces 201 to 206 form the outer shell 21 of the second cartridge 20. Each of the surfaces 201 to 206 is formed in a planar shape. The planar shape herein includes not only the case where the entire surface is completely flat but the case where part of the surface has some concavity and convexity. In other words, each planar surface is allowed to partly have some concavity and convexity. Each of the surfaces 201 to 206 is formed in an approximately rectangular outer shape in a plan view.

The second cartridge 20 (shown in FIG. 15) has a plurality of (three according to the embodiment) second liquid chambers 200A, 200B and 200C, each being configured to contain inside thereof one type of liquid among the multiple different types of liquids described above (yellow ink, magenta ink and cyan ink according to the embodiment). The multiple different types of liquids (yellow ink, magenta ink and cyan ink) contained in the second cartridge 20 are respectively dye inks.

The bottom surface 201 is a concept including a wall that forms a bottom wall of the second cartridge 20 in the mounting state and is also called “bottom surface wall portion (bottom wall) 201”. The upper surface 202 is a concept including a wall that forms an upper wall of the second cartridge 20 in the mounting state and is also called “upper surface wall portion (upper wall) 202”. The first side surface 204 is a concept including a wall that forms a front wall of the second cartridge 20 in the mounting state and is also called “front surface wall portion (front wall) 204”. The second side surface 203 is a concept including a wall that forms a rear wall of the second cartridge 20 in the mounting state and is also called “rear surface wall portion (rear wall) 203”. The third side surface 205 is a concept including a wall that forms a left side wall of the second cartridge 20 in the mounting state and is also called “left side surface wall portion (left side wall) 205”. The fourth side surface 206 is a concept including a wall that forms a right side wall of the second cartridge 20 in the mounting state and is also called “right side surface wall portion (right side wall) 206”. The “wall portion” or the “wall” herein may not be necessarily formed by a single wall but may be formed by a plurality of walls.

As shown in FIG. 19, the bottom surface 201 and the upper surface 202 are opposed to each other in the Z direction. The bottom surface 201 is located on the −Z direction side, and the upper surface 202 is located on the +Z direction side. In the mounting state, the bottom surface 201 is arranged to face the apparatus-side bottom wall portion 601 of the cartridge holder 60 (shown in FIG. 4). The bottom surface 201 and the upper surface 202 are horizontal surfaces in the mounting state. The bottom surface 201 and the upper surface 202 are arranged to intersect with the first side surface 204, the second side surface 203, the third side surface 205 and the fourth side surface 206 at approximately right angles. The bottom surface 201 and the upper surface 202 are surfaces parallel to the X direction and the Y direction. The bottom surface 201 and the upper surface 202 are surfaces perpendicular to the Z direction. Assuming that a surface parallel to the X direction and the Y direction (i.e., surface perpendicular to the Z direction) is expressed as an XY plane, the bottom surface 201 and the upper surface 202 are surfaces parallel to the XY plane.

As shown in FIG. 15, the first side surface 204 and the second side surface 203 are opposed to each other in the Y direction. The first side surface 204 is located on the +Y direction side, and the second side surface 203 is located on the −Y direction. In the mounting state, the first side surface 204 is arranged to face the second apparatus-side side wall portion 604 of the cartridge holder 60 (shown in FIG. 4). The second side surface 203 is arranged to face the first apparatus-side side wall portion 603 of the cartridge holder 60 (shown in FIG. 4). The first side surface 204 and the second side surface 203 are vertical surfaces in the mounting state. The first side surface 204 and the second side surface 203 are arranged to intersect with the bottom surface 201 (shown in FIG. 19), the upper surface 204 (shown in FIG. 19), the third side surface 205 and the fourth side surface 206 at approximately right angles. The first side surface 204 and the second side surface 203 are surfaces parallel to the X direction and the Z direction. The first side surface 204 and the second side surface 203 are surfaces perpendicular to the Y direction. Assuming that a surface parallel to the X direction and the Z direction (i.e., surface perpendicular to the Y direction) is expressed as an XZ plane, the first side surface 204 and the second side surface 203 are surfaces parallel to the XZ plane.

As shown in FIG. 15, the third side surface 205 and the fourth side surface 206 are opposed to each other in the X direction. The third side surface 205 is located on the +X direction side, and the fourth side surface 206 is located on the −X direction side. In the mounting state, the third side surface 205 is arranged to face the first cartridge 10. In the mounting state, the fourth side surface 206 is arranged to face the fourth apparatus-side side wall portion 606 of the cartridge holder 60 (shown in FIG. 4). The third side surface 205 and the fourth side surface 206 are arranged to intersect with the bottom surface 201, the upper surface 202, the first side surface 204 and the second side surface 203 at approximately right angles. The third side surface 205 and the fourth side surface 206 are surfaces parallel to the Y direction and the Z direction. The third side surface 205 and the fourth side surface 206 are surfaces perpendicular to the X direction. Assuming that a surface parallel to the Y direction and the Z direction (i.e., surface perpendicular to the X direction) is expressed as a YZ plane, the third side surface 205 and the fourth side surface 206 are surfaces parallel to the YZ plane.

As shown in FIG. 13 and FIG. 17, the second cartridge 20 is provided with the circuit board 400 and the engagement member 230 on the second side surface 203.

The second side surface 203 includes a first surface portion 242, a second surface portion 241 and a protruded surface portion 245. The protruded surface portion 245 is a part protruded toward the cartridge holder 60-side (outward, −Y direction side according to the embodiment) from the first surface portion 242 and the second surface portion 241. The protruded surface portion 245 has a larger wall thickness (dimension in the Y direction) than the wall thicknesses (dimensions in the Y direction) of the first surface portion 242 and the second surface portion 241 and has a higher rigidity than the rigidities of the first surface portion 242 and the second surface portion 241. The protruded surface portion 245 includes a first protruded surface portion 246 that is provided between the first surface portion 242 and the second surface portion 241 in the X direction, and a second protruded surface portion 247 that is connected with a +Z direction-side end of the first protruded surface portion 246. The first surface portion 242 is located on a −X direction side that is one direction side in the X direction of the first protruded surface portion 246. The second surface portion 241 is located on a +X direction side that is the other direction side in the X direction of the first protruded surface portion 246.

The first protruded surface portion 246 is extended in the +Z direction from an intersecting part of the bottom surface 201 and the second side surface 203 to the approximate center in the Z direction of the second cartridge 20. The first protruded surface portion 246 is a member in an approximately rectangular shape. In the mounting state of the second cartridge 20, the first protruded surface portion 246 is placed between the first regulating portion 635A and the second regulating portion 645B (shown in FIG. 4). The circuit board 400 is provided on the first protruded surface portion 246. A plurality of contact portions cp that come into contact with the apparatus-side terminal group 799 (shown in FIG. 7) in the second mounting portion 602T are placed on a surface 400fa of the circuit board 400. The surface 400fa serves as a placement portion where the plurality of contact portions cp are placed. The details of the circuit board 400 will be described later.

The first protruded surface portion 246 includes a first side portion 246B located on the first surface portion 242-side (−X direction side) and a second side portion 246A located on the second surface portion 241-side (+X direction side). The first side portion 246B is a part that forms a side surface on the first surface portion 242-side of the first protruded surface portion 246 and that is arranged to face in the −X direction. The second side portion 246A is a part that forms a side surface on the second surface portion 241-side of the first protruded surface portion 246 and that is arranged to face in the +X direction.

The first side portion 246B is provided with a first projection 249 that is protruded in the −X direction. The second side portion 246A is provided with a second projection 248 that is protruded in the +X direction. The first projection 249 and the second projection 248 are located on the upper surface 202-side (+Z direction side) of the contact portions cp on the circuit board 400 in the Z direction. In the mounting state of the second cartridge 20, the first projection 249 comes into contact with the first regulating portion 635A (shown in FIG. 5). In the mounting state of the second cartridge 20, the second projection 248 comes into contact with the second regulating portion 635B (shown in FIG. 4).

The first surface portion 242 has concave portions 222 that are provided away from the protruded surface portion 245. According to the embodiment, three concave portions 222 are provided. The second surface portion 241 has concave portions 221 that are provided away from the protruded surface portion 245. According to the embodiment, three concave portions 221 are provided. The concave portions 222 and 221 serve to increase the rigidities of the first surface portion 242 and the second surface portion 241. According to another embodiment, the concave portions 222 and 221 may be replaced with convex portions. According to another embodiment, convex portions may be provided in addition to the concave portions 222 and 221. Such modifications also increase the rigidities of the first surface portion 242 and the second surface portion 241.

The second protruded surface portion 247 is a part that is formed in an approximately rectangular parallelepiped shape and that is extended along the X direction. The second protruded surface portion 247 is connected with a base end portion (first end portion) 231 of the engagement member 230.

As shown in FIG. 17, the circuit board 400 is provided on the first protruded surface portion 246. The circuit board 400 includes a boss groove 401 formed on a +Z direction-side end and a boss hole 402 formed on a −Z direction-side end. The circuit board 400 is fixed to the first protruded surface portion 246 of the second cartridge 20 by means of the boss groove 401 and the boss hole 402. According to the embodiment, the boss groove 401 and the boss hole 402 pass through the center in the X direction of the second cartridge 20 and intersects with a plane PCP that is parallel to the Y direction and the Z direction (i.e., that is perpendicular to the X direction). According to another embodiment, at least one of the boss groove 401 and the boss hole 402 may be omitted from the circuit board 400, and the circuit board 400 may be fixed to the first protruded surface portion 246 by means of an adhesive or may be fixed by using an engagement claw (not shown) provided on the first protruded surface portion 246-side.

As shown in FIG. 22, the circuit board 400 includes a cartridge-side terminal group 499 (shown in FIG. 22) provided on the surface 400a serving as the placement portion, and a storage device 420 provided on a rear face 400fb. The surface 400fa and the rear face 400fb are plane surfaces. The surface 400fa is a surface that is parallel to the mounting direction (−Z direction) of the second cartridge 20. According to the embodiment, the surface 400fa is a surface parallel to the X direction and the Z direction. In the state that the circuit board 400 is mounted to the second cartridge 20, a most +Z-direction-side portion (one side) of the surface 400fa is called a board end portion 405.

The cartridge-side terminal group 499 consists of nine cartridge-side terminals 431 to 439. The storage device 420 stores information regarding the second cartridge 20. The information regarding the second cartridge 20 includes, for example, information indicating the types of liquids contained in the second cartridge 20, information indicating the amounts of the liquids contained therein, information indicating the consumed amounts of the liquids, and information indicating the manufacturing date of the second cartridge 20.

As shown in FIG. 21, the nine cartridge-side terminals 431 to 439 are respectively formed in an approximately rectangular shape and are arranged in two lines that are approximately perpendicular to the −Z direction as the mounting direction. The approximately perpendicular lines are lines extended in the width direction (X direction) of the second cartridge 20. Out of the two lines, a rear-side (−Z direction side) line in the mounting direction is called first terminal line RN1 (lower line RN1), and a front-side (+Z direction side) line in the mounting direction is called second terminal line RN2 (upper line RN2). Accordingly, the first terminal line RN1 and the second terminal line RN2 have different positions in the Z direction. More specifically, the first terminal line RN1 is located on the −Z direction side of the second terminal line RN2. The respective terminals 431 to 439 have contact portions cp on respective centers thereof, which come into contact with the apparatus-side terminal group 799 of the contact mechanism 70A (shown in FIG. 5 and FIG. 7). The first terminal line RN1 and the second terminal line RN2 described above may be regarded as lines formed by the plurality of contact portions cp.

The respective cartridge-side terminals 431 to 439 may be called as follows based on their functions (applications). In order to clarify the discrimination from the terminals on the liquid ejection apparatus 50-side, the respective names may have a prefix “cartridge-side”. For example, a “ground terminal 437” may be called “cartridge-side ground terminal 437”.

### <First Terminal Line RN1>

(1) mounting detection terminal (first terminal) 435;
(2) power supply terminal 436;
(3) ground terminal 437;
(4) data terminal 438; and
(5) mounting detection terminal (second terminal) 439.

### <Second Terminal Line RN2>

(6) mounting detection terminal (third terminal) 431;
(7) reset terminal 432;
(8) clock terminal 433; and
(9) mounting detection terminal (fourth terminal) 434.

The respective contact portions cp of the terminals 435 to 439 forming the first terminal line RN1 and the respective contact portions cp of the terminals 431 to 434 forming the second terminal line RN2 are arranged alternately. According to the embodiment, the respective contact portions cp are arranged in zigzag.

The four mounting detection terminals 431, 434, 435 and 439 are used to detect the good/poor electric contact with the corresponding terminals of the apparatus-side terminal group 799 (shown in FIG. 4) provided in the contact mechanism 70A and thereby enables the liquid ejection apparatus 50 to detect whether the second cartridge 20 is mounted correctly at a designed mounting position of the cartridge holder 60. Accordingly, the four mounting detection terminals 431, 434, 435 and 439 may collectively be called “mounting detection terminal group”. According to the embodiment, the four cartridge-side terminals 431, 434, 437 and 439 are electrically coupled to one another inside of the circuit board 400. When the second cartridge 20 is mounted to the cartridge holder 60 (shown in FIG. 4), the cartridge-side terminals 431, 434, 437 and 439 are electrically coupled to a ground line (not shown) on the liquid ejection apparatus 50-side via the ground terminal 437.

The other five cartridge-side terminals 432, 433, 436, 437 and 438 are terminals for the storage device 420. Accordingly, the five terminals 432, 433, 436, 437, and 438 may collectively be called “memory terminal group”.

The reset terminal 432 receives supply of a reset signal RST to the storage device 420. The clock terminal 433 receives supply of a clock signal SCK to the storage device 420. The power supply terminal 436 receives supply of a power supply voltage VDD (for example, rated voltage of 3.3 V) to the storage device 420. The ground terminal 437 receives supply of a ground voltage VSS (0 V) to the storage device 420. The data terminal 438 receives supply of a data signal SDA to the storage device 420.

The first terminal 435 as one of the mounting detection terminal group includes a first outside portion 435P that is located on a most −X direction side of the cartridge-side terminal group 499. The second terminal 439 as one of the mounting detection terminal group includes a second outside portion 439P that is located on a most +X direction side of the cartridge-side terminal group 499. The third terminal 431 as one of the mounting detection terminal group includes a third outside portion 431P that is located on a most −X direction side of the second terminal line RN2. The fourth terminal 434 as one of the mounting detection terminal group includes a fourth outside portion 414P that is located on a most +X direction side of the second terminal line RN2.

Among the plurality of contact portions cp, the ground terminal 437 including a contact portion (center contact portion) cp provided on the center in the X direction is placed at a position intersecting with the plane PCP. When the center contact portion cp is to be distinguished from the other contact portions cp, a reference sign “cpc” is used to express the center contact portion. The contact portions cp of the remaining terminals 431 to 436, 438 and 439 are provided at positions symmetric with respect to a line of intersection of this plane PCP and the ground terminal 437 as the axis. Accordingly, the plurality of (nine according to the embodiment) contact portion cp are arranged to be symmetric with respect to the plane PCP. The plane PCP is identical with a first center plane PC described later.

As shown in FIG. 17, the plurality of contact portions cp of the circuit board 400 are arrayed in the X direction on the second side surface 203 at a position closer to the bottom surface 201 than the upper surface 202. The expression that the the plurality of contact portions cp are arrayed in the X direction means that the the plurality of contact portions cp are arranged at different positions in the X direction.

The ground terminal 437 (shown in FIG. 21) is configured to come into contact with the contact mechanism 70A before the other cartridge-side terminals 431 to 436, 438 and 439 (shown in FIG. 21) come into contact with the contact mechanism 70A when the second cartridge 20 is mounted to the cartridge holder 60. This configuration causes a biasing force that is first applied from the cartridge holder 60 to the circuit board 400, to be generated on the center in the X direction of the second cartridge 20. This suppresses the function of causing the biasing force applied to the circuit board 40 to act as a force of tilting the second cartridge 20 in the X direction and enables the second cartridge 20 to be mounted at the designed mounting position. Since the ground terminal 437 comes into contact with the contact mechanism 70A of the cartridge holder 60 prior to the other cartridge-side terminals 431 to 436, 438 and 439, even when an unintentional high voltage is applied to the second cartridge 20-side, the grounding function of the ground terminal 437 reduces a trouble caused by the high voltage.

As shown in FIG. 13 and FIG. 17, the engagement member 230 is provided in the form of a lever on the upper surface 202-side of the contact portions cp on the second side surface 203. Accordingly, at least part of the engagement member 230 is located in a range WA (shown in FIG. 21) where the plurality of contact portions cp are located in the X direction. The engagement member 230 includes a first end portion (base end portion) 231 on the −Z direction side, a second end portion (leading end portion) 232 on the +Z direction side, and a cartridge-side engagement portion 235 located between the first end portion 231 and the second end portion 232. The first end portion 231 is connected with the second protruded surface portion 247 of the second side surface 203. The engagement member 230 is elastically deformed in a direction including a Y-direction component about the first end portion 231 as the center, such that the second end portion 232-side comes close to and goes away from the second side surface 203. Such elastic deformation is used to mount and dismount the second cartridge 20 to and from the cartridge holder 60 (shown in FIG. 4). The cartridge-side engagement portion 235 is a projection protruded in the −Y direction from a main body of the engagement member 230. The cartridge-side engagement portion 235 is extended along the X direction. In the mounting state of the second cartridge 20, an upper surface of the cartridge-side engagement portion 235 is locked by the lower surface 633 of the apparatus-side engagement portion 632A (shown in FIG. 10). This lock is released when the second end portion 232 is pressed to come close to the second side surface 203-side to displace the cartridge-side engagement portion 235 toward the second side surface 203-side.

As shown in FIG. 14, the second cartridge 20 includes a liquid supply portion 289, projections 262 and 263 and a recessed portion 264 provided on the bottom surface 201. The liquid supply portion 289 is protruded in the −Z direction from the bottom surface 201. In the mounting state of the second cartridge 20, at least a −Z direction-side part of the liquid supply portion 289 is placed in the area 611 (shown in FIG. 3) where the three liquid supply needles 640A, 640B and 640C are surrounded by the apparatus-side restriction wall portions 615. The liquid supply portion 289 includes an odd number of (three according to the embodiment) liquid supply ports 280A, 280B and 280C and three surrounding members 283A, 283B and 283C provided corresponding to the respective liquid supply ports 280A, 280B and 280C. When there is no need to distinguish the three liquid supply ports 280A, 280B and 280C from one another, a reference sign “280” is used. When there is no need to distinguish the three surrounding members 283A, 283B and 283C from one another, a reference sign “283” is used.

As shown in FIG. 14 and FIG. 16, the three liquid supply ports 280A, 280B and 280C are placed on the bottom surface 201 at a position closer to the second side surface 203 than the first side surface 204. More specifically, the three liquid supply ports 280A, 280B and 280C are placed on the bottom surface 201 at a position closer to the second side surface 203 relative to a middle position between the first side surface 204 and the second side surface 203. According to the embodiment, the three liquid supply ports 280A, 280B and 280C are placed near to the second side surface 203. More specifically, the three liquid supply ports 280A, 280B and 280C are placed on the bottom surface 201 at a position leaning to the second side surface 203-side. Each of the three liquid supply ports 280A, 280B and 280C is formed in a cylindrical shape and has a −Z direction side that is protruded from the bottom surface 201 and a +Z direction side that is placed inside of the outer shell 21. The three liquid supply ports 280A, 280B and 280C respectively have center axes CM, CC, and CN along the Z direction. When there is no need to distinguish the center axes CM, CC and CN, an expression of “center axis CX” is used.

The three liquid supply ports 280A, 280B and 280C are arrayed in the X direction. According to the embodiment, the three center axes CM, CC and CN are aligned parallel to the X direction. In other words, the three center axes CM, CC and CN are all located on the XZ plane that is parallel to the X direction and the Z direction (i.e., that is orthogonal to the Y direction). According to another embodiment, the three liquid supply ports 280A, 280B and 280C should be arranged to intersect with a predetermined straight line along the X direction, and the three center axes CM, CC and CN may not be necessarily placed on the same XZ plane. The valve mechanism 284 described above (shown in FIG. 10) is placed inside of each of the three liquid supply ports 280A, 280B and 280C.

As shown in FIG. 16, the liquid supply port (middle liquid supply port) 280B is located in the center of (at the second position from the −X direction side or from the +X direction side) the three liquid supply ports 280A, 280B and 280C. The expression of “locating in the center” means locating at an {(N+1)/2}-th position from one direction side in the X direction (for example, from the −X direction side) among N (where N denotes an odd number equal to or greater than 3) liquid supply ports arrayed in the X direction. The center axis CC of the middle liquid supply port 280B goes through a center XCP of the second cartridge 20 in the X direction and intersects with the plane PCP that is parallel to the Y direction and the Z direction (i.e., that is perpendicular to the X axis).

As shown in FIG. 9 and FIG. 16, the other two liquid supply ports 280A and 280C are located adjacent to the middle liquid supply port 280B. The liquid supply port 280 is located on the +X direction side of the middle liquid supply port 280B. The liquid supply port 280C is located on the side near to the center of the carriage 520 (shown in FIG. 4) in the X direction. Accordingly, the liquid supply port 280C is located at a position nearer to the first mounting portion 602W-side (shown in FIG. 4) than the liquid supply port 280A in the X direction. The liquid supply port 280C is located on the first cartridge 10-side. The liquid supply port 280A is located on the −X direction side of the middle liquid supply port 280B. Accordingly, the liquid supply port 280A is located at a position farthest from the first mounting portion 602W (first cartridge 10) in the X direction. The center axis CC of the middle liquid supply port 280B is also called first center axis CC. The center axis CN of the liquid supply port 280C is also called second center axis CN.

As shown in FIG. 14, each of the liquid supply ports 280A, 280B and 280C has an opening 288 on its −Z direction side end. The opening 288 is in a circular shape. The liquid supply port 280 may, however, not be necessarily in a cylindrical shape, and the opening 288 may not be necessarily in a circular shape. The liquid supply port 280 may be in any shat that enables the liquid supply needle 640 to be inserted therein. In this case, the center axis CT of the liquid supply needle 640 in the mounting state may be regarded as a center axis of the liquid supply port 280.

As shown in FIG. 9, in the mounting state that the second cartridge 20 is mounted to the carriage 520, the liquid supply needles 640A, 640B and 640C provided in the second mounting portion 602T of the cartridge holder 60 are respectively inserted into the liquid supply ports 280A, 280B and 280C. In other words, in the mounting state that the second cartridge 20 is mounted to the carriage 520, the liquid supply ports 280A, 280B and 280C respectively receive the liquid supply needles 640A, 640B and 640C. As shown in FIG. 14, in the second cartridge 20 prior to mounting to the second mounting portion 602T, the openings 288 are closed by a film FM. The film FM is configured to be broken by the liquid supply needles 640A, 640B and 640C when the second cartridge 20 is mounted to the second mounting portion 602T.

As shown in FIG. 15, the liquid supply port 280A communicates with the second liquid chamber 200A that contains yellow ink therein and serves to supply the yellow ink contained in the second liquid chamber 200A to the liquid supply needle 640A. The liquid supply port 280B communicates with the second liquid chamber 200B that contains magenta ink therein and serves to supply the magenta ink contained in the second liquid chamber 200B to the liquid supply needle 640B. The liquid supply port 280C communicates with the second liquid chamber 200C that contains cyan ink therein and serves to supply the cyan ink contained in the second liquid chamber 200C to the liquid supply needle 640C.

As shown in FIG. 14, the surrounding members 283A, 283B and 283C are members protruded in the −Z direction from the bottom surface 201. The surrounding member 283A is protruded from an outer circumferential surface of the liquid supply port 280A to both sides in the Y direction (i.e., toward the +Y direction side and the −Y direction side). The surrounding member 283B is protruded from an outer circumferential surface of the liquid supply port 280B to both sides in the Y direction (i.e., toward the +Y direction side and the −Y direction side). The surrounding member 283C is protruded from an outer circumferential surface of the liquid supply port 280C to both sides in the Y direction (i.e., toward the +Y direction side and the −Y direction side). In the mounting state of the second cartridge 20, the surrounding members 283A, 283B and 283C are opposed to the apparatus-side restriction wall portions 615 (shown in FIG. 3) in the X direction and in the Y direction. This configuration reduces the possibility that the liquid supply ports 280A, 280B and 280C move in the X direction and in the Y direction in the mounting state. Among the three surrounding members 283A, 283B and 283C, the middle surrounding member 283B has a restriction convex 282 on its +Y direction-side side surface. The restriction convex 282 is located on the +Y direction side of the middle liquid supply port 280B. The restriction convex 282 is protruded in the +Y direction from the remaining part of the surface of the middle surrounding member 283B. The restriction convex 282 is extended along the Z direction. In the mounting state that the second cartridge 20 is mounted to the second mounting portion 602T (shown in FIG. 2 and FIG. 3), the restriction convex 282 comes into contact with the apparatus-side restriction wall portion 615 (shown in FIG. 5).

The projections 262 and 263 are respectively protruded in the −Z direction from the bottom surface 201. The projections 262 and 263 are formed in an approximately rectangular parallelepiped shape. One of the projections 262 and 263 may be called as first projection 262, and the other as second projection 263. As shown in FIG. 14 and FIG. 16, the projections 262 and 263 are provided on the bottom surface 201 at positions closer to the first side surface 204 than the second side surface 203. According to the embodiment, the projections 262 and 263 are provided to abut on a lower end of the first side surface 204. The first projection 262 and the second projection 263 are provided across the plane PCP that includes the center axis CC of the middle liquid supply port 280B and that is perpendicular to the X direction. The first projection 262 is provided on the bottom surface 201 at a position near to the third side surface 205. The second projection 263 is provided on the bottom surface 201 at a position near to the fourth side surface 206. The functions of the projections 262 and 263 will be described later.

As shown in FIG. 14 and FIG. 16, the recessed portion 264 is provided on the bottom surface 201 at a position closer to the first side surface 204 than the second side surface 203. The recessed portion 264 is provided to abut on the lower end of the first side surface 204. The recessed portion 264 is located between the first projection 262 and the second projection 263. The recessed portion 264, the first projection 262 and the second projection 263 are arrayed along the X direction. In the mounting state of the second cartridge 20, the recessed portion 264 receives the apparatus-side projection 638 (shown in FIG. 3 and FIG. 5).

As shown in FIG. 14 and FIG. 18, the second cartridge 20 includes a concavo-convex portion 257 provided on the first side surface 204. The concavo-convex portion 257 is provided on at least one end portion of the first side surface 204, out of one end portion (corner portion) L1 in the X direction (+X direction end) and the other end portion (corner portion) R1 in the X direction (−X direction end). According to the embodiment, the concavo-convex portion 257 is provided on the end portion L1 of the first side surface 204. Accordingly, at least part of the concavo-convex portion 257 is provided to abut on the end portion L1 where the first side surface 204 intersects with the third side surface 205.

The concavo-convex portion 257 includes convex portions 250 and a concave portion 252 defined by the convex portions 250. The concavo-convex portion 257 is extended from the bottom surface 201-side toward the upper surface 202-side on the first side surface 204. According to the embodiment, the concavo-convex portion 257 is extended in the +Z direction from an intersecting part of the first side surface 204 and the bottom surface 201 to an approximate center in the Z direction of the first side surface 204. A −Z direction side of the concave portion 252 is open to receive the cartridge identification convex 616. The shape of the concavo-convex portion 257 differs according to the type of cartridge (for example, the model number). The concavo-convex portion 257 is fit with the cartridge identification convex 616 (shown in FIG. 3) only when the second cartridge 20 having the concavo-convex portion 257 in the shape shown in FIG. 14 and FIG. 18 is mounted to the second mounting portion 602T (shown in FIG. 2 and FIG. 3). More specifically, the cartridge identification convex 616 corresponding to the shape of the concave portion 252 of the concavo-convex portion 257 is fit in the concave portion 252 of the concavo-convex portion 257. When any wrong type of cartridge is tried to be mounted to the second mounting portion 602T, a concavo-convex portion of this cartridge does not match the shape of the cartridge identification convex 616 and partly collides with the cartridge identification convex 616. The wrong type of cartridge can thus not be mounted to the second mounting portion 602T. The presence of the concavo-convex portion 257 accordingly prevents any wrong type of cartridge from being mounted to the second mounting portion 602T.

As shown in FIG. 14, the second cartridge 20 further includes a concave portion 258 provided at the corner portion R1 where the first side surface 204 intersects with the fourth side surface 206. The concave portion 258 is extended from the bottom surface 201-side toward the upper surface 202-side of the first side surface 204. According to the embodiment, the concave portion 258 is extended in the +Z direction from an intersecting part of the first side surface 204 and the bottom surface 201 to an approximate center in the Z direction of the first side surface 204. The concave portion 258 is formed in a shape recessed inward of the outer shell 21 from both the first side surface 204 and the fourth side surface 206. The concave portion 258 includes a surface 258fa arranged to face in the −X direction and a surface 258b arranged to face in the +Y direction.

In the mounting state of the second cartridge 20, the concave portion 258 receives the guide projection 617 (shown in FIG. 3 and FIG. 5). According to another embodiment, the concave portion 258 may be provided in at least one corner portion among the corner portion R1, the corner portion L1 where the first side surface 204 intersects with the third side surface 205, a corner portion L2 (shown in FIG. 15) where the second side surface 203 intersects with the third side surface 205, and a corner portion R2 (shown in FIG. 15) where the second side surface 203 intersects with the fourth side surface 206.

As shown in FIG. 13, the second side surface 203 is provided with the first surface portion 242, the second surface portion 241 and the protruded surface portion 245 and accordingly has a concavo-convex structure. This increases the rigidity of the second side surface 203. The circuit board 400 is provided on the protruded surface portion 245 (more specifically, the first protruded surface portion 246) of the second side surface 203 having the higher rigidity. This reduces the possibility that the protruded surface portion 245 is deformed by an external force. Accordingly, this suppresses a variation in position of the contact portions cp provided on the surface 400fa of the circuit board 400 in the mounting state and thereby maintains the good contact between the contact portions cp of the circuit board 400 and the apparatus-side terminal group 799.

The engagement member 230 is provided on the protruded surface portion 245 (more specifically, the second protruded surface portion 247) having the higher rigidity. This also reduces the possibility that the protruded surface portion 245 is deformed by an external force. This accordingly reduces the possibility that an excess load is applied to the engagement member 230 and reduces the possibility of deformation of the engagement member 230 and the possibility of displacement of the locking position of the cartridge-side engagement portion 235 with the apparatus-side engagement portion 632A. This maintains the good contact between the contact portions cp of the circuit board 400 and the apparatus-side terminal group 799.

As shown in FIG. 13 and FIG. 14, the second cartridge 20 has the protruded surface portion 245 on the second side surface 203, while not having a protruded surface portion on the first side surface 204 that is opposed to the second side surface 203 in the Y direction. This configuration enables the user to use the protruded surface portion 245 as a mark when mounting the second cartridge 20 to the carriage 520. This configuration reduces the possibility that the second cartridge 20 in such an attitude that the first side surface 204 and the second side surface 203 are inverted is mounted to the carriage 520.

As shown in FIG. 13, the configuration of providing the circuit board 400 on the first protruded surface portion 246 increases the possibility that the surface 400fa of the circuit board 400 collides with the ground or another surface prior to the remaining part when the user or the manufacturer mistakenly drops down the second cartridge 20 during transportation or the like. This increases the possibility that the circuit board 400 or its storage device (memory) is purposely broken when the second cartridge 20 is dropped down. This accordingly enables the controller 510 of the liquid ejection apparatus 50 to readily detect a failure of the second cartridge 20 when the second cartridge 20 is mounted to the carriage 520. When the remaining part of the second cartridge 20 other than the contact portions cp (for example, the upper surface or the bottom surface) is damaged, the controller 510 may fail to detect a failure of the second cartridge 20 when the second cartridge 20 is mounted to the carriage 520. The liquid ejection apparatus 50 is then likely to be operated irrespective of the damage of the second cartridge 20 and to be thereby broken.

A-6. Positional Relationship of Respective Components of Second Cartridge 20

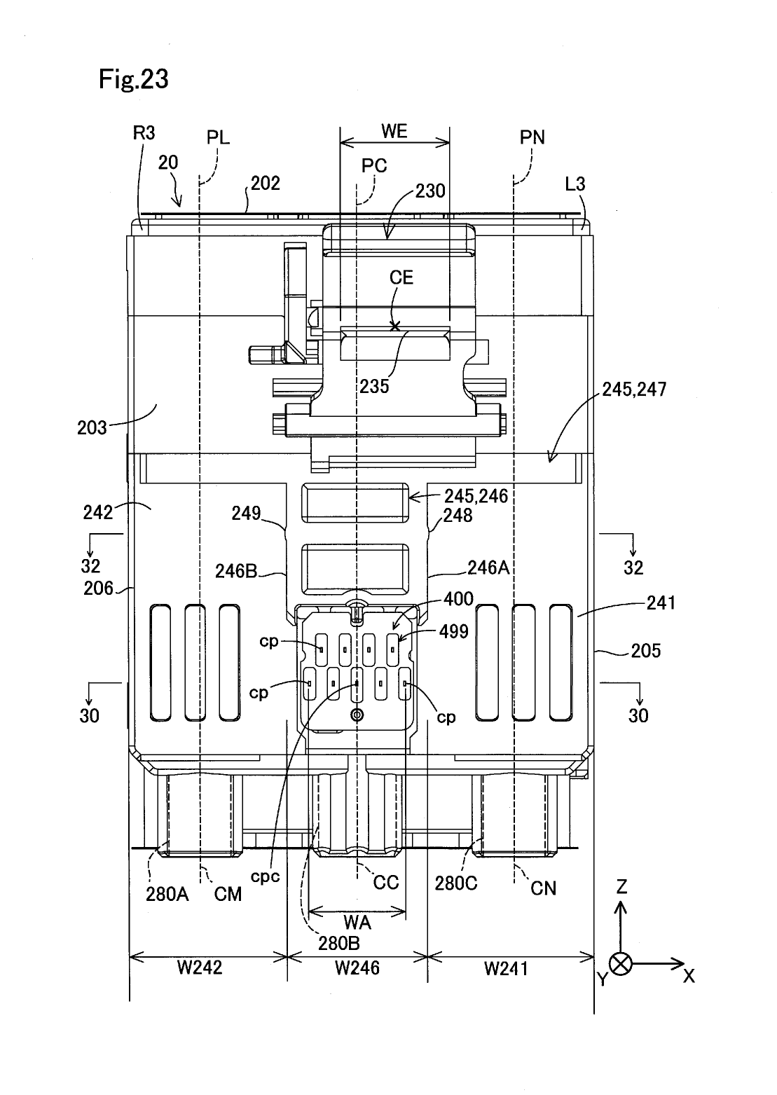

FIG. 23 is a diagram illustrating the positional relationship of the respective components of the second cartridge 20. FIG. 23 illustrates the second cartridge 20 viewed in a direction from the second side surface 203-side toward the first side surface 204-side of the Y direction (i.e., in the +Y direction).

As shown in FIG. 23, a plane that includes the first center axis CC and that is perpendicular to the X direction (i.e., that is parallel to the Y direction and the Z direction) is defined as a first center plane (predetermined YZ plane) PC. According to the embodiment, the first center plane PC is identical with the plane PCP described above (shown in FIG. 17). A plane that includes the second center axis CN and that is perpendicular to the X direction (i.e., that is parallel to the Y direction and the Z direction) is defined as a second center plane PN. A plane that includes the third center axis CM and that is perpendicular to the X direction (i.e., that is parallel to the Y direction and the Z direction) is defined as a third center plane PL. A center in the X direction of the cartridge-side engagement portion 235 is defined as an engagement center CE. With regard to the X direction, a range where the first protruded surface portion 246 is located is defined as a range W246, a range where the first surface portion 242 is located is defined as a range W242, and a range where the second surface portion 241 is located is defined as a range W241.

The center contact portion cpc provided at the center in the X direction of the multiple contact portions cp is arranged to intersect with the first center plane PC. The engagement center CE is at a position away in the +X direction from the first center plane PC. The engagement center CE is located between the first center plane PC and the second center plane PN. With regard to the X direction, part of the multiple contact portions cp are placed in a range WE where the cartridge-side engagement portion 235 is located. In other words, when the second cartridge 20 is viewed from the +Z direction side, part of the multiple contact portions cp overlaps with the cartridge-side engagement portion 235 in the X direction. According to the embodiment, part of the contact portions cp including the center contact portion cpc is placed in the range WE in the X direction.

The first protruded surface portion 246 is arranged to intersect with the first center plane PC. With regard to the X direction, the center axis CC of the middle liquid supply port 280B is placed in the range W246 where the first protruded surface portion 246 is located. With regard to the X direction, the center axis CM of the liquid supply port 280A that is located on the −X direction side of the middle liquid supply port 280B is placed in the range W242 where the first surface portion 242 is located. With regard to the X direction, the center axis CN of the liquid supply port 280C that is located on the +X direction side of the middle liquid supply port 280B is placed in the range W241 where the second surface portion 241 is located.

A-7. External Forces Applied to Cartridge 20

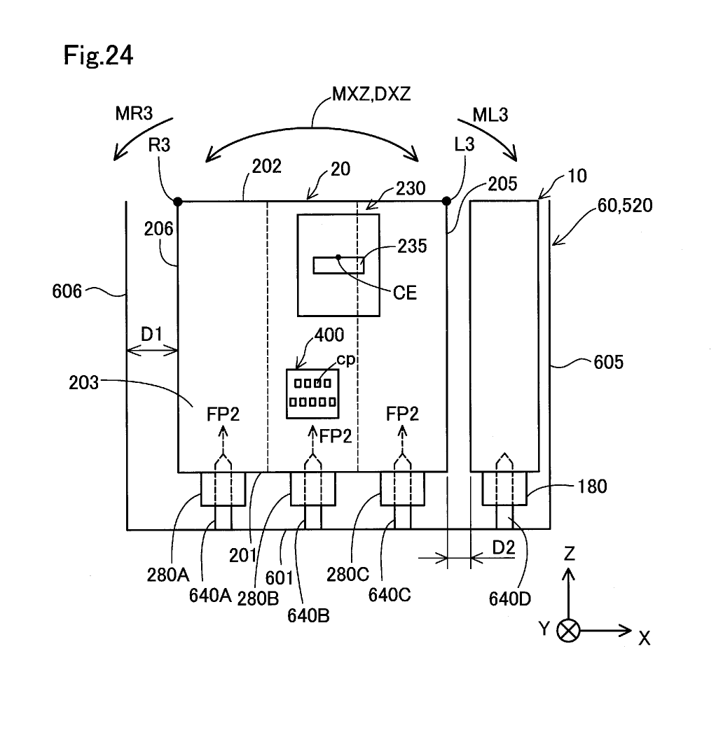

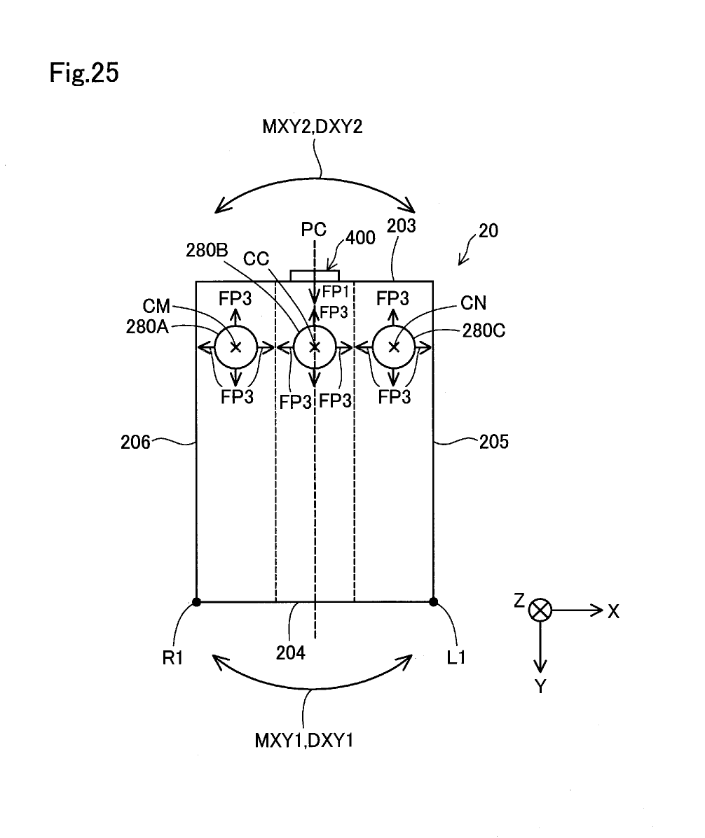

FIG. 24 is a first diagram illustrating external forces applied to the second cartridge 20. FIG. 25 is a second diagram illustrating external forces applied to the second cartridge 20. In the mounting state that the second cartridge 20 is mounted to the cartridge holder 60, an external force FP1 (shown in FIG. 25), external forces FP2 (shown in FIG. 24) and external forces FP3 (shown in FIG. 25) are applied to the second cartridge 20.

The external force FP1 (shown in FIG. 25) is an external force (biasing force) applied from the apparatus-side terminal group 799 of the contact mechanism 70A to the contact portions cp of the circuit board 400. The external force FP1 is a force in the +Y direction. The external forces FP2 (shown in FIG. 24) are external forces (reaction forces) generated when the valve elements 286 are pressed up in the +Z direction by the liquid supply needles 640A, 640B and 640C to compress the biasing members 285. The external forces FP2 are forced in the +Z direction. The external forces FP3 (shown in FIG. 25) are external forces generated by reaction forces of elastic deformation when the seal portions 287 are elastically deformed by the liquid supply needles 640A, 640B and 640C. The external forces FP3 are forces along the XY plane that is parallel to the X direction and the Y direction. The second cartridge 20 is likely to be slightly moved even in the state mounted to the second mounting portion 602T by these external forces FP1 to FP3.

When the carriage 520 is located at a halfway point in the moving direction (switchover point in the moving direction), the carriage 520 has a high acceleration or a high deceleration. Accordingly, a large force of inertia due to acceleration or deceleration is generated in the second cartridge 20. This force of inertia generates rotating moments MXZ, MXY1 and MXY2 in the second cartridge 20.

The rotating moment MXZ (shown in FIG. 24) causes the second cartridge 20 to swing in a direction DXZ along the XZ plane that is parallel to the X direction and the Z direction, about the insertion positions of liquid supply needles 640A, 640B and 640C into the liquid supply ports 280A, 280B and 280C as the center. The second cartridge 20 has a larger motion by the rotating moment MXZ with an increase in distance from the liquid supply ports 280A, 280B and 280C (more strictly, contact locations of the liquid supply needles 640 with the seal portions 287 of the valve mechanisms 284). The rotating moment MXY2 (shown in FIG. 25) causes the second cartridge 20 to rotate in a direction DXY2 along the XY plane that is parallel to the X direction and the Y direction about the vicinity of the center axis CC as the center. The rotating moment MXY1 (shown in FIG. 25) causes the first side surface 204-side of second cartridge 20 to rotate in a direction DXY1 along the XY plane that is parallel to the X direction and the Y direction about the vicinity of the center axis CC as the center. The second cartridge 20 has a larger motion by the rotating moments MXY1 and MXY2 with an increase in distance from the center axis CC. The rotational transfer and the swinging of the XZ plane and the XY plane about the three center axes CM, CC and CN may be regarded as rotational transfer and swinging about the first center axis CC. This is because the first center axis CC is located in the middle of the three center axes CM, CC and CN in the X direction.

The external forces FP1 to FP3 and the rotating moments MXZ, MXY1 and MXY2 may similarly applied to the first cartridge 10, like the second cartridge 20. The second cartridge 20 is, however, a cartridge configured to contain multiple different types of inks therein and tends to have a larger weight than the first cartridge 10. The second cartridge 20 accordingly receives a significantly larger force of inertia caused by acceleration or deceleration of the carriage 520 and has the larger rotating moments MXZ, MXY1 and MXY2. The second cartridge 20 is thus likely to significantly move accompanied with the reciprocating motion of the carriage 520. The second cartridge 20 accordingly needs a different ingenuity from that for the first cartridge 10 to appropriately maintain the contact between the apparatus-side terminal group 799 and the contact portions cp.

A-8. Restriction of Motions of Second Cartridge

A-8-1. External Force FP2 and Rotating Moment MXZ

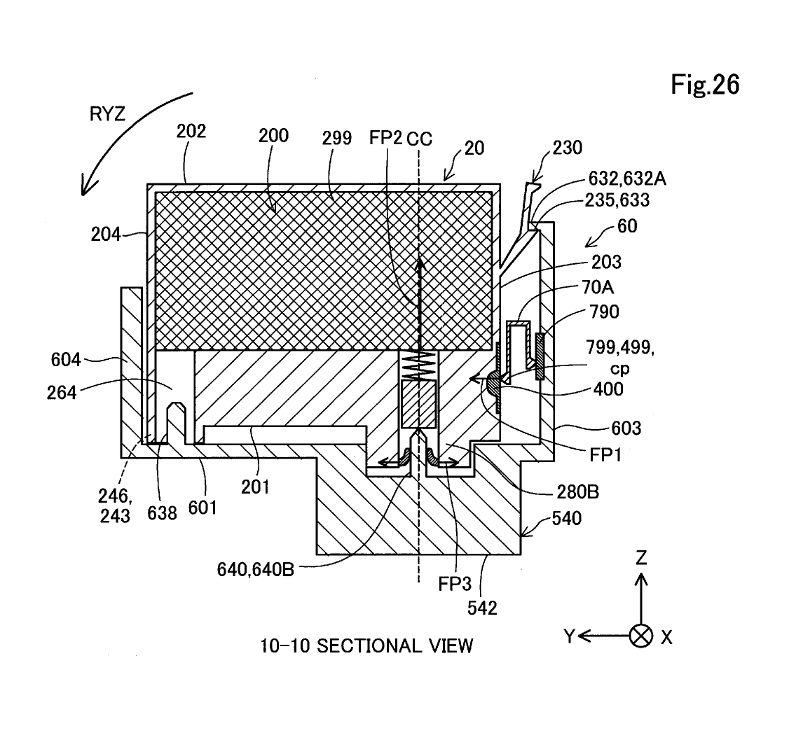

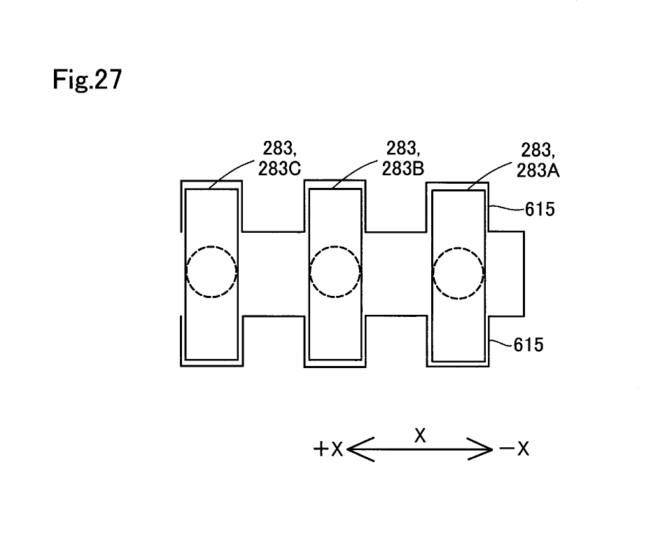

FIG. 26 is a diagram illustrating the configuration of restricting the motion of the second cartridge 20. FIG. 27 is a diagram illustrating restriction of the motion of the second cartridge 20 in the X direction.

As shown in FIG. 26, in the mounting state of the second cartridge 20, the cartridge-side engagement portion 235 (more strictly, an upper surface of the cartridge-side engagement portion 235) is locked by the lower surface 633 of the apparatus-side engagement portion 632A. This reduces the motion of the second cartridge 20 by the effects of the external force FP2 and the rotating moment MXZ (shown in FIG. 24). This accordingly reduces a variation in position of the contact portions cp of the circuit board 400 relative to the apparatus-side terminal group 799 and thereby maintains the good contact between the contact portions cp of the circuit board 400 and the apparatus-side terminal group 799.

The effect of the rotating moment MXZ shown in FIG. 24 on the variation in position of the contact portions cp is suppressed by the configuration that the contact portions cp are placed on the second side surface 203 at a position closer to the bottom surface 201-side than the upper surface 202-side, i.e., at a position near to the liquid supply ports 280A, 280B and 280C. As described above, the second cartridge 20 has the larger motion by the rotating moment MXZ with an increase in distance from the liquid supply ports 280A, 280B and 280C (more strictly, the contact locations of the liquid supply needles 640 with the seal portions 287 of the valve mechanisms 284). The contact portions cp are provided at a position near to the liquid supply ports 280A, 280B and 280C. This configuration reduces a variation in position of the contact portions cp even when the second cartridge 20 is rotated in the direction DXY2 along the XY plane that is parallel to the X direction and the Y direction about the center axes CM, CC, and CN.

According to the embodiment, as shown in FIG. 23, with regard to the X direction, part of the multiple contact portions cp are placed in the range WE where the cartridge-side engagement portion 235 is located. In other words, the range WE and the range WA partly overlap with each other in the X direction. The engagement center CE is located between the first center plane PC and the second center plane PN. This configuration also suppresses the effect of the rotating moment MXZ on the variation in position of the contact portions cp. The following describes this reason with reference to FIG. 24.

An intersecting part of the second side surface 203, a third side surface 205 and the upper surface 202 is defined as a corner portion L3. An intersecting part of the second side surface 203, the fourth side surface 206 and the upper surface 202 is defined as a corner portion R3. On the assumption that the second cartridge 20 is not provided with the engagement member 230, the corner portion R3 and the corner portion L3 have approximately identical rotating moments MZX caused by acceleration or deceleration of the carriage 520. When the carriage 520 turns back on the −X direction side, a counterclockwise rotating moment MR3 out of the rotating moment MXZ shown in FIG. 24 is applied to the corner portion R3 (in the first case). When the carriage 520 turns back on the +X direction side, on the other hand, a clockwise rotating moment ML3 out of the rotating moment MXZ shown in FIG. 24 is applied to the corner portion L3 (in the second case). The magnitude of the rotating moment MR3 is almost equal to the magnitude of the rotating moment ML3. As described above with reference to FIG. 9, in the mounting state of the first cartridge 10 and the second cartridge 20, the distance D1 between the second cartridge 20 and the cartridge holder 60 is larger than the distance D2 between the first cartridge 10 and the second cartridge 20 in the X direction. Accordingly, a space in which the corner portion R3 rotates toward the fourth apparatus-side side wall portion 606 by the rotating moment MR3 is wider than a space in which the corner portion L3 rotates toward the third apparatus-side side wall portion 605 by the rotating moment ML3. The corner portion R3 is thu likely to more significantly move compared with the corner portion L3. According to the embodiment, the engagement center CE is located between the first center plane PC and the second center plane PN as described above. This means that the engagement center CE is located at a position farther from the corner portion R3. This configuration thus more effectively restricts the motion of the corner portion R3 by the rotating moment MR3.

As shown in FIG. 23, the configuration that part of the multiple contact portions cp is placed in the range WE where the cartridge-side engagement portion 235 is located in the X direction reduces a variation in position of the contact portions cp in the XZ plane by the rotating moment MXZ. This configuration accordingly maintains the good contact between the contact portions cp and the apparatus-side terminal group 799.

As shown in FIG. 26, when the external force FP2 in the +Z direction is applied to the second cartridge 20, the second cartridge 20 starts rotating in the direction of an arrow RYZ about the liquid supply ports 280A, 280B and 280C. The rotation in the direction of the arrow RYZ is rotation along the YZ plane that is parallel to the Y direction and the Z direction. The rotation in the direction of the arrow RYZ is also rotation to lift up a lower part of the second side surface 203 in the +Z direction and to lift down an upper part of the first side surface 204 in the −Z direction. When the second cartridge 20 starts rotating in the direction of the arrow RYZ, the projections 262 and 263 come into contact with the apparatus-side bottom wall portion 601. This restricts the rotation of the second cartridge 20 in the direction of the arrow RYZ. As shown in FIG. 16, the two projections 262 and 263 are provided across the plane PCP that includes the center axis CC of the middle liquid supply port 280B and that is perpendicular to the X direction. This configuration more effectively restricts the rotation of the second cartridge 20 in the direction of the arrow RYZ.

As shown in FIG. 16, the three liquid supply ports 280A, 280B and 280C are arrayed parallel to the X direction. Even when the second cartridge 20 is rotated in the direction of the arrow RYZ shown in FIG. 26, this configuration prevents the degree of insertion and the position of insertion of the liquid supply needles 640A, 640B and 640C into the three liquid supply ports 280A, 280B and 280C from differing among the respective liquid supply ports. This configuration accordingly maintains the good connection of the liquid supply needles 640A, 640B and 640C with the liquid supply ports 280A, 280B and 280C and reduces the leakage of the liquid and invasion of the air into the liquid supply needles 640A, 640B and 640C.

A-8-2. External Forces FP1 and FP3

As shown in FIG. 26, out of the external forces in the Y direction applied to the second cartridge 20, external forces in the +Y direction are both the external force FP1 and the external force FP3, whereas an external force in the −Y direction is only the external force FP3. The second cartridge 20 is thus likely to be more significantly affected by the external force applied in the +Y direction than the external force applied in the −Y direction and is likely to move in the +Y direction. According to the embodiment, in the mounting state of the second cartridge 20, the restriction convex 282 (shown in FIG. 14) located on the +Y direction side of the middle liquid supply port 280B comes into contact with the apparatus-side restriction wall portion 615. This restricts the motion of the second cartridge 20 in the +Y direction. This configuration accordingly maintains the good contact between the contact portions cp of the circuit board 400 and the apparatus-side terminal group 799.

The effects of the external forces FP1 and FP3 on the variation in position of the contact portions cp are also suppressed by the configuration that the center contact portion cpc intersects with the first center plane PC as shown in FIG. 23. The configuration that the center contact portion cpc intersects with the first center plane PC causes the multiple contact portions cp to be placed between the middle liquid supply port 280B and the apparatus-side terminal group 799 as shown in FIG. 26. This reduces the motion of the contact portions cp away from the apparatus-side terminal group 799. This configuration accordingly maintains the good contact between the contact portions cp of the circuit board 400 and the apparatus-side terminal group 799.

As shown in FIG. 27, the motion of the liquid supply ports 280A, 280B and 280C in the X direction that may be caused by an X-direction component of the external force FP3 is restricted by the configuration that the surrounding members 283A, 283B and 283C are arranged to face the apparatus-side restriction wall portions 615 in the X direction. When the liquid supply ports 280A, 280B and 280C start moving in the X direction, the surrounding members 283A, 283B and 283C come into contact with the apparatus-side restriction wall portions 615. This restricts the motion of the second cartridge 20 in the X direction.

A-8-3. Rotating Moments MXY1 and MXY2

The effect of the rotating moment MXY2 shown in FIG. 25 is suppressed by the configuration that the liquid supply ports 280A, 280B and 280C are placed on the bottom surface 201 at a position closer to the second side surface 203 where the contact portions cp are located, than the first side surface 204. As described above, the second cartridge 20 has the larger motion by the rotating moment MXY2 with an increase in distance from the center axes CM, CC and CN. The contact portions cp are provided at the position near to the center axes CM, CC and CN of the liquid supply ports 280A, 280B and 280C. This configuration reduces the variation in position of the contact portions cp, even when the second cartridge 20 is rotated in the direction DXY2 along the XY plane that is parallel to the X direction and the Y direction about the center axes CM, CC and CN as the center.

The effect of the rotating moment MXY1 shown in FIG. 25 is suppressed by the configuration that the apparatus-side projection 638 (shown in FIG. 3 and FIG. 5) is inserted into the recessed portion 264 (shown in FIG. 14) provided on the bottom surface 201 at the position closer to the first side surface 204 than the second side surface 203. Insertion of the apparatus-side projection 638 into the recessed portion 264 restricts the motion of the second cartridge 20 in the direction DXY1. Restricting the motion of the second cartridge 20 in the direction DXY1 results in restricting the motion of the second side surface 203-side of the second cartridge 20 in the direction DXY2. This configuration accordingly suppresses the variation in position of the contact portions cp and thereby maintains the good contact between the contact portions cp and the apparatus-side terminal group 799.

As shown in FIG. 23, the center contact portion cpc does not intersect with the second center plane PN or the third center plane PL but intersects with the first center plane PC. This configuration reduces the effect of the rotating moment MXY1 shown in FIG. 25. The following describes the relationship between the position of the center contact portion cpc and the effect of the rotating moment MXY1 shown in FIG. 25 more in detail.

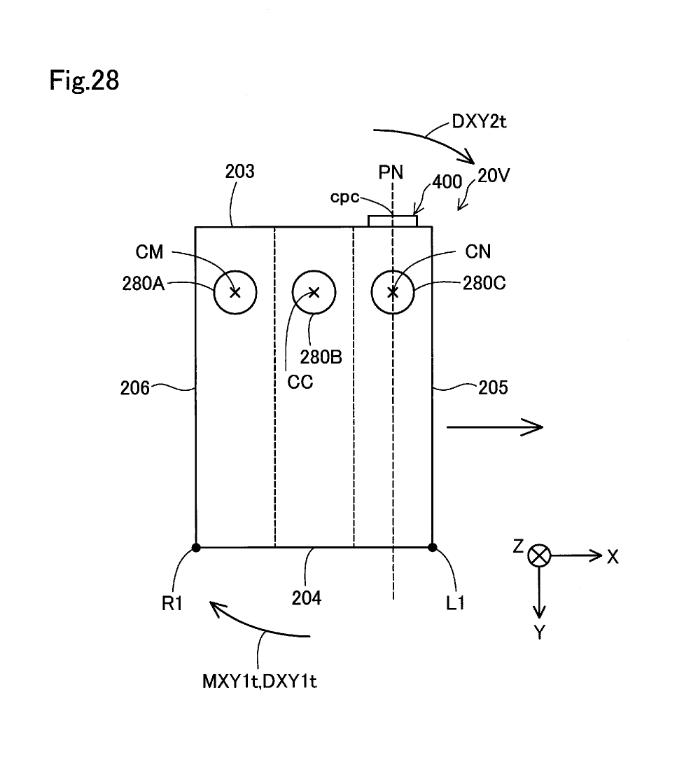

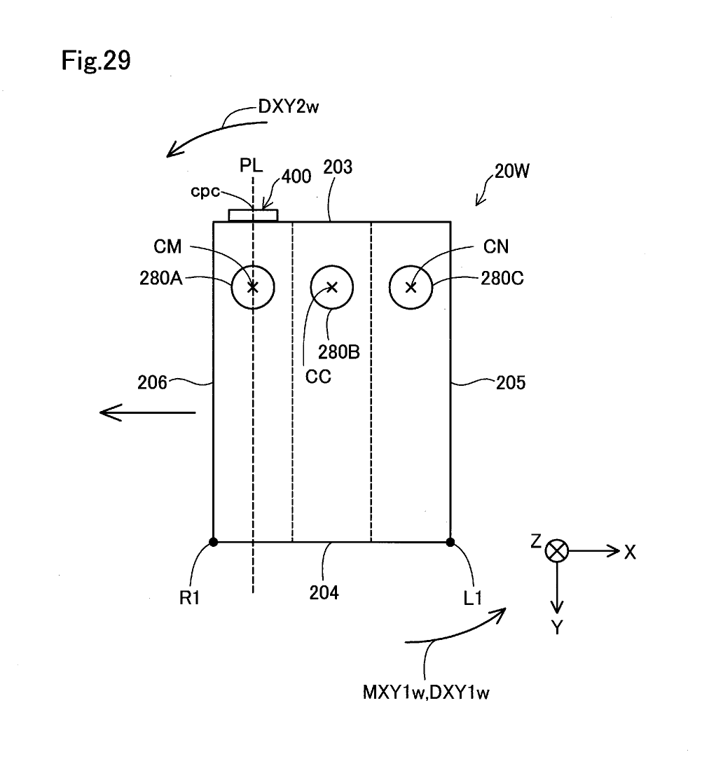

FIG. 28 is a diagram illustrating a second cartridge 20V according to a first reference example. FIG. 29 is a diagram illustrating a second cartridge 20W according to a second reference example. The second cartridges 20V and 20W of the reference examples differ from the second cartridge 20 of the embodiment by the location of the circuit board 400 on the second side surface 203. In the second cartridge 20V shown in FIG. 28, the circuit board 400 is located at a position leaning to the +X direction side on the second side surface 203, and the center contact portion cpc of the circuit board 400 is arranged to intersect with the second center plane PN. In the second cartridge 20W shown in FIG. 29, the circuit board 400 is located at a position leaning to the −X direction side on the second side surface 203, and the center contact portion cpc of the circuit board 400 is arranged to intersect with the third center plane PL.

As shown in FIG. 28, when the circuit board 400 is located at a position leaning to the third side surface 205-side (+X direction side), a large rotating moment MXY1t is generated in part of the corner portion R1 when the carriage 520 is accelerated and moved in the +X direction. This rotating moment MXY1t causes the second cartridge 20V to start significantly rotating in the direction of an arrow DXY1t. The vicinity of the circuit board 400 then starts significantly rotating in the direction of an arrow DXY2t. This provides a large variation in position of the contact portions cp on the circuit board 400.

As shown in FIG. 29, when the circuit board 400 is located at a position leaning to the fourth side surface 206-side (−X direction side), a large rotating moment MXY1w is generated in part of the corner portion L1 when the carriage 520 is accelerated and moved in the −X direction. This rotating moment MXY1w causes the second cartridge 20W to start significantly rotating in the direction of an arrow DXY1w. The vicinity of the circuit board 400 then starts significantly rotating in the direction of an arrow DXY2w. This provided a large variation in position of the contact portions cp on the circuit board 400.

The arrangement of the circuit board 40 such that the center contact portion cpc does not intersect with the second center plane PN or the third center plane PL but intersects with the first center plane PC like the embodiment shown in FIG. 25, on the other hand, causes a similar level of the rotating moment MXY1 to be generated in the corner portion R1 or in the corner portion R2 of the second cartridge 20 whether the carriage 520 is accelerated and moved in the +X direction or is accelerated and moved in the −X direction. This rotating moment MXY1 is smaller than the rotating moment MXY1t shown in FIG. 28 and the rotating moment MXY1w shown in FIG. 29. Accordingly, compared with the second cartridge 20V, the second cartridge 20 of the embodiment has a smaller variation in position of the contact portions cp when the carriage 520 is accelerated and moved in the +X direction. Compared with the second cartridge 20W, the second cartridge 20 of the embodiment has a smaller variation in position of the contact portions cp when the carriage 520 is accelerated and moved in the −X direction. This accordingly maintains the good contact between the contact portions cp of the circuit board 400 and the apparatus-side terminal group 799.

A-8-4. Rotating Moments MXZ and MXY

As shown in FIG. 23, the multiple contact portions cp are arranged to be symmetric in the X direction with respect to the first center plane PC. When the second cartridge 20 starts rotating about the vicinity of the first center axis CC as the center by the effects of the rotating moment MXZ (shown in FIG. 24) and the rotating moment MXY2, the contact portion cp located at a farthermost position in the Z direction or in the ±X direction from the first center plane PC is likely to have a largest variation in position. When the magnitude of the variation in position of the contact portion cp located at the farthermost position in the Z direction or in the ±X direction from the first center plane PC is defined as a maximum variation, the maximum variation in the arrangement of the multiple contact portions cp to be symmetric in the X direction with respect to the first center plane PC is smaller than the maximum variation in the arrangement of the multiple contact portions cp to be asymmetric in the X direction with respect to the first center plane PC.

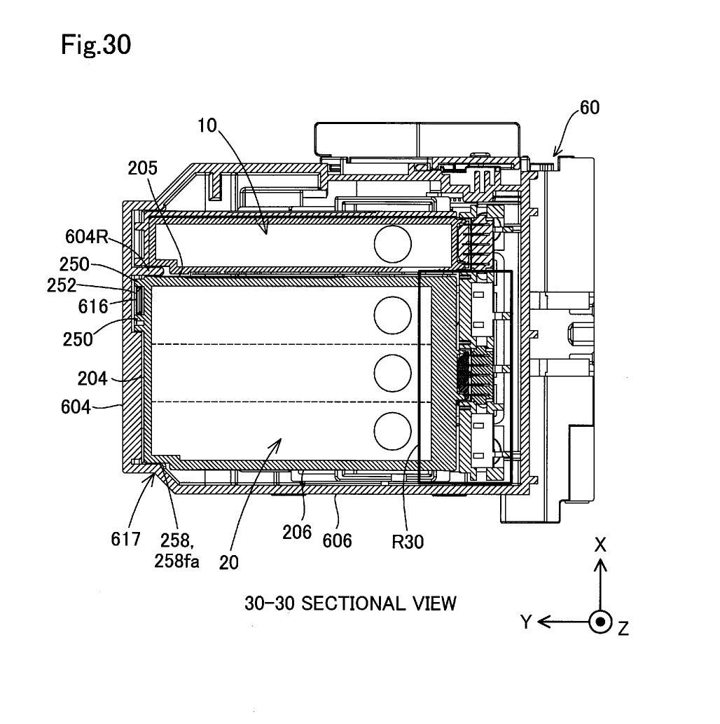

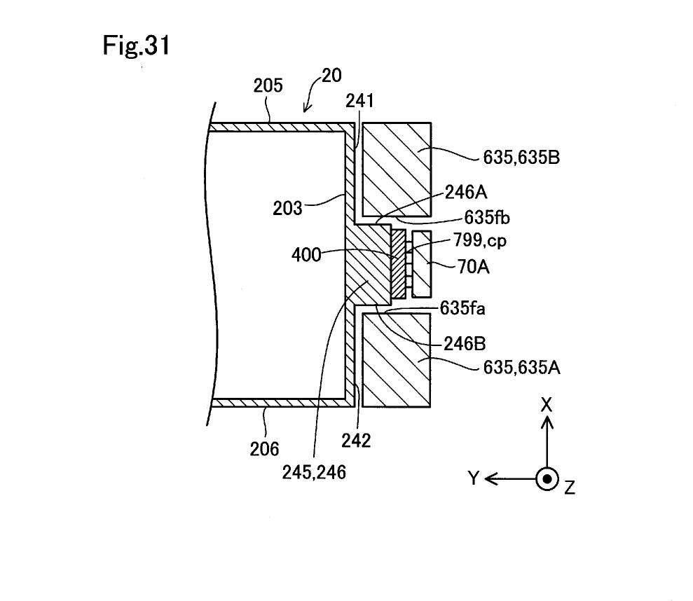

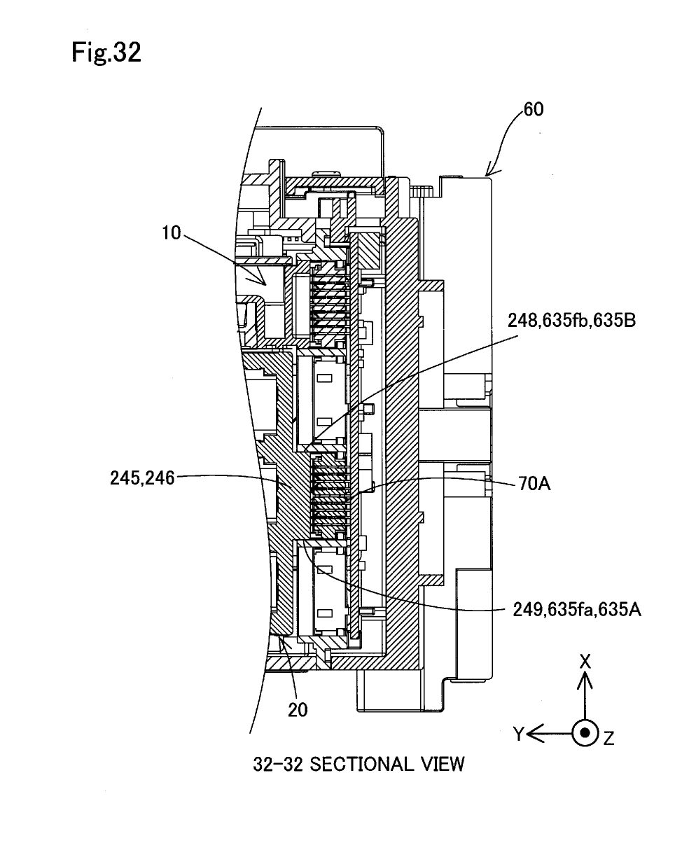

The following describes the configuration of restricting the motion of the second cartridge 20 by the rotating moments MXZ and the MXY and the X-direction component of the external force F3 with reference to FIGS. 30 to 32. FIG. 30 is a sectional view taken on a line 30-30 shown in FIG. 23. FIG. 31 is a diagram illustrating a region surrounded by a rectangle R30 in FIG. 30. FIG. 32 is a partial sectional view taken on a line 32-32 shown in FIG. 23. FIG. 30 and FIG. 32 also illustrate sections of the cartridge holder 60 and the first cartridge 10 in the mounting state of the second cartridge 20.

As shown in FIG. 30, in the mounting state, the guide projection 617 is received in the concave portion 258. As shown in FIG. 14, the concave portion 258 is extended from the bottom surface 201-side toward the upper surface 202. Receiving the guide projection 617 in the concave portion 258 causes the surface 258fa of the concave portion 258 that is arranged to face in the −X direction, to come into contact with the guide projection 617 in the mounting state. This configuration restricts the motion of the second cartridge 20 in the −X direction in the mounting state. This accordingly suppresses the variation in position of the contact portions cp and thereby maintains the good contact between the contact portions cp and the apparatus-side terminal group 799.

The second cartridge 20 includes the concavo-convex portion 257 that is fit with the cartridge identification convex 616. The concavo-convex portion 257 is extended from the bottom surface 201-side toward the upper surface 202-side of the first side surface 204. This configuration restricts the motion of the second cartridge 20 along the XY plane that is orthogonal to the Z direction, in the mounting state. According to the embodiment, the cartridge identification convex 616 is placed between the convex portions 250 of the concavo-convex portion 257 in the X direction. This restricts the motion of the second cartridge 20 in the X direction. Accordingly, this configuration suppresses a variation in position of the contact portions cp and maintains the good contact between the contact portions cp and the apparatus-side terminal group 799.

In the mounting state, the partition wall 604R comes into contact with the third side surface 205. This restricts the motion of the second cartridge 20 in the +X direction, in the mounting state. Accordingly, this configuration suppresses a variation in position of the contact portions cp and maintains the good contact between the contact portions cp and the apparatus-side terminal group 799.

As shown in FIG. 31, the first side portion 246B and the second side portion 246A of the first protruded surface portion 246 (shown in FIG. 23) are placed between the first regulating portion 635A and the second regulating portion 635B (shown in FIG. 4). In other words, the first protruded surface portion 246 is placed at a position between the first regulating portion 635A and the second regulating portion 635B in the X direction. This configuration restricts the motion of the second side surface 203-side of the second cartridge 20 in the X direction and thereby suppresses a variation in position of the contact portions cp. This accordingly maintains the good contact between the contact portions cp and the apparatus-side terminal group 799.

As shown in FIG. 4, the first regulating portion 635A and the second regulating portion 635B are provided by utilizing a space of the cartridge mounting portion 602 that is opposed in the Y direction to the first surface portion 242 and the second surface portion 241. According to the embodiment, this space is utilized to increase the dimensions in the Y direction (thicknesses) of the first regulating portion 635A and the second regulating portion 635B and thereby increase the rigidities of the first regulating portion 635A and the second regulating portion 635B. According to the embodiment, the motion of the first protruded surface portion 246 is restricted by the first regulating portion 635A and the second regulating portion 635B having the high rigidities. This more effectively suppresses a variation in position of the contact portions cp.

As shown in FIG. 23, the first protruded surface portion 246 is provided between the first surface portion 242 and the second surface portion 241 in the X direction, and the center axis CC of the liquid supply port 280B is placed in the range W246 where the first protruded surface portion 246 is located, in the X direction. This configuration restricts the motion of the first protruded surface portion 246 in the X direction in a balanced manner from the respective sides in the X direction (+X direction side and −X direction side) of the first protruded surface portion 246 by the first regulating portion 635A and the second regulating portion 635B (shown in FIG. 4). Accordingly, this configuration suppresses a variation in position of the contact portions cp and maintains the good contact between the contact portions cp and the apparatus-side terminal group 799. This configuration also allows the dimensions in the X direction of the first surface portion 242 and the second surface portion 241 to be increased to some extent. As a result, the dimensions in the X direction of the first regulating portion 635A and the second regulating portion 635B can be increased to some extent corresponding to the first surface portion 242 and the second surface portion 241. This provides the high rigidities of the first regulating portion 635A and the second regulating portion 635B. According to the embodiment, the motion of the first protruded surface portion 246 is restricted by the first regulating portion 635A and the second regulating portion 635B having the high rigidities. This more effectively suppresses a variation in position of the contact portions cp.

As shown in FIG. 32, in the mounting state of the second cartridge 20, the first projection 249 (shown in FIG. 17) abuts on the first restriction wall surface 635fa (shown in FIG. 5) of the first regulating portion 635A, whereas the second projection 248 (shown in FIG. 17) abuts on the second restriction wall surface 635fb (shown in FIG. 4) of the second regulating portion 635B. This configuration further restricts the motion of the first protruded surface portion 246 in the X direction. This accordingly further suppresses a variation in position of the contact portions cp and thereby maintains the better contact between the contact portions cp and the apparatus-side terminal group 799.

As shown in FIG. 17, the first projection 249 and the second projection 248 are located on the upper surface 202-side of the contact portions cp on the circuit board 400 in the Z direction. More specifically, the abutting positions of the first projection 249 and the second projection 248 with the first regulating portion 635A and the second regulating portion 635B (shown in FIG. 4 and FIG. 5) are located at the position farther from the contact regions of the liquid supply ports 280A, 280B and 280C with the liquid supply needles 640A, 640B and 640C. This reduces the motion (swing) of the second cartridge 20 in the direction DXZ by the rotating moment MXZ (shown in FIG. 24).

As shown in FIG. 17, the first projection 249 and the second projection 248 are located on the bottom surface 201-side of the engagement member 230 in the Z direction. More specifically, the abutting positions of the first projection 249 and the second projection 248 with the first regulating portion 635A and the second regulating portion 635B (shown in FIG. 4 and FIG. 5) are located at the position nearer to the contact portions cp than the engagement member 230. This reduces the motion (swinging motion) of the second cartridge 20 in the direction DXZ by the rotating moment MXZ (shown in FIG. 24).

A-9. Advantageous Effects of Cartridge Set and Liquid Ejection System

According to the embodiment described above, the second cartridge 20 is configured to contain multiple different types of (according to the embodiment, three different types of) liquids therein. This configuration allows for downsizing of the cartridge set 5 and the liquid ejection system 90, compared with a configuration that cartridges, each containing only one type of a liquid among multiple different types of liquids, are provided separately. Furthermore, the configuration of replacing the second cartridge 20 that contains multiple different types of liquids reduces the labor and time and the frequency of replacement, compared with a configuration of replacing separate cartridges that individually contain different types of liquids. The cartridge set 5 includes the direct liquid-type first cartridge 10 that is not provided with the liquid absorber 299 and the liquid absorber-type second cartridge 20 that is provided with the liquid absorbers 299. Using the two different types of cartridges takes advantages of both the liquid absorber-type that has a simple configuration and is inexpensive and the direct liquid-type that has a slightly complicated configuration but is suitable for high-speed printing.

According to the above embodiment, the first cartridge 10 is the direct liquid-type cartridge. This enables the liquid to be smoothly ejected from the head 540 with little inflow of air bubbles even when the liquid contained in the first cartridge 10 is supplied to the head 540 at a high speed. The second cartridge 20 is, on the other hand, the liquid absorber-type cartridge. Supplying the liquid contained in the second cartridge 20 to the head 540 at a high speed may cause the flow of ink in the liquid absorber 299 to fail to follow the supply rate of ink and is thus likely to split the ink layer by the air in the liquid absorber 299. This is likely to increase the amount of ink that is not supplied to the head 540 but remains in the liquid absorber 299 (amount of remaining ink). The split of the ink flow by the air in the liquid absorber 299 is likely to cause air bubbles to flow into the head 540. According to the embodiment, the direct liquid-type first cartridge 10 containing black ink is used both for high-speed printing and for low-speed printing, whereas the liquid absorber-type second cartridge 20 containing color inks is used only for low-speed printing. This configuration reduces the amount of remaining ink in the second cartridge 20, while allowing for high-speed printing using black ink. This configuration also reduces the possibility that air bubbles are discharged from the second cartridge 20 into the head 540 and thereby suppresses deterioration of the printing quality.

Additionally, according to the above embodiment, the cartridge holder 60 includes the first mounting portion 602W and the second mounting portion 602T. Accordingly, the liquid ejection system 90 of the embodiment is configured on the premise that the two different types of cartridge 10 and 20 are respectively mounted to the specific mounting portions 602W and 602T. This suppresses complication of the configuration of the liquid ejection apparatus 50.

Furthermore, according to the above embodiment, the pigment-containing ink (pigment ink) is contained in the direct liquid-type first cartridge 10, and the dye inks are contained in the liquid absorber-type second cartridge 20. The pigment is more likely to settle. The first cartridge 10 is, however, not provided with the liquid absorber, so that the settled pigment is readily dispersed by applying vibration to the first cartridge 10. The dye inks are used for the liquid absorber-type second cartridge 20, so that the second cartridge 20 does not have the problem of sedimentation like the pigment-containing ink. This reduces the possibility that the inks ejected from the liquid ejection apparatus 50 have varying concentrations. Black ink contained in the first cartridge 10 is the pigment ink, which is unlikely to bleed in printing on plain paper, compared with the dye ink. Color inks contained in the second cartridge 20 are, on the other hand, dye inks, which improve the color developing property in printing on special paper. The configuration of the embodiment performs black and white printing on plain paper at a high speed and color printing on special paper at a low speed and accordingly achieves a diversity of printing.

The first-type ejecting port portion 544D that ejects the liquid contained in the first cartridge 10 is configured to have the larger maximum ejection amount that is ejectable per unit time than the second-type ejecting port portions 544A, 544B and 544C that respectively eject the liquids contained in the second cartridge 20 (shown in FIG. 8). The ink contained in the first cartridge 10 can thus be used for high-speed printing. The second cartridge 20 is, on the other hand, used for low-speed printing. This reduces the possibility that the ink flow is split by the air in the liquid absorber 299.

B. Other Embodiments

The present disclosure is not limited to the embodiment and aspects described above but may be implemented by various other aspects without departing from the scope of the disclosure. Some modifications are given below.

B-1. Cartridge Using Adapter

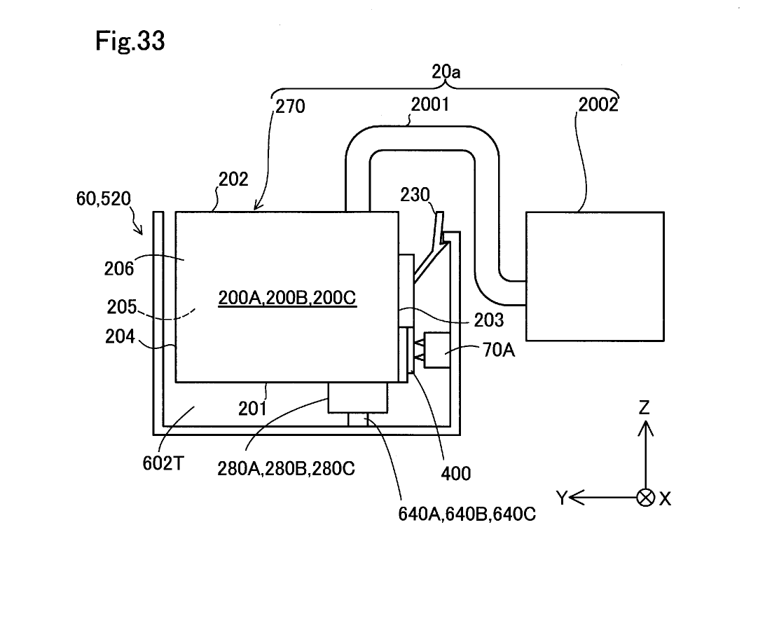

FIG. 33 is a diagram illustrating a second cartridge 20a using an adapter 270. The second cartridge 20a includes external tanks 2002, tubes 2001 and the adapter 270. Although only one external tank 2002 and only one tube 2001 are illustrated in FIG. 33, three external tanks 2002 and three tubes 2001 are actually provided to supply the respective inks to second liquid chambers 200A, 200B and 200C.

The adapter 270 is compatible with the second cartridge 20 of the above embodiment and is configured to be mounted to and dismounted from the second mounting portion 602T of the cartridge holder 60. The adapter 270 differs from the second cartridge 20 by that ink is supplied from the external tank 2002 via the tube 2001. The adapter 270 includes three openings that are provided on an upper surface 202 thereof to connect the tubes 2001 with the second liquid chambers 200A, 200B and 200C.

The three external tanks 2002 (only one is illustrated in FIG. 33) separately contain three different types of liquids (yellow ink, magenta ink and cyan ink) that are to be supplied to the second liquid chambers 200A, 200B and 200C. The three tubes 2001 (only one is illustrated in FIG. 33) are provided to connect the external tanks 2002 with the corresponding second liquid chambers 200A, 200B and 200C. When the liquid contained in the external tank 2002 is used up, the used external tank 2002 may be replaced with a new external tank 2002 or may be refilled with the liquid. The adapter 270 may be configured such that the three different types of liquids are contained in advance in the respective second liquid chambers 200A 200B or 200C or are supplied from the respective external tanks 2002 to be contained therein.

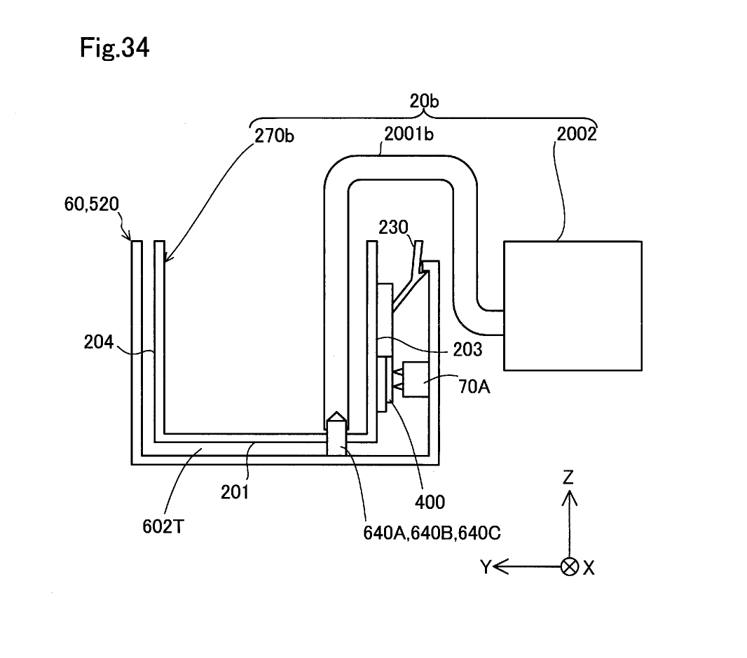

FIG. 34 is a diagram illustrating a second cartridge 20b using an adapter 270b. Like components to those of the second cartridge 20a (shown in FIG. 33) are expressed by like reference signs, and their description is appropriately omitted.

The second cartridge 20b includes external tanks 2002, tubes 2001b and the adapter 270b. Although only one external tank 2002 and only one tube 2001b are illustrated in FIG. 34, three external tanks 2002 and three tubes 2001b are actually provided to supply the respective inks to the liquid supply needles 640A, 640B and 640C.

The adapter 270b is compatible with the second cartridge 20 of the above embodiment and is configured to be mounted to and dismounted from the second mounting portion 602T of the cartridge holder 60. In order to provide the compatibility with the second cartridge 20, the adapter 270b includes, for example, a circuit board 400 and an engagement member 230. The adapter 270b, however, does not include the second liquid chambers 200A, 200B and 200C, the upper surface 202, the third side surface 205 or the fourth side surface 206. A bottom surface 201 of the adapter 270b has three openings that are formed to allow for insertion of the three liquid supply needles 640A, 640B and 640C.

The three tubes 2001b (only one is illustrated in FIG. 34) are directly connected with the liquid supply needles 640A, 640B and 640C. This configuration causes the liquids (yellow ink, magenta ink and cyan ink) to be directly supplied from the external tanks 2002 through the tubes 2001b to the liquid supply needles 640A, 640B and 640C. When the liquid contained in the external tank 2002 is used up, the used external tank 2002 may be replaced with a new external tank 2002 or may be refilled with the liquid. Any other configuration that directly connects the tubes 2001b with the liquid supply needles 640A, 640B and 640C may be employed for the adapter 270b. For example, the adapter 270b may be configured to include at least one surface out of the upper surface 202, the third side surface 205 and the fourth side surface 206. When the adapter 270b has the upper surface 202, openings may be provided in the upper surface 202 to allow for insertion of the respective tubes 2001b.

B-2. Other Embodiments With Regard to Outer Shape of Second Cartridge

According to the above embodiment, the outer shell 21 of the second cartridge 20 is formed in an approximately rectangular parallelepiped shape (shown in FIG. 13). The shape is, however, not limited to this embodiment. More specifically, the outer shell (upper surface, bottom surface and side surfaces) of the second cartridge may not be necessarily in a complete rectangular shape but may be, for example, a rounded rectangular shape, a rectangular shape with some concavity and convexity in part of a side, an oval shape or an elliptical shape. The following describes other embodiments with regard to the outer shape of the second cartridge.

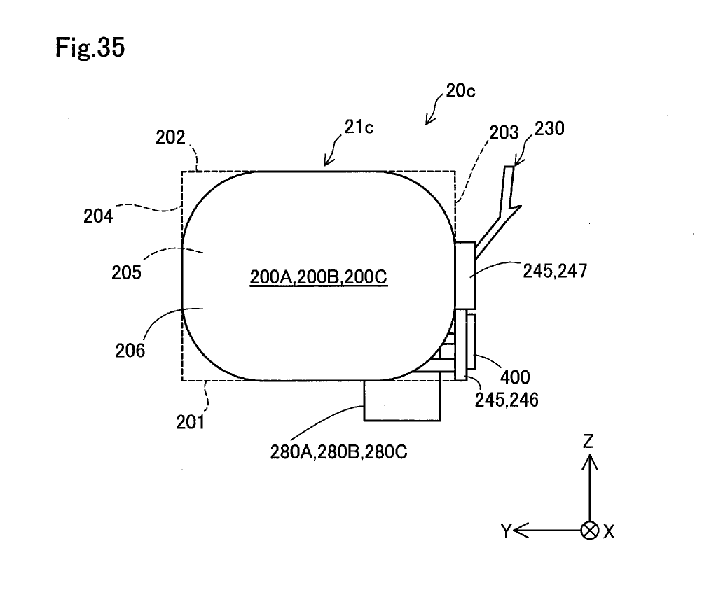

FIG. 35 is a conceptual view illustrating a second cartridge 20c. The second cartridge 20c is compatible with the second cartridge 20 and is configured to be mounted to and dismounted from the second mounting portion 602T. The second cartridge 20c has an outer shell 21c formed in a rounded rectangular shape when being viewed from its fourth side surface 206-side. The second cartridge 20c has an engagement member 230 and a circuit board 400 on its second side surface 203-side. The second cartridge 20c also has liquid supply ports 280A, 280B and 280C that are provided on its bottom surface 201-side. The second cartridge 20c has a fixed width when being view from its first side surface 204-side.

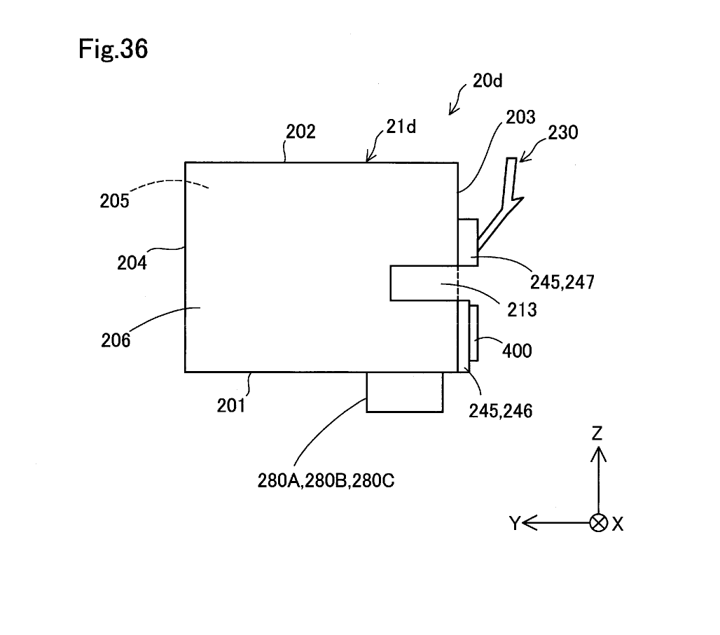

FIG. 36 is a conceptual view illustrating a second cartridge 20d. The second cartridge 20d is compatible with the second cartridge 20 and is configured to be mounted to and dismounted from the second mounting portion 602T. The second cartridge 20d has an outer shell 21d that is formed in an approximately rectangular parallelepiped shape like the outer shell 21 of the second cartridge 20 (shown in FIG. 13). A primary difference from the second cartridge 20 is that part of a second side surface 203 of the second cartridge 20d has a recessed portion 213. The recessed portion 213 is formed from a third side surface 205 to a fourth side surface 206. As long as the second cartridge 20d is compatible with the second cartridge 20, the second cartridge 20d may have a recessed portion that is formed in at least one surface among the respective surfaces of the outer shell 21d. As long as the second cartridge 20d is compatible with the second cartridge 20, the second cartridge 20d may have a convex portion that is formed in at least one surface among the respective surfaces of the outer shell 21d.

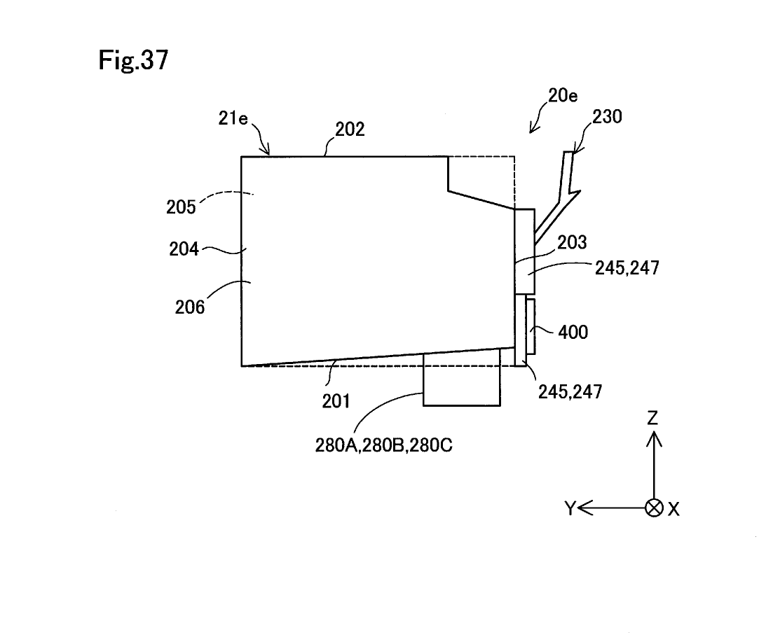

FIG. 37 is a conceptual view illustrating a second cartridge 20e. The second cartridge 20e is compatible with the second cartridge 20 and is configured to be mounted to and dismounted from the second mounting portion 602T. The second cartridge 20e has an outer shell 21e that is formed in an approximately rectangular parallelepiped shape like the outer shell 21 of the second cartridge 20 (shown in FIG. 13). Primary differences from the second cartridge 20 are that a corner portion where an upper surface 202 and a second side surface 203 intersect with each other is recessed in the −Z direction and in the +Y direction and that a bottom surface 201 is inclined to the horizontal direction. As long as the second cartridge 20e is compatible with the second cartridge 20, the second cartridge 20e may have at least one inclined surface among the respective surfaces of the outer shell 21e and may have at least partly recessed and cut out in each surface.

B-3. Second Cartridge Having Movable Part

According to the above embodiment, the outer shell 21 of the second cartridge 20 is configured integrally. According to a modification, however, a second cartridge may be configured to be partly movable relative to the outer shell 21, as long as the second cartridge is compatible with the second cartridge 20 and is configured to be mounted to and dismounted from the second mounting portion 602T. The following describes some embodiments of this modified configuration.

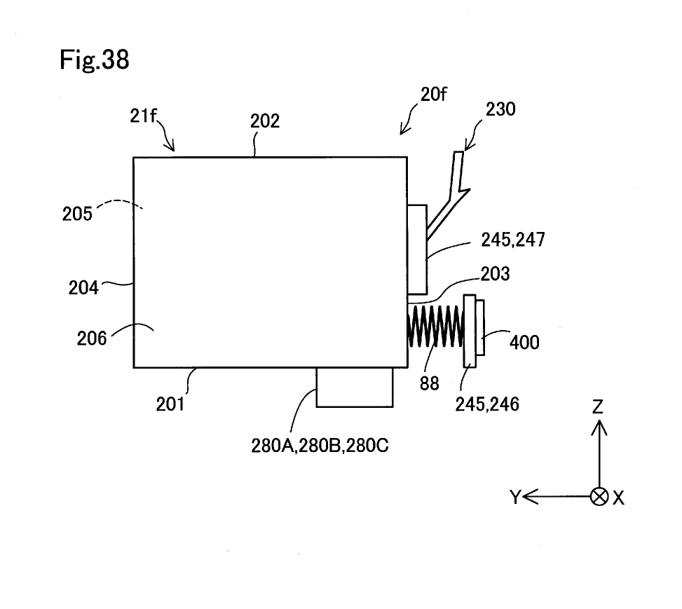

FIG. 38 is a conceptual view illustrating a second cartridge 20f. The second cartridge 20f is compatible with the second cartridge 20 and is configured to be mounted to and dismounted from the second mounting portion 602T. The second cartridge 20f includes a first protruded surface portion 246 that is movable relative to an outer shell 21f. The first protruded surface portion 246 of the second cartridge 20f is coupled with a second side surface 203 by means of a spring 88. In the process of mounting the second cartridge 20f to the second mounting portion 602T, the spring 88 is compressed to move the first protruded surface portion 246 toward the second side surface 203-side. This causes the first protruded surface portion 246 to be placed between the first regulating portion 635A and the second regulating portion 635B (shown in FIG. 4).

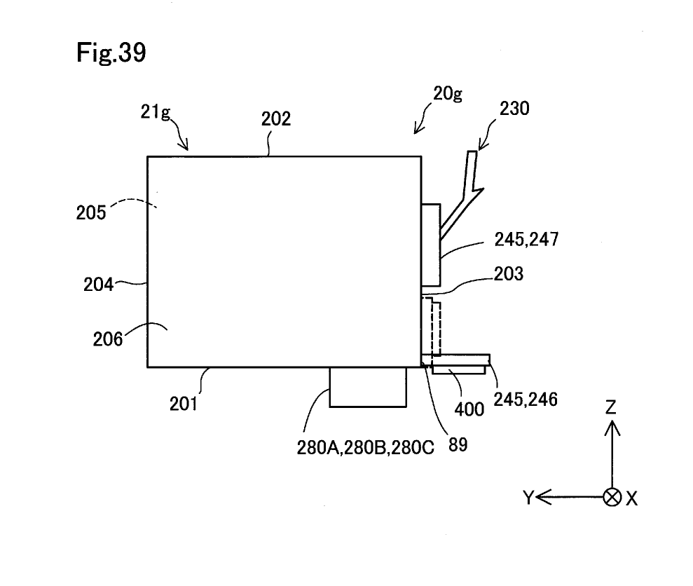

FIG. 39 is a conceptual view illustrating a second cartridge 20g. The second cartridge 20g is compatible with the second cartridge 20 and is configured to be mounted to and dismounted from the second mounting portion 602T. The second cartridge 20g includes a first protruded surface portion 246 that is movable relative to an outer shell 21g. The first protruded surface portion 246 of the second cartridge 20g has one end that is supported by a hinge 89 provided on a second side surface 203 and the other end that is rotatable and movable about the hinge 89 as the supporting point. In the process of mounting the second cartridge 20g to the second mounting portion 602T, the first protruded surface portion 246 is brought into contact with the second side surface 203 by rotating and moving the other end of the first protruded surface portion 246 about the hinge 89 as the supporting point. This causes the first protruded surface portion 246 to be placed between the first regulating portion 635A and the second regulating portion 635B (shown in FIG. 4).

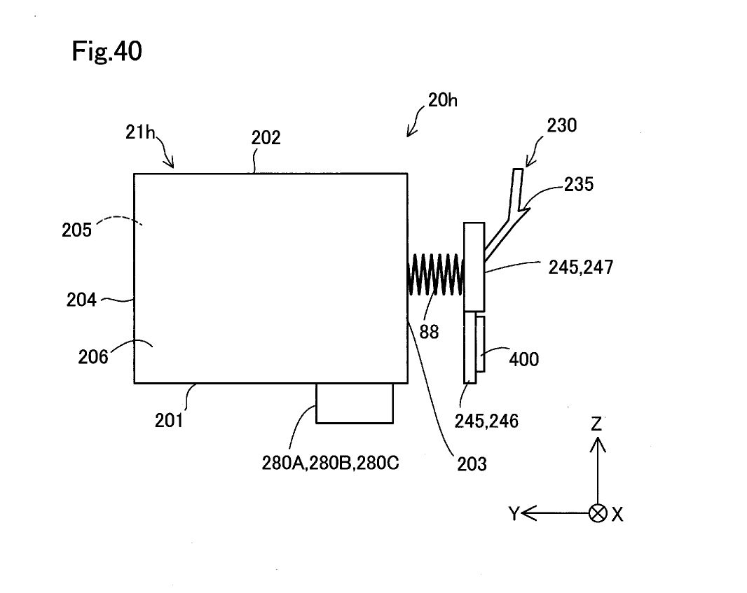

FIG. 40 is a conceptual view illustrating a second cartridge 20h. The second cartridge 20h is compatible with the second cartridge 20 and is configured to be mounted to and dismounted from the second mounting portion 602T. The second cartridge 20h includes a protruded surface portion 245 that is movable relative to an outer shell 21h. The protruded surface portion 245 of the second cartridge 20g is coupled with a second side surface 203 by means of a spring 88. In the process of mounting the second cartridge 20g to the second mounting portion 602T, the spring 88 is compressed to move the protruded surface portion 245 toward the second side surface 203-side. This causes the first protruded surface portion 246 to be placed between the first regulating portion 635A and the second regulating portion 635B (shown in FIG. 4) and enables the cartridge-side engagement portion 235 of the engagement member 230 to be locked by the apparatus-side engagement portion 632A.

B-4. Two-Part Type Cartridge

In the second cartridge 20 of the above embodiment, the outer shell 21 is integrally formed with the second liquid chambers 200A, 200B and 200C. The second cartridge may, however, be configured as a two-part type cartridge consisting of two separate components as long as the second cartridge is compatible with the second cartridge 20 and is configured to be mounted to and dismounted from the second mounting portion 602T. The following describes configurations of the two-part type cartridge.

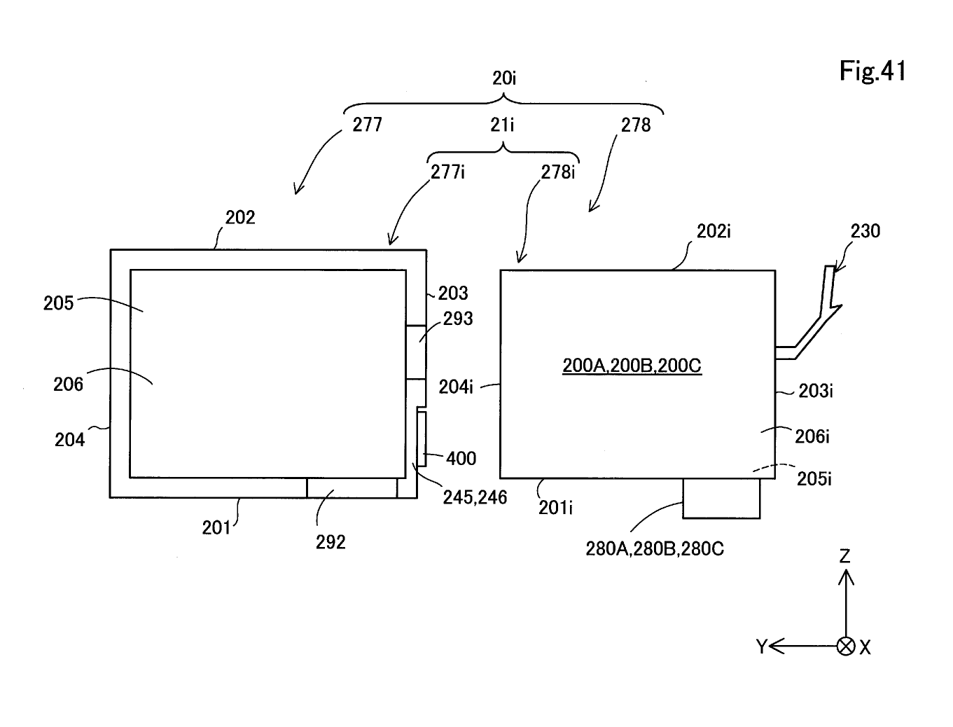

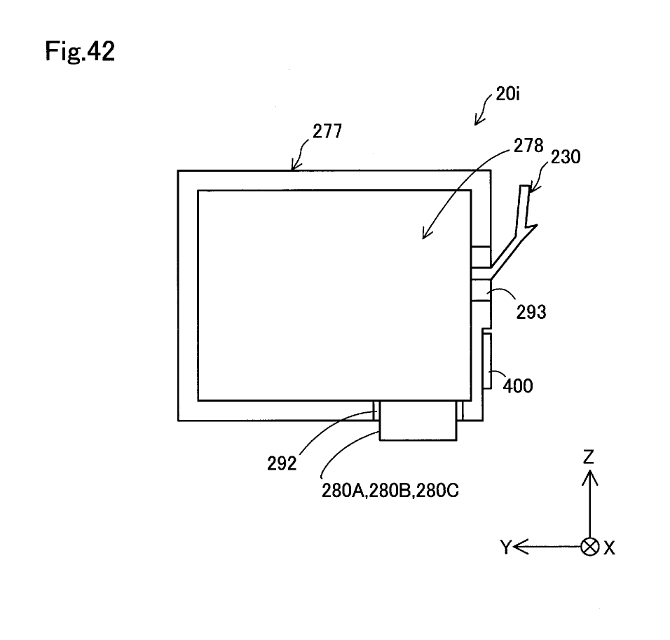

FIG. 41 is a conceptual view illustrating a two-part type second cartridge 20i. FIG. 42 is a diagram illustrating the two-part type second cartridge 20i. The second cartridge 20i is compatible with the second cartridge 20 and is configured to be mounted to and dismounted from the second mounting portion 602T. The second cartridge 20i includes a case member 277 and a container member 278. The container member 278 includes second liquid chambers 200A, 200B and 200C provided inside thereof. When the liquids contained in the second liquid chambers 200A, 200B and 200C are used up, the used container member 278 may be replaced with a new container member 278 or may be refilled with the liquids.

The second cartridge 20i has an outer shell 21i that is configured by combination of an outer shell 277i of the case member 277 with an outer shell 278i of the container member 278. The container member 278 includes an engagement member 230 and liquid supply ports 280A, 280B and 280C, in addition to the second liquid chambers 200A, 200B and 200C. The outer shell 278i of the container member 278 includes surfaces 201i to 206i corresponding to respective surfaces 201 to 206 of the second cartridge 20i. The bottom surface 201i and the upper surface 202i are opposed to each other in the Z direction. The second side surface 203i and the first side surface 204i are opposed to each other in the Y direction. The third side surface 205i and the fourth side surface 206i are opposed to each other in the X direction. The bottom surface 201i is located on the −Z direction side, and the upper surface 202i is located on the +Z direction side. The second side surface 203i is located on the −Y direction side, and the first side surface 204i is located on the +Y direction side. The third side surface 205i is located on the +X direction side, and the fourth side surface 206i is located on the −X direction side. The second side surface 203i is provided with the engagement member 230, and the bottom surface 201i is provided with the liquid supply ports 280A, 280B and 280C.

The outer shell 277i of the case member 277 includes surfaces corresponding to the bottom surface 201, the upper surface 202, the first side surface 204, the second side surface 203 and the third side surface 205 of the second cartridge 20i. The outer shell 277i includes an opening 206 that is formed in a surface corresponding to the fourth side surface 206 of the cartridge 20i. The second side surface 203 is provided with a first protruded surface portion 246 and a circuit board 400. The bottom surface 201 has an opening 292 that is open in the −X direction and in the Z direction. The liquid supply ports 280A, 280B and 280C are inserted into the opening 292 (as shown in FIG. 42). The second side surface 203 has an opening 293 that is open in the −X direction and in the Y direction. The engagement member 230 is inserted into the opening 293 (as shown in FIG. 42).

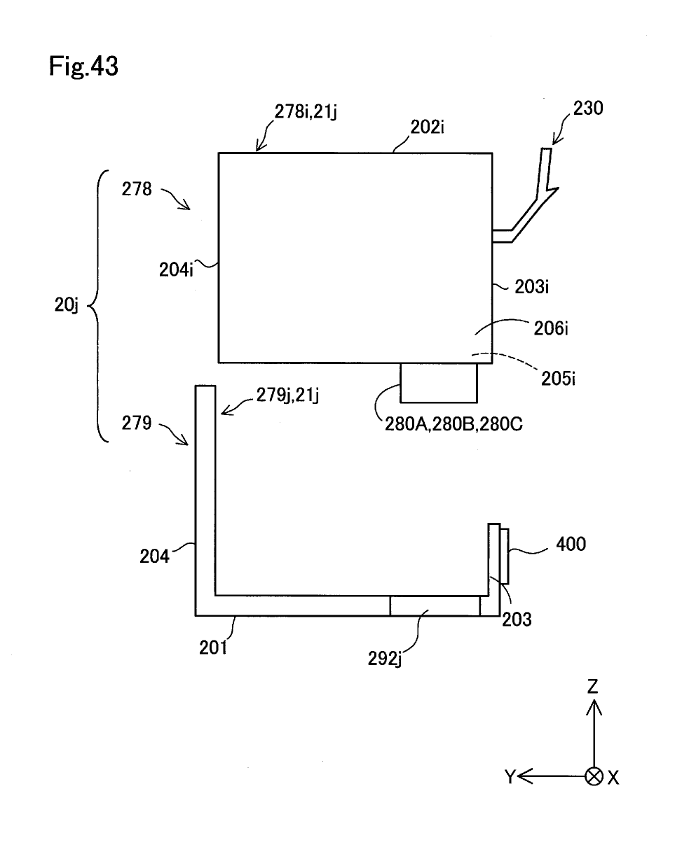

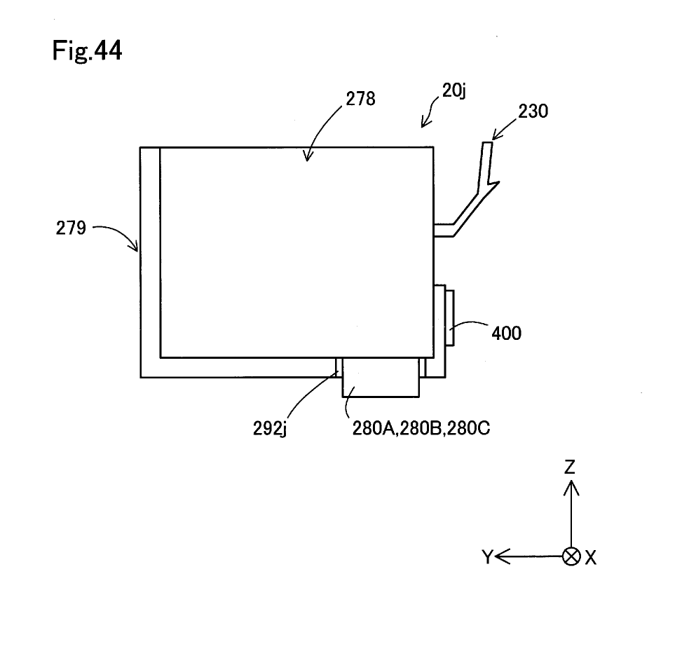

FIG. 43 is a a conceptual view illustrating a two-part type second cartridge 20j. FIG. 44 is a diagram illustrating the two-part type second cartridge 20j. The second cartridge 20j is compatible with the second cartridge 20 and is configured to be mounted to and dismounted from the second mounting portion 602T. The second cartridge 20j includes a case member 279 and a container member 278. The container member 278 of the second cartridge 20j is identical with the container member 278 of the second cartridge 20i (shown in FIG. 41) and is not described here.

The second cartridge 20j has an outer shell 21j that is configured by combination of an outer shell 279j of the case member 279 with the outer shell 278i of the container member 278. The case member 279 includes surfaces corresponding to the first side surface 204, the bottom surface 201 and the second side surface 203 and has openings that are formed in surfaces corresponding to the upper surface 202, the third side surface 205 and the fourth side surface 206. The second side surface 203 does not have a +Z direction side portion but has only a −Z direction side portion that is connected with the bottom surface 201. The bottom surface 201 has an opening 292j that is formed to penetrate in the Z direction and to receive insertion of the liquid supply ports 280A, 280B and 280C. The second cartridge 20j is assembled by moving the container member 278 from the +Z direction side to the −Z direction side of the case member 279 to insert the liquid supply ports 280A, 280B and 280C into the opening 292j (as shown in FIG. 44).

B-5. Other Embodiments of Engagement Member 230

In the second cartridge 20, the engagement member 230 is the member that is connected with the second side surface 203 and has elasticity (shown in FIG. 13). The engagement member may have any other configuration that is locked by the apparatus-side engagement portion 632A (shown in FIG. 4). The following describes some concrete examples.

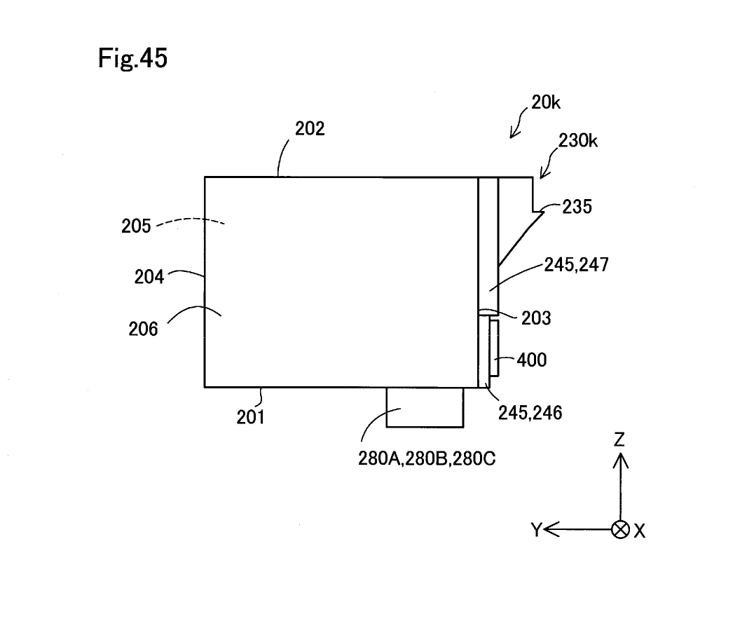

FIG. 45 is a diagram illustrating a second cartridge 20k. Differences from the second cartridge 20 include that a second protruded surface portion 247 is extended to an intersecting part of the upper surface 202 and the second side surface 203 and that an engagement member 230k is not elastically deformed. The second cartridge 20k is compatible with the second cartridge 20 and is configured to be mounted to and dismounted from the second mounting portion 602T. The engagement member 230k is a solid member that is protruded in the −Y direction from the second protruded surface portion 247. The engagement member 230k includes a cartridge-side engagement portion 235. According to a modification, the engagement member 230k may be replaced by a projection that is protruded in the −Y direction from the second side surface 203 or from the second protruded surface portion 247 and that serves as the cartridge-side engagement portion 235.

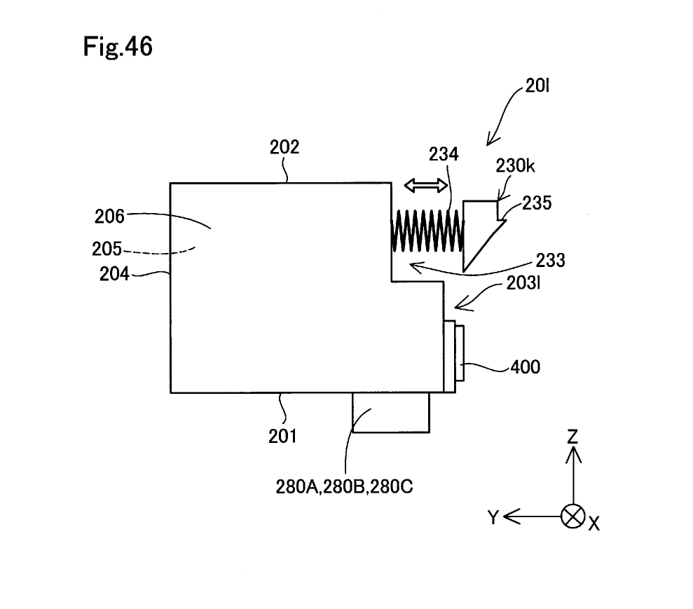

FIG. 46 is a diagram illustrating a second cartridge 201. Differences from the second cartridge 20 include a recessed portion 233 provided in a second side surface 203l, the configuration of an engagement member 230k and addition of a spring 234. The second cartridge 20l is compatible with the second cartridge 20 and is configured to be mounted to and dismounted from the second mounting portion 602T. The recessed portion 233 is formed in the second side surface 203l at a position on the upper surface 202-side of the circuit board 400. The recessed portion 233 is formed in a shape recessed in the +Y direction and is open on its −Y direction side. The second cartridge 20l also includes the spring 234 that is arranged to couple a +Y direction side surface of the recessed portion 233 with the engagement member 230k. This spring 234 enables the engagement member 230k to move in the Y direction. Accordingly, the engagement member 230k is allowed to be placed inside of the recessed portion 233 and outside of the recessed portion 233. The configuration that the engagement member 230k is movable in the Y direction enables the cartridge-side engagement portion 235 to be readily locked by and unlocked from the apparatus-side engagement portion 632A (shown in FIG. 5). The configuration of the engagement member 230k of the second cartridge 20l is identical with the configuration of the engagement member 230k of the second cartridge 20k.

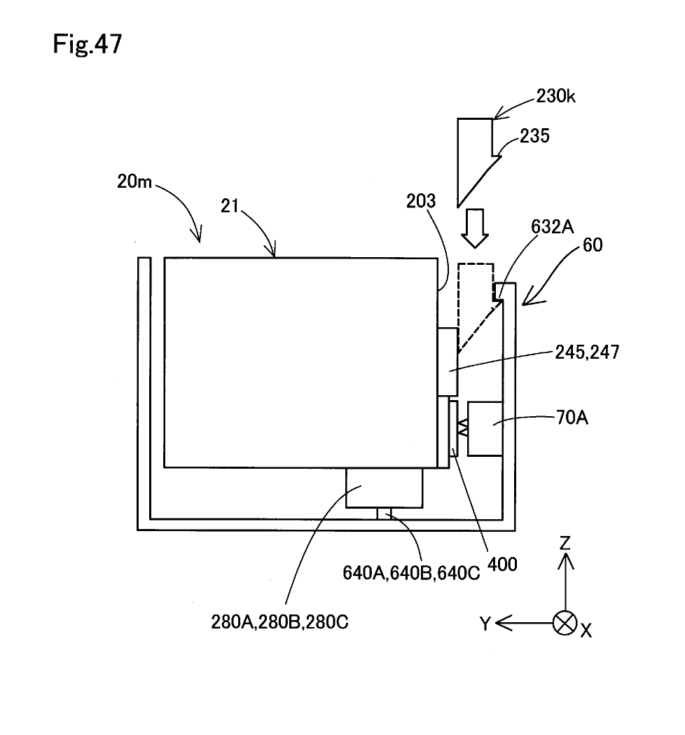

FIG. 47 is a diagram illustrating a second cartridge 20m. A difference from the second cartridge 20k (shown in FIG. 45) is that an engagement member 230k is separable from the outer shell 21. The second cartridge 20m is compatible with the second cartridge 20 and is configured to be mounted to and dismounted from the second mounting portion 602T. The configuration of the engagement member 230k of the second cartridge 20m is identical with the configuration of the engagement member 230k of the second cartridge 20k. For example, after the outer shell 21 is mounted to the second mounting portion 602T, the engagement member 230k is inserted into the second mounting portion 602T, such that the cartridge-side engagement portion 235 of the engagement member 230k is locked by the apparatus-side engagement portion 632A. The engagement member 230k and the second protruded surface portion 247 may respectively have rails that are extended in the Z direction to be fit in each other. These rails serve to readily guide the engagement member 230k to the locking position inside of the second mounting portion 602T.

B-6. Other Embodiments of Cartridge-Side Terminal Group

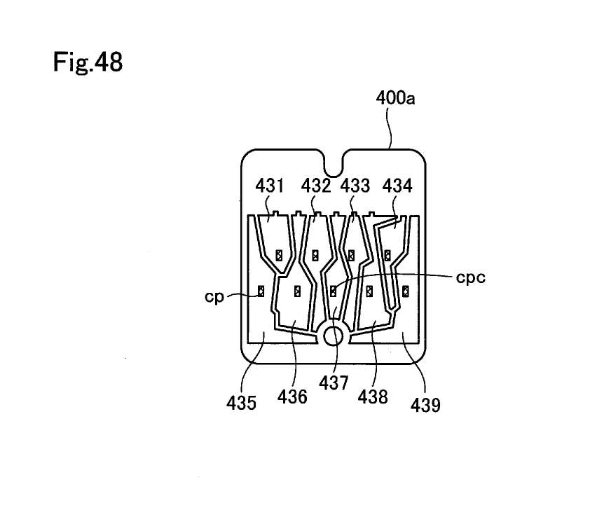

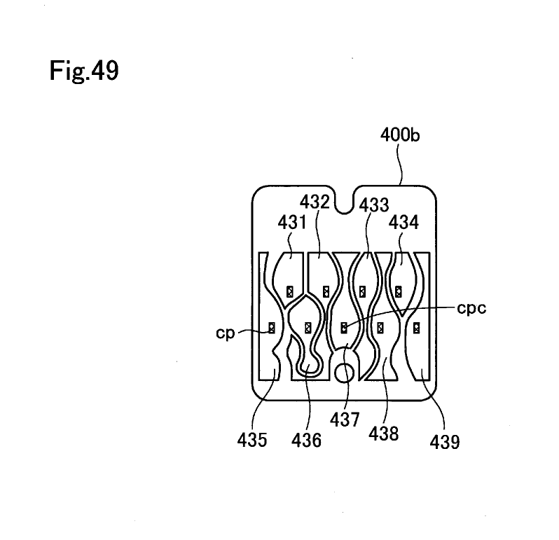

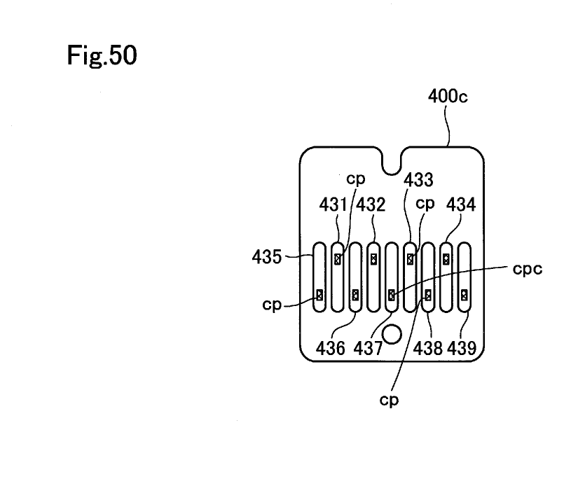

FIGS. 48 to 50 are diagrams illustrating other embodiments of the configuration of terminals of a circuit board. These circuit boards 400a to 400c differ from the circuit board 400 shown in FIG. 21 only by the surface configuration of cartridge-side terminals 431 to 439. In the circuit board 400a shown in FIG. 48 and the circuit board 400b shown in FIG. 49, the respective terminals are not in an approximately rectangular shape but are in irregular shapes. In the circuit board 400c shown in FIG. 50, nine cartridge-side terminals 431 to 439 are aligned with the mounting detection terminals 435 and 439 located on respective ends. The mounting detection terminals 431 and 434 are respectively placed between the mounting detection terminal 435 and the power supply terminal 436 and between the mounting detection terminal 439 and the data terminal 438. In these circuit boards 400a to 400c, the arrangement of the contact portions cp that are in contact with the apparatus-side terminals corresponding to the respective cartridge-side terminals 431 to 439 is identical with the arrangement of the contact portions cp in the circuit board 400 shown in FIG. 21. The respective cartridge-side terminals may have any of various surface configurations as long as the arrangement of the contact portions cp is unchanged.

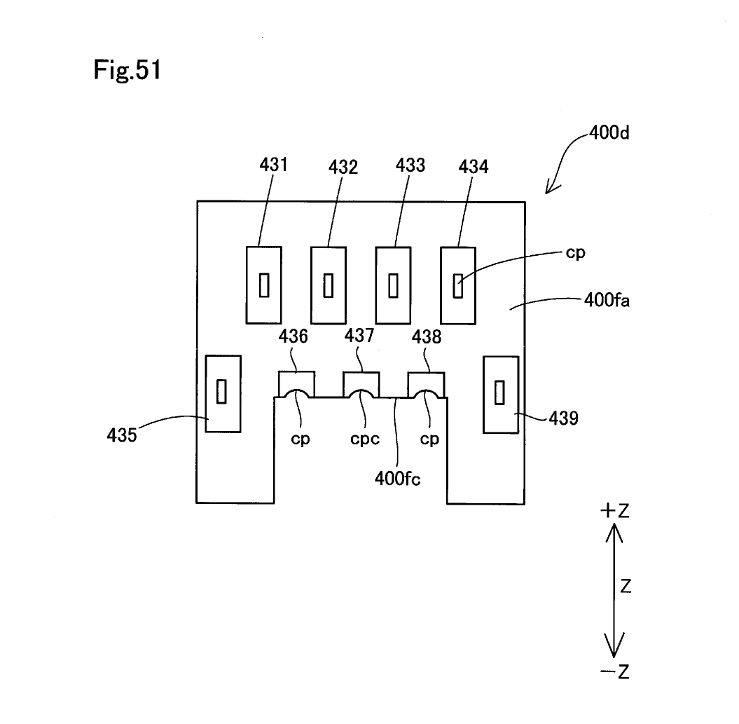

FIG. 51 is a diagram illustrating another embodiment of the configuration of terminals of a circuit board. In a circuit board 400d shown in FIG. 51, contact portions cp of cartridge-side terminals 436, 437 and 438 are provided on a surface 400fc that is orthogonal to the surface 400fa. The surface 400fc is arranged to face in the −Z direction. Part of the multiple contact portions cp may not be provided on the surface 400fa, as long as the arrangement of the contact portions cp is unchanged.

B-7. Other Embodiments of Cartridge

According to the above embodiment, in the first cartridge 10 mounted to the first mounting portion 602W and the second cartridge 20 mounted to the second mounting portion 602T, the contact portion group consisting of the multiple contact portions cp of the circuit board 30 and the contact portion group consisting of the multiple contact portions cp of the circuit board 400 may be provided at different positions in the Z direction. The arrangement of the contact portion groups at different positions in the Z direction allows the respective ranges in the Z direction of these contact portion groups to be partly overlapped with each other in the Z direction as long as the contact portion group of the circuit board 30 and the contact portion group of the circuit board 40 are arranged to be displaced in the Z direction. This configuration prevents the first cartridge 10 that is mistakenly mounted to the second mounting portion 602T from providing electrical continuity with the contact mechanism 70A of the second mounting portion 602T. This accordingly reduces the possibility that the storage device and the circuit of the circuit board 30 are broken.

According to the above embodiment, the cartridge having the multiple liquid chambers 200A to 200C parted from one another by the partition walls 22 and 23 is used as the second cartridge 20. According to a modification, however, an integrated cartridge by joining multiple cartridges, each having one liquid chamber, may be used as the second cartridge.

The first cartridge 10 is not provided with the liquid absorber 299 according to the above embodiment but may be provided with the liquid absorber 299. The second cartridge 20 is provided with the liquid absorbers 299 according to the above embodiment but may not be provided with the liquid absorbers 299. The first cartridge 10 contains the pigment ink according to the above embodiment but may contain dye ink. The second cartridge 20 contains the dye inks according to the above embodiment but may contain pigment inks.

What is claimed is:

1. A cartridge mounted to a carriage of a liquid ejection apparatus, the cartridge comprising:
a bottom surface and an upper surface opposed to each other in a Z direction;
a first side surface and a second side surface opposed to each other in a Y direction orthogonal to the Z direction;
three or a larger odd number of liquid supply ports arrayed in an X direction orthogonal to the Z direction and the Y direction, the liquid supply ports provided on the bottom surface at a position closer to the second side surface than the first side surface, and respectively having center axes along the Z direction;
a plurality of contact portions arrayed in the X direction on the second side surface at a position closer to the bottom surface than the upper surface, the plurality of contact portions having a center contact portion provided on center in the X direction among the plurality of contact portions; and
an engagement member provided on the second side surface at a position closer to the upper surface side than the contact portions, the engagement member including a cartridge-side engagement portion;
wherein
assuming that
the center axis of a middle liquid supply port among the three or the larger odd number of liquid supply ports is a first center axis;
a plane that includes the first center axis and that is perpendicular to the X direction is a first center plane;
the center axis of the liquid supply port on a side close to center of the carriage in the X direction out of two liquid supply ports located adjacent to the middle liquid supply port is a second center axis;
a plane that includes the second center axis and that is perpendicular to the X direction is a second center plane; and
center of the cartridge-side engagement portion in the X direction is an engagement center,
the center contact portion is arranged to intersect with the first center plane,
part of the plurality of contact portions is placed in a range where the cartridge-side engagement portion is located, in the X direction, and
the engagement center is provided between the first center plane and the second center plane.

2. The cartridge according to claim 1, further comprising:
a third side surface and a fourth side surface opposed to each other in the X direction; and
a concave portion provided in at least one corner portion among a corner portion where the first side surface intersects with the third side surface, a corner portion where the first side surface intersects with the fourth side surface, a corner portion where the second side surface intersects with the third side surface, and a corner portion where the second side surface intersects with the fourth side surface, to receive a guide projection that is provided on the carriage and that is configured to guide mounting of the cartridge, wherein
the concave portion is extended from the bottom surface side toward the upper surface side.

3. The cartridge according to claim 1, further comprising:
a concavo-convex portion provided on at least one end of the first side surface out of one end in the X direction and the other end in the X direction and configured to be fit with a cartridge identification convex provided in the carriage, wherein
the concavo-convex portion is extended from the bottom surface side toward the upper surface side on the first side surface.
